(19) United States
(12) Patent Application Publication
(10) Pub. No.: US 2026/0154596 A1
(43) Pub. Date: Jun. 4, 2026

(54) METHODS AND SYSTEMS FOR CONSTRAINED OPTIMIZATION USING SUBSPACE CORRECTION CODES

(71) Applicant: Atom Computing Inc., Berkeley, CA (US)

(72) Inventors: Kelly Ann PAWLAK, Santa Barbara, CA (US); Jeffrey EPSTEIN, San Francisco, CA (US); Daniel CROW, Oakland, CA (US); Ming LI, El Cerrito, CA (US); Jonathan KING, Oakland, CA (US)

(21) Appl. No.: 18/750,946

(22) Filed: Jun. 21, 2024

Related U.S. Application Data
(60) Provisional application No. 63/509,730, filed on Jun. 22, 2023.
(60) Provisional application No. 63/583,718, filed on Sep. 19, 2023.
(60) Provisional application No. 63/591,692, filed on Oct. 19, 2023.

(51) Int. Cl. G06N 10/70; G06N 10/60

(52) U.S. Cl. CPC G06N 10/70; G06N 10/60

(57) ABSTRACT

Systems, methods, computer-readable media, and techniques disclosed herein provide for preparing a solution to a problem comprising a constraint on a non-classical computer, comprising: (a) providing a state preparation operation, wherein the state preparation operation comprises at least a portion of an implementation of the problem comprising the constraint on the non-classical computer, wherein the state preparation operation is configured to evolve a quantum register to a solution state; (b) applying a constraint detection operation, the constraint detection operation comprising entangling an ancilla qubit with a set of data qubits; and (c) measuring the ancilla qubit to determine whether a constraint of the problem is satisfied.

### CROSS-REFERENCE

This application claims the benefit of U.S. Provisional Application No. 63/509,730, filed Jun. 22, 2023, U.S. Provisional Application No. 63/583,718, filed Sep. 19, 2023, and U.S. Provisional Application No. 63/591,692, filed Oct. 19, 2023, each of which is incorporated herein by reference in its entirety.

### BACKGROUND

Quantum computers typically make use of quantum-mechanical phenomena, such as superposition and entanglement, to perform operations on data Quantum computers may be different from digital electronic computers based on transistors. For instance, whereas digital computers require data to be encoded into binary digits (bits), each of which is always in one of two definite states (0 or 1), quantum computation uses quantum bits (qubits), which can be in superpositions of states.

In neutral-atom quantum computers or simulation devices, qubits may be encoded in optically trapped atoms. The qubit can be represented by a linear superposition of its two orthonormal basis states. The two orthonormal basis states are usually denoted as

$$\vert 0 〉 = [ \begin{matrix}1 \\ 0\end{matrix} ]$$

the “zero state”) and

$$\vert 1 〉 = [ \begin{matrix}0 \\ 1\end{matrix} ]$$

(“one state”). The two orthonormal basis states, {|0 [symbol] , |1 [symbol] }, together called the computational basis, span the two-dimensional linear vector (Hilbert) space of the qubit. The basis states can also be combined to form product basis states, e.g., |00 [symbol] , |01 [symbol] , |10 [symbol] , |11 [symbol] , each called a quantum register. Generally, n qubits are represented by a superposition state vector in 2ⁿ dimensional Hilbert space.

The ability to reliably detect the quantum state of a qubit may be important to the operation of a quantum computer. In architectures making use of trapped ions or neutral atoms, the state of the qubit is typically read out by collecting photons through imaging systems that spatially or temporally resolve the qubit states.

A significant issue in the field of quantum computing is the optimization of functions with respect to constraints on the solution space. The functions may be constrained optimization functions from industrial applications, or energy functionals in restricted subspaces in chemistry and physics related applications. Examples of such functions include the traveling salesman problem, the maximally independent set problem, maximum clique, ground state energies of molecular and material problems, etc.

### SUMMARY

Quantum computers are generally thought to be specially suited to solve optimization problems due to their ability to obtain a solution (or many solutions in parallel) by explore a quantum mechanical state space, returning a reasonable solution at a high probability when the search algorithm is carefully constructed. While the advantage of quantum parallelism aids optimization by allowing for the simultaneous exploration of many states, the simultaneity of exploration may detrimentally affect the final solutions when there are many constraints on the underlying parameters. Popular methods for solving constrained optimization on quantum computers, like the adiabatic quantum computation (e.g., instructions may carry stochastic or nonstochastic paths of evolution of an initial quantum system to a final quantum system), the variational quantum eigensolver (VQE) and quantum approximate optimization algorithm (QAOA), create scalar cost functions by combining the optimization function with a constraint violation penalty function. The combination of the optimization function and penalty function may lead to an emergent tradespace between optimality of a solution versus its adherence to constraints.

The present disclosure provides methods and systems for circumventing this specific tradespace by using measurement and wavefunction collapse of a quantum system to enforce constraints. Using the present disclosure, the optimization process or optimization search may occur within the constraint subspace. The mechanism that supports constraint subspace correction may be similar to error correction, in that a syndrome measurement and a recovery are involved. However, unlike error correction, there are many such schemes one can implement via mix-and-match, depending on the quality of the quantum devices and the desired accuracy of the results. For example, mix-and-match may refer to the ability to choose from multiple recovers and multiple ways of detecting errors for a given problem.

Furthermore, the actions of syndrome measurement and recovery for many common constraints may be carried out by sets of neutral-atom hardware-specific gates for greatly reduced gate-depths and improved fidelities. For example, the Rydberg Blockade mechanism, which allows the coherent manipulation and entanglement of multiple qubits within a physical radius may be useful for implementing systems and methods of the present disclosure.

In one aspect, a method for preparing a solution to a problem comprising a constraint on a non-classical computer, comprises: (a) providing a state preparation operation, wherein the state preparation operation comprises at least a portion of an implementation of the problem comprising the constraint on the non-classical computer, wherein the state preparation operation is configured to evolve a quantum register to a solution state; (b) applying a constraint detection operation, the constraint detection operation comprising entangling an ancilla qubit with a set of data qubits; and (c) measuring the ancilla qubit to determine whether a constraint of the problem is satisfied.

In some embodiments, the problem is a constrained optimization problem. In some embodiments, the state preparation operation is a unitary operation. In some embodiments, the ancilla qubit is one of a set of ancilla qubits, and (c) further comprises measuring the set of ancilla qubits. In some embodiments, (c) further comprises measuring the set of data qubits. In some embodiments, the set of data qubits are comprised of logical qubits, physical qubits, or a combination thereof. In some embodiments, measuring the ancilla qubit at (c) comprises: (i) collapsing at least part of a wavefunction into a new wavefunction, and (ii) determining whether the new wavefunction satisfies the constraint. In some embodiments, (c) further comprises determining, via a processor, whether the constraint of the problem is satisfied. In some embodiments, subsequent to (c), the method further comprises applying one or more recovery operations to the set of data qubits, and wherein measuring the ancilla qubit in (c) comprises an indication that the constraint is not satisfied by the set of data qubits. In some embodiments, the one or more recovery operations comprise preparing a superposition of states over all possible registers containing a single qubit in a |1 [symbol] computational state. In some embodiments, the one or more recovery operations comprises applying a RESET operation; and a) shelving one or more qubits in the |0 [symbol] state to the |clock 0 [symbol] state, b) exciting the |clock 0 [symbol] state with a pulse to the |ryd [symbol] state for π/\sqrt{N} time, c) applying the Rydberg de-excitation beam to |clock 1 [symbol] ; and d) deshelving all qubits from the clock states. In some embodiments, the constraint comprises a one-hot-encoding constraint. In some embodiments, (b) comprises applying a shelving pulse to the ancilla qubit to excite to a |clock 0 [symbol] state; applying a multiphoton excitation to the set of logical qubits from a 1-in-n state to a 1-in-(n+1) Rydberg state; applying a Rydberg to |clock 1 [symbol] pulse on the ancilla qubit; and deshelving the ancilla qubit. In some embodiments, the constraint comprises a m-in-n constraint. In some embodiments, (b) comprises applying a shelving pulse to the ancilla qubit to excite to a |clock 0 [symbol] state; applying a multiphoton excitation to the set of logical qubits from an m-in-n state to a m-in-(n+ancilla) Rydberg state; applying a. Rydberg to |clock 1 [symbol] pulse on the ancilla qubit; and deshelving the ancilla qubit. In some embodiments, the one or more recovery operations comprises preparing a superposition of states over all possible registers containing m qubits in a |1 [symbol] computational state. In some embodiments, the one or more recovery operations comprises a plying a RESET operation; and a) shelving the qubits in the |0 [symbol] state to the |clock 0 [symbol] state, b) exciting the |clock 0 [symbol] state with a pulse to the |ryd [symbol] state for π/\sqrt{N} time, c) applying the Rydberg de-excitation beam to |clock 1 [symbol] ; and d) deshelving all qubits from the clock states. In some embodiments, the constraint is an independent set constraint. In some embodiments, (b) comprises applying a Toffoli gate at an edge. In some embodiments, the constraint is a less than or equal to m-in-n constraint. In some embodiments, (b) comprises recursively for all m′ excitations greater than m: applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to |clock 1 [symbol] pulse on the ancilla qubit; and deshelving the ancilla qubit. In some embodiments, the method is integrated with an error correcting code. In some embodiments, the quantum register comprises neutral atom qubits. In some embodiments, the neutral atom qubits comprise strontium or ytterbium. In some embodiments, the quantum register comprises nuclear-spin qubits. In some embodiments, the constraint is an implied constraint. In some embodiments, the problem is configured to be solved on a non-classical computer. In some embodiments, the problem is a satisfiability problem. In some embodiments, the stopping criterion comprises reaching a threshold number of iterations or a threshold change in the solution state.

In another aspect, a method for detecting a status of a constraint comprises: (a) obtaining a data qubit and an ancilla qubit; (b) applying a constraint detection operation, the constraint detection operation comprising an operation on the ancilla qubit with the data qubit; and (c) measuring the ancilla qubit to determine whether the constraint is violated.

In some embodiments, the ancilla qubit is one of a set of ancilla qubits, and wherein (c) further comprises measuring the set of ancilla qubits. In some embodiments, the data qubit is one of a set of data qubits, and wherein (c) further comprises measuring the set of data qubits. In some embodiments, the set of data qubits are comprised of logical qubits, physical qubits, or a combination thereof. In some embodiments, measuring the ancilla qubit at (c) comprises: (i) collapsing at least part of a wavefunction into a new wavefunction, and (ii) determining whether the new wavefunction satisfies the constraint. In some embodiments, (c) further comprises determining, via a processor, whether the constraint is satisfied. In some embodiments, subsequent to (c), the method further comprises applying one or more recovery operations to the data qubit, and wherein measuring the ancilla qubit in (c) comprises an indication that the constraint is not satisfied by the data qubit. In some embodiments, the one or more recovery operations comprises preparing a superposition of states over all possible registers containing a single qubit in a |1 [symbol] computational state. In some embodiments, the one or more recovery operations comprises applying a RESET operation; and a) shelving one or more qubits in the |0 [symbol] state to the |clock 0 [symbol] state, b) exciting the |clock 0 [symbol] state with a pulse to the |ryd [symbol] state for π/\sqrt{N} time time, c) applying the Rydberg de-excitation beam to |clock 1 [symbol] ; and d) deshelving all qubits from the clock states. In some embodiments, the constraint comprises a one-hot-encoding constraint. In some embodiments, (b) comprises applying a shelving pulse to the ancilla qubit to excite to a |clock 0 [symbol] state; applying a multiphoton excitation to the set of logical qubits from a 1-in-n state to a 1-in-(n+1) Rydberg state; applying a Rydberg to |clock 1 [symbol] pulse on the ancilla qubit; and deshelving the ancilla qubit. In some embodiments, the constraint comprises a m-in-n constraint. In some embodiments, (b) comprises applying a shelving pulse to the ancilla qubit to excite to a |clock 0 [symbol] state; applying a multiphoton excitation to the set of logical qubits from an m-in-n state to a m-in-(n+ancilla) Rydberg state, applying a Rydberg to |clock 1 [symbol] pulse on the ancilla qubit; and deshelving the ancilla qubit. In some embodiments, the one or more recovery operations comprises preparing a superposition of states over all possible registers containing in qubits in a |1 [symbol] computational state. In some embodiments, the one or more recovery operations comprises applying a RESET operation; and a) shelving the qubits in the |0 [symbol] state to the |clock 0) state, b) exciting the |clock 0 [symbol] state with a pulse to the |ryd [symbol] state for π/\sqrt{N} time, c) applying the Rydberg de-excitation beam to |clock 1 [symbol] ; and d) deshelving all qubits from the clock states. In some embodiments, the constraint is an independent set constraint. In some embodiments, (b) comprises applying a Toffoli gate at an edge. In some embodiments, the constraint is a less than or equal to m-in-n constraint. In some embodiments, (b) comprises recursively for all m′ excitations greater than in: applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to |clock 1 [symbol] pulse on the ancilla qubit; and deshelving the ancilla qubit. In some embodiments, the method is integrated with an error correcting code. In some embodiments, the constraint is an implied constraint. In some embodiments, a problem corresponding to the constraint is configured to be solved on a non-classical computer. In some embodiments, a problem corresponding to the constraint is a satisfiability problem. In some embodiments, a problem corresponding to the constraint is a constrained optimization problem. In some embodiments, the stopping criterion comprises reaching a threshold number of iterations or a threshold change in the solution state.

In another aspect, a non-classical computer is operable to perform a constrained optimization on a non-using subspace correction, the non-classical computer comprising: a quantum register comprising a set of qubits and an ancilla qubit; a quantum circuit comprising: (a) a state preparation unitary operation, wherein the state preparation unitary operation comprises at least a portion of an implementation of a constrained optimization problem, wherein the state preparation unitary operation is configured to evolve a quantum register to a solution state; (b) a constraint detection operation, the constraint detection operation comprising entangling the ancilla qubit with the set of logical qubits; and (c) a measurement of the ancilla qubit, wherein the measurement is indicative of whether a constraint of the constrained optimization problem is satisfied.

In some embodiments, the ancilla qubit is one of a set of ancilla qubits, and (c) further comprises a measurement of the set of ancilla qubits. In some embodiments, (c) further comprises a measurement of the set of qubits. In some embodiments, the set of qubits are comprised of data qubits, logical qubits, physical qubits, or a combination thereof. In some embodiments, the measurement of the ancilla qubit at (c) comprises: (i) collapsing at least part of a wavefunction into a new wavefunction, and (ii) determining whether the new wavefunction satisfies the constraint. In some embodiments, the quantum circuit further comprises an outputting operation of the solution state. In some embodiments, the quantum circuit further comprises subsequent to (c), application of one or more recovery operations to the set of data qubits, and wherein the measurement of the ancilla qubit in (c) comprises an indication that the constraint is not satisfied. In some embodiments, the quantum circuit further comprises a determining operation for a sequence of the one or more recovery operations based on an extent to which the constraint is not satisfied. In some embodiments, the one or more recovery operations comprises preparing of states over all possible registers containing a single qubit in a |1 [symbol] computational state. In some embodiments, the one or more recovery operations comprises applying a RESET operation; and a) shelving one or more qubits in the |0 [symbol] state to the |clock 0 [symbol] state, b) exciting the |clock 0 [symbol] state with a pulse to the |ryd [symbol] state for π/\sqrt{N} time, c) applying the Rydberg de-excitation beam to |clock 1 [symbol] ; and d) deshelving all qubits from the clock states. In some embodiments, the constraint comprises a one-hot-encoding constraint. In some embodiments, (b) comprises applying a shelving pulse to the ancilla qubit to excite to a |clock 0 [symbol] state; applying a multiphoton excitation to the set of logical qubits from a 1-in-n state to a 1-in-(n+1) Rydberg state; applying a Rydberg to |clock 1 [symbol] pulse on the ancilla qubit; and deshelving the ancilla qubit. In some embodiments, the constraint comprises a mi-in-n constraint. In some embodiments, (b) comprises applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to |clock 1 [symbol] pulse on the ancilla qubit; and deshelving the ancilla qubit. In some embodiments, the one or more recovery operations comprises preparing a superposition of states over all possible registers containing m qubits in a |1 [symbol] computational state. In some embodiments, the one or more recovery operations comprises applying a RESET operation; and a) shelving the qubits in the |0 [symbol] state to the |clock 0 [symbol] state, b) exciting the |clock 0 [symbol] state with a pulse to the |ryd [symbol] state for π/\sqrt{N} time, c) applying the Rydberg de-excitation beam to |clock 1 [symbol] ; and d) deshelving all qubits from the clock states. In some embodiments, the constraint is an independent set constraint. In some embodiments, (b) comprises applying a Toffoli gate at an edge. In some embodiments, the constraint is a less than or equal to m-in-n constraint. In some embodiments, (b) comprises recursively for all m′ excitations greater than m: applying a shelving pulse to the ancilla qubit to excite to a |clock 0 [symbol] state; applying a multiphoton excitation to the set of logical qubits from an m-n-n state to a m-in-(n+ancilla) Rydberg state; applying a Rydberg to |clock 1 [symbol] pulse on the ancilla qubit; and deshelving the ancilla qubit. In some embodiments, the non-classical computer is integrated with an error correcting code. In some embodiments, the quantum register comprises neutral atom qubits. In some embodiments, the neutral atom qubits comprise strontium or ytterbium. In some embodiments, the quantum register comprises nuclear-spin qubits. In some embodiments, the constraint is an implied constraint. In some embodiments, the constrained optimization problem is configured to be solved on a non-classical computer. In some embodiments, the constrained optimization problem is a satisfiability problem. In some embodiments, the stopping criterion comprises reaching a threshold number of iterations or a threshold change in the solution state.

In another aspect, a classical computer is operably connected to a non-classical computer, the classical computer comprising instructions, which when executed, are configured to: provide a state preparation unitary operation, wherein the state preparation unitary operation comprises at least a portion of an implementation of a constrained optimization problem on the non-classical computer, wherein the state preparation unitary operation is configured to evolve a quantum register to a solution state; apply a constraint detection operation, the constraint detection operation comprising entangling an ancilla qubit with a set of logical qubits; and measure the ancilla qubit to determine whether a constraint of the constrained optimization problem is satisfied.

In some embodiments, the ancilla qubit is one of a set of ancilla qubits, and (c) further comprises measuring the set of ancilla qubits. In some embodiments, (c) further comprises measuring the set of logical qubits. In some embodiments, the set of logical qubits are comprised of data qubits, physical qubits, or a combination thereof. In some embodiments, the measuring of the ancilla qubit at (c) comprises: (i) collapsing at least part of a wavefunction into a new wavefunction, and (ii) determining whether the new wavefunction satisfies the constraint. In some embodiments, the instructions, when executed, are further configured to output the solution state. In some embodiments, the instructions, when executed, are further configured to, subsequent to (c), apply one or more recovery operations to the set of data qubits, and wherein the measuring of the ancilla qubit in (c) comprises an indication that the constraint is not satisfied. In some embodiments, the instructions, when executed, are further configured to determine a sequence of the one or more recovery operations based on an extent to which the constraint is not satisfied. In some embodiments, the one or more recovery operations m rises preparing a superposition of states over all possible registers containing a single qubit in a |1 [symbol] computational state. In some embodiments, the one or more recovery operations comprises applying a RESET operation; and a) shelving one or more qubits in the |0 [symbol] state to the |clock 0 [symbol] state, b) exciting the |clock 0 [symbol] state with a pulse to the |ryd [symbol] state for π/\sqrt{N} time, c) applying the Rydberg de-excitation beam to |clock 1 [symbol] ; and d) deshelving all qubits from the clock states. In some embodiments, the constraint comprises a one-hot-encoding constraint. In some embodiments, (b) comprises applying a shelving pulse to the ancilla qubit to excite to a |clock 0 [symbol] state; applying a multiphoton excitation to the set of logical qubits from a 1-in-n state to a 1-in-(n+1) Rydberg state; applying a Rydberg to |clock 1) pulse on the ancilla qubit; and deshelving the ancilla qubit. In some embodiments, the constraint comprises a m-in-n constraint. In some embodiments, (b) comprises applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to |clock 1 [symbol] pulse on the ancilla qubit; and deshelving the ancilla qubit. In some embodiments, the one or more recovery operations comprises preparing a superposition of states over all possible registers containing n qubits in a |1 [symbol] computational state. In some embodiments, the one or more recovery operations comprises applying a RESET operation; and a) shelving the qubits in the |0 [symbol] state to the |clock 0 [symbol] state, b) exciting the |clock 0 [symbol] state with a pulse to the |ryd [symbol] state for π/\sqrt{N} time, c) applying the Rydberg de-excitation beam to |clock 1 [symbol] ; and d) deshelving all qubits from the clock states. In some embodiments, the constraint is an independent set constraint. In some embodiments, (b) comprises applying a. Toffoli gate at an edge. In some embodiments, the constraint is a less than or equal to m-in-n constraint. In some embodiments, (b) comprises recursively for all m′ excitations greater than m: applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to |clock 1 [symbol] pulse on the ancilla qubit; and deshelving the ancilla qubit. In some embodiments, the non-classical computer is integrated with an error correcting code. In some embodiments, the quantum register comprises neutral atom qubits. In some embodiments, the neutral atom qubits comprise strontium or ytterbium. In some embodiments, the quantum register comprises nuclear-spin qubits. In some embodiments, the constraint is an implied constraint. In some embodiments, the constrained optimization problem is configured to be solved on a non-classical computer. In some embodiments, the constrained optimization problem is a satisfiability problem. In some embodiments, the instructions, when executed, are further configured to repeat operations (a) to (c) until a stopping criterion is met. In some embodiments, the stopping criterion comprises reaching a threshold number of iterations or a threshold change in the solution state.

In another aspect, a method for constrained optimization on a non-classical computer using subspace correction is provided. The method may comprise: (a) providing a state preparation unitary operation, wherein the state preparation unitary operation comprises at least a portion of an implementation of a constrained optimization problem on the non-classical computer, wherein the state preparation unitary operation is configured to evolve a quantum register to a solution state; (b) applying a constraint detection operation, the constraint detection operation comprising entangling an ancilla qubit with a set of logical qubits; and (c) measuring the ancilla qubit to determine whether a constraint of the constrained optimization problem is satisfied.

In some embodiments, subsequent to (c), the method further comprises applying one or more recovery operations to the set of qubits (e.g., logical or physical), and wherein measuring the ancilla qubit in (c) comprises an indication that the constraint is not satisfied by the set of logical qubits. In some embodiments, the method further comprises repeating (a) to (c) until a stopping criterion is met. In some embodiments, the stopping criterion comprises reaching a threshold number of iterations or a threshold change in the solution state. In some embodiments, the method further comprises, subsequent to (c) outputting the solution state. In some embodiments, (c) further comprises, at a processor, determining whether the constraint of the constrained optimization problem is satisfied. In some embodiments, the method further comprises, at the processor, determining a sequence of the one or more recovery operations based on an extent to which the constraint is not satisfied. In some embodiments, wherein the constraint is a one-hot-encoding constraint. In some embodiments, (b) comprises applying a shelving pulse to the ancilla qubit to excite to a |clock 0 [symbol] state; applying a multiphoton excitation to the set of logical qubits from a 1-in-n state to a 1-in-(n+1) Rydberg state; applying a Rydberg to |clock 1 [symbol] pulse on the ancilla qubit; and deshelving the ancilla qubit. In some embodiments, the one or more recovery operations comprise preparing a superposition of states over all possible registers containing a single qubit in a |1 [symbol] computational state. In some embodiments, the one or more recovery operations comprise applying a RESET operation; and a) shelving the qubits in the |0 [symbol] state to the |clock 0 [symbol] state, b) exciting the |clock 0 [symbol] state with a pulse to the |ryd [symbol] state for pi/sqrt(N) time, c) applying the Rydberg de-excitation beam to |clock 1 [symbol] ; and d) deshelving all qubits from the clock states. In some embodiments, the constraint is a n-in-n constraint. In some embodiments, (b) comprises applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to |clock 1 [symbol] pulse on the ancilla qubit; and deshelving the ancilla qubit. In some embodiments, the one or more recovery operations comprise preparing a superposition of states over all possible registers containing m qubits in a |1 [symbol] computational state. In some embodiments, the one or more recovery operations comprise applying a RESET operation; and a) shelving the qubits in the |0 [symbol] state to the |clock 0 [symbol] state, b) exciting the |clock 0 [symbol] state with a pulse to the |ryd [symbol] state, c) applying the Rydberg de-excitation beam to |clock 1 [symbol] ; and d) deshelving all qubits from the clock states. In some embodiments, the constraint is an independent set constraint. In some embodiments, (b) comprises applying a Toffoli gate per edge. In some embodiments, the constraint is a less than or equal to m-in-n constraint. In some embodiments, (b) comprises recursively for all m′ excitations greater than m: applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to |clock 1 [symbol] pulse on the ancilla qubit; and deshelving the ancilla qubit. In some embodiments, the method is integrated with an error correcting code. In some embodiments, the quantum register comprises neutral atom qubits. In some embodiments, the neutral atom qubits comprise strontium or ytterbium. In some embodiments, the quantum register comprises nuclear-spin qubits.

In another aspect, the present disclosure provides a non-classical computer operable to perform a constrained optimization on a non-using subspace correction. The non-classical computer may comprise: a quantum register comprising a set of logical qubits and an ancilla qubit; a quantum circuit comprising: a state preparation unitary operation, wherein the state preparation unitary operation comprises at least a portion of an implementation of a constrained optimization problem, wherein the state preparation unitary operation is configured to evolve a quantum register to a solution state; a constraint detection operation, the constraint detection operation comprising entangling the ancilla qubit with the set of logical qubits; and a measurement of the ancilla qubit, wherein the measurement is indicative of whether a constraint of the constrained optimization problem is satisfied.

In another aspect, the present disclosure provides a classical computer operably connected to a non-classical computer, the classical computer comprising instructions which when executed are configured to: provide a state preparation unitary operation, wherein the state preparation unitary operation comprises at least a portion of an implementation of a constrained optimization problem on the non-classical computer, wherein the state preparation unitary operation is configured to evolve a quantum register to a solution state; apply a constraint detection operation, the constraint detection operation comprising entangling an ancilla qubit with a set of logical qubits; and measure the ancilla qubit to determine whether a constraint of the constrained optimization problem is satisfied.

In another aspect, the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

The novel features of the invention are set forth with particularity in the appended claims. The patent or application file contains at least one drawing executed in color. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

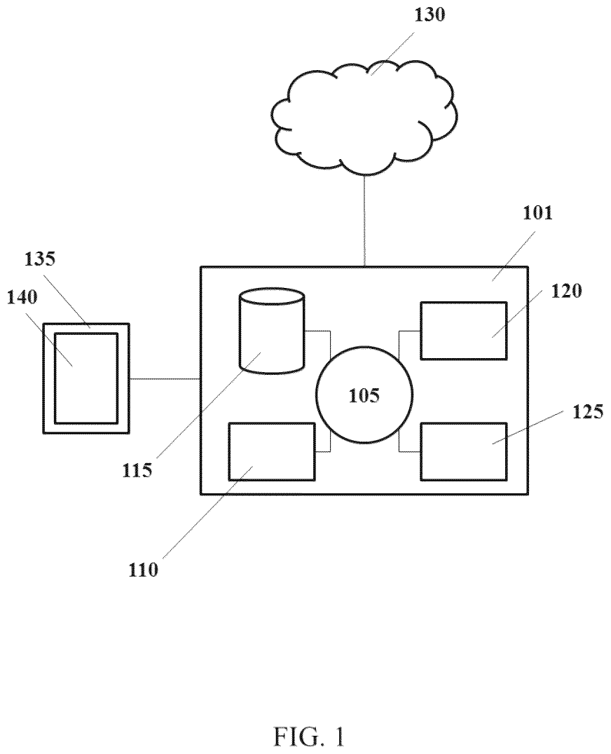

FIG. 1 shows a computer control system that is programmed or otherwise configured to implement methods provided herein;

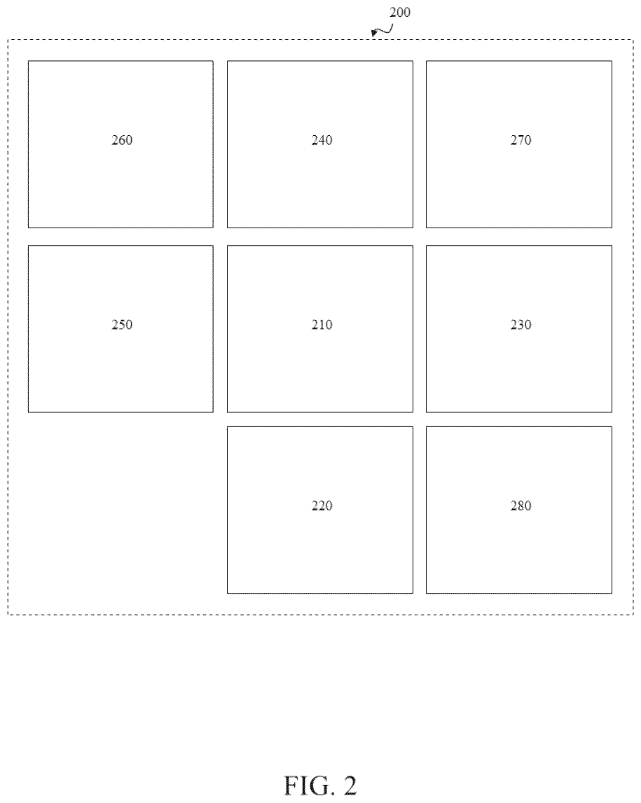

FIG. 2 shows an example of a system for performing a non-classical computation;

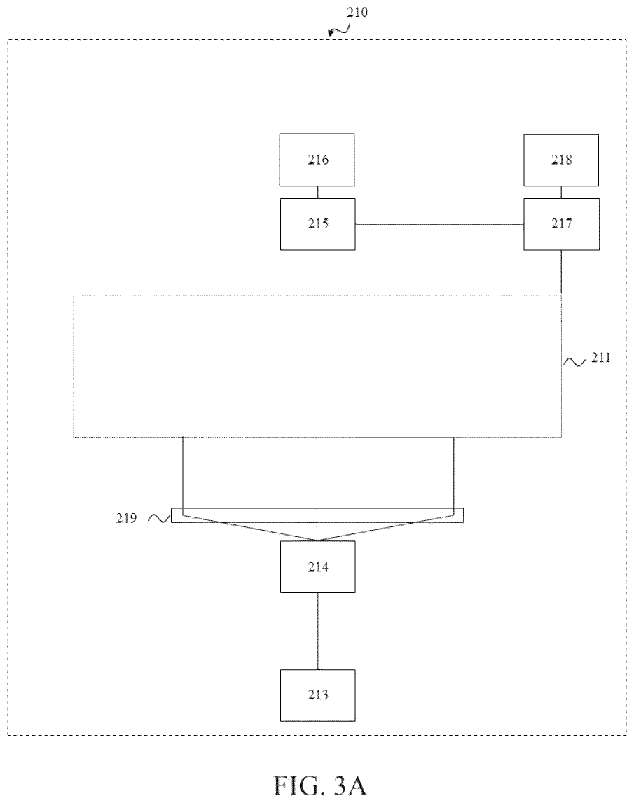

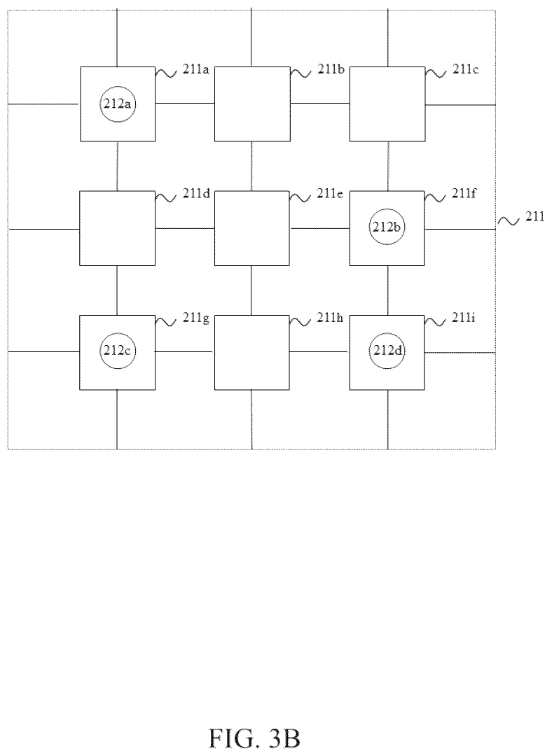

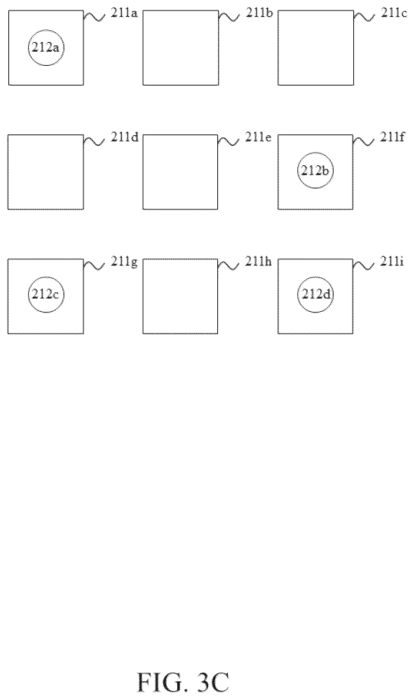

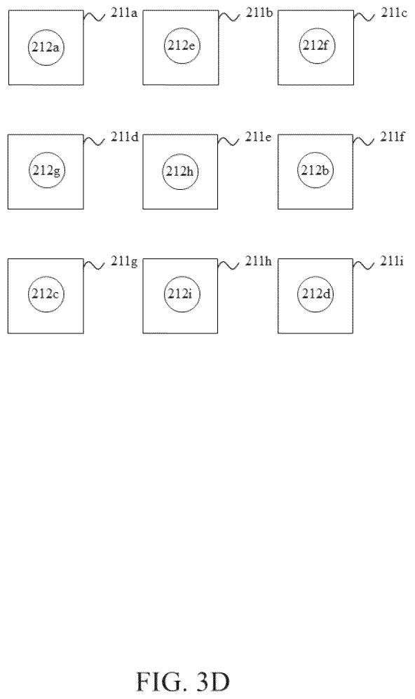

FIG. 3A shows an example of an optical trapping unit;

FIG. 3B shows an example of a plurality of optical trapping sites;

FIG. 3C shows an example of an optical trapping unit that is partially filled with atoms;

FIG. 3D shows an example of an optical trapping unit that is completely filled with atoms;

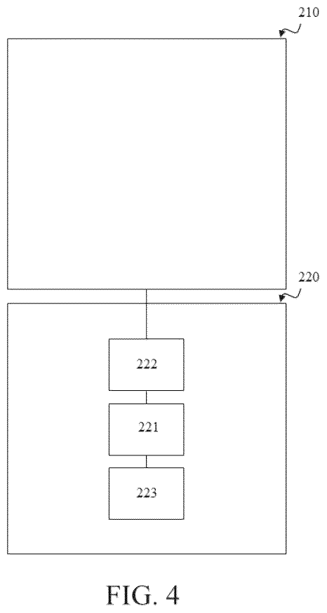

FIG. 4 shows an example of an electromagnetic delivery unit;

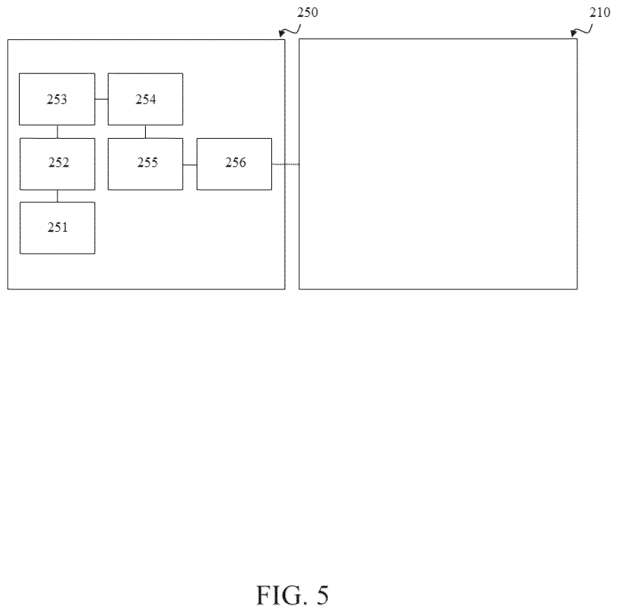

FIG. 5 shows an example of a state preparation unit;

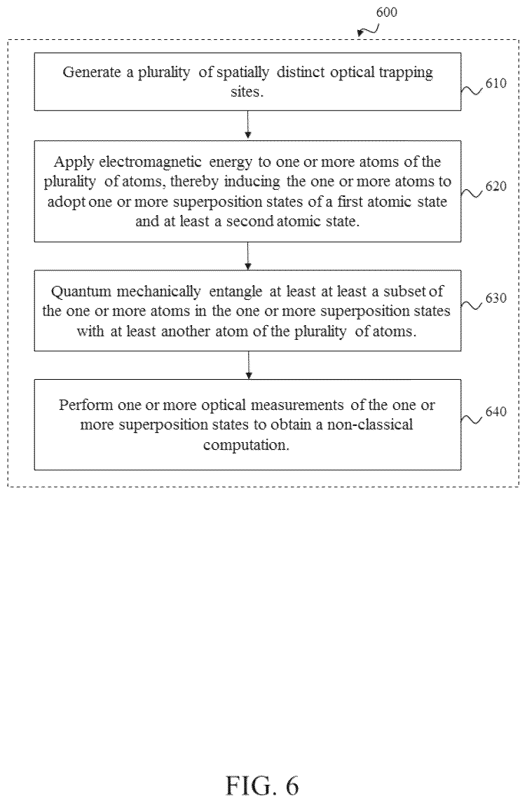

FIG. 6 shows a flowchart for an example of a first method for performing a non-classical computation;

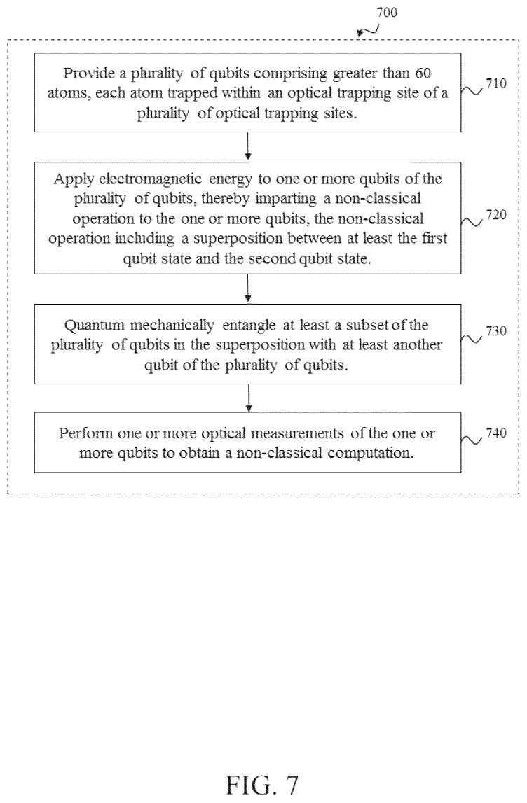

FIG. 7 shows a flowchart for an example of a second method for performing a non-classical computation;

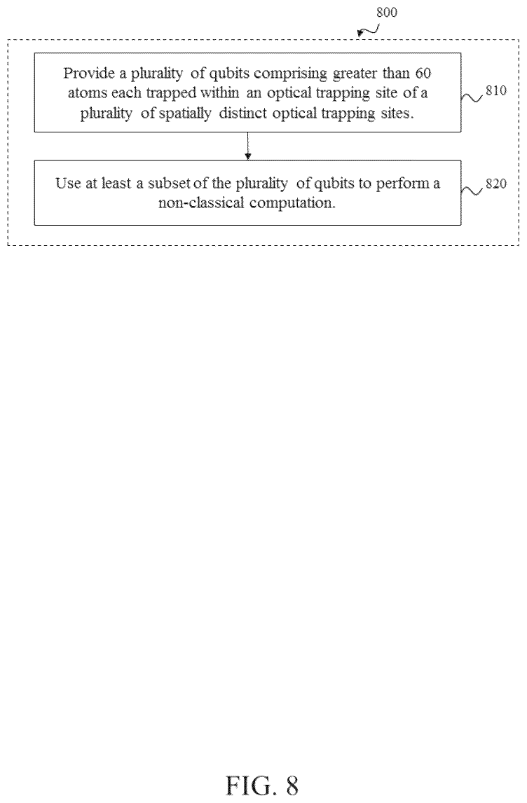

FIG. 8 shows a flowchart for an example of a third method for performing a non-classical computation;

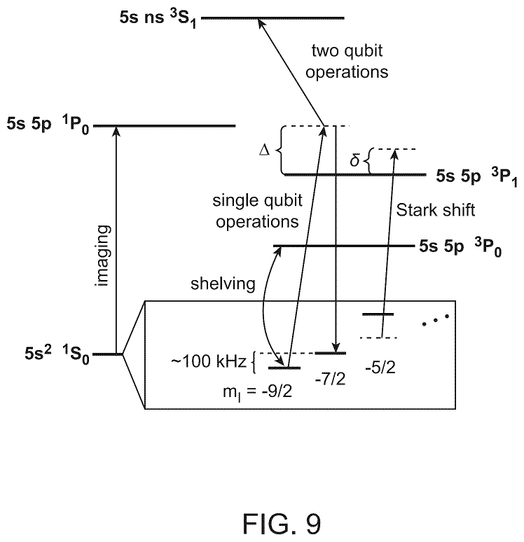

FIG. 9 shows an energy level structure for single-qubit and multi-qubit operations in strontium-87;

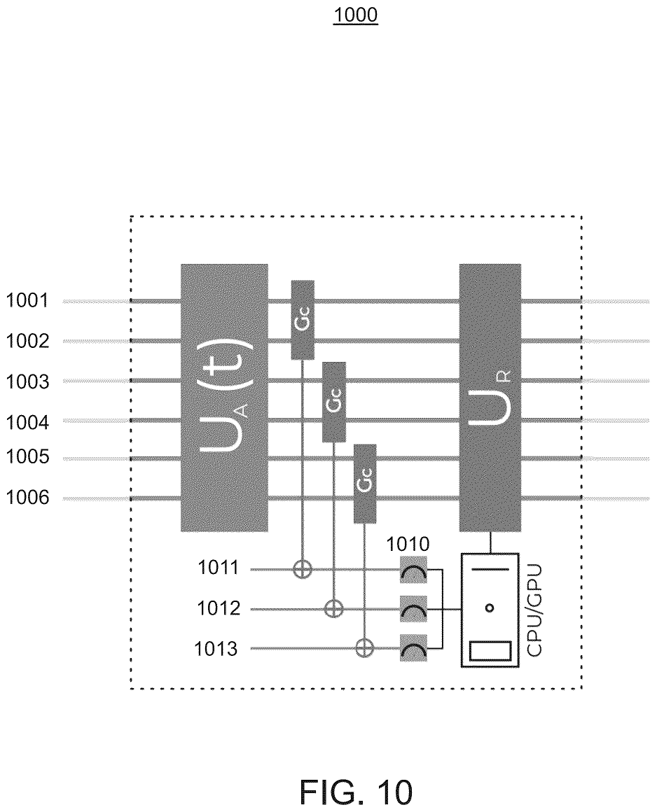

FIG. 10 is a schematic of an example process of implementing a subspace correction code of the present disclosure;

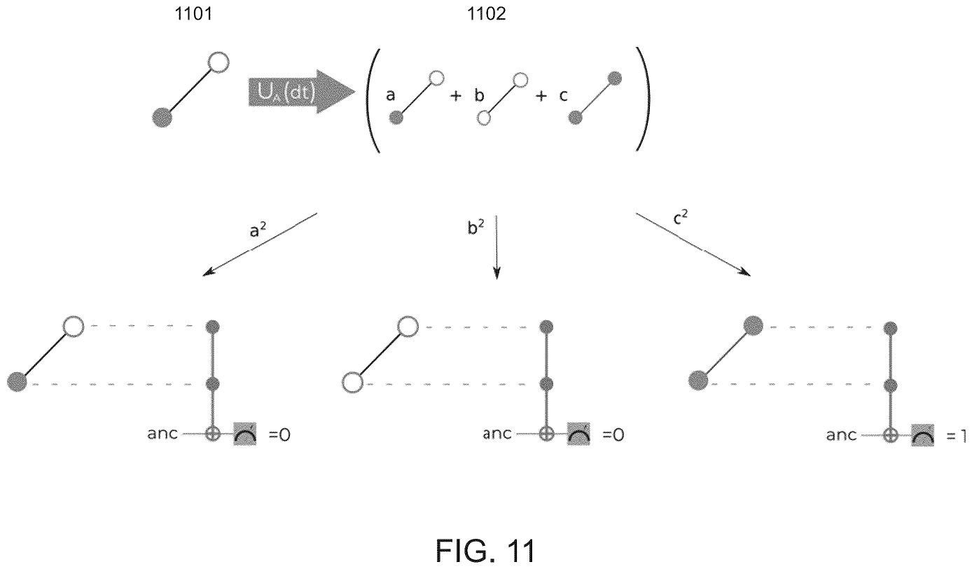

FIG. 11 is an example of constraint detection for the problem of finding a maximally independent set on a 2-site graph;

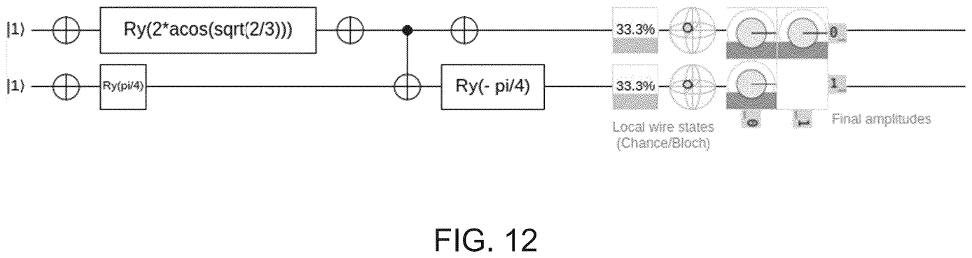

FIG. 12 shows an example recovery sequence for a single edge projected to the |1 [symbol] state;

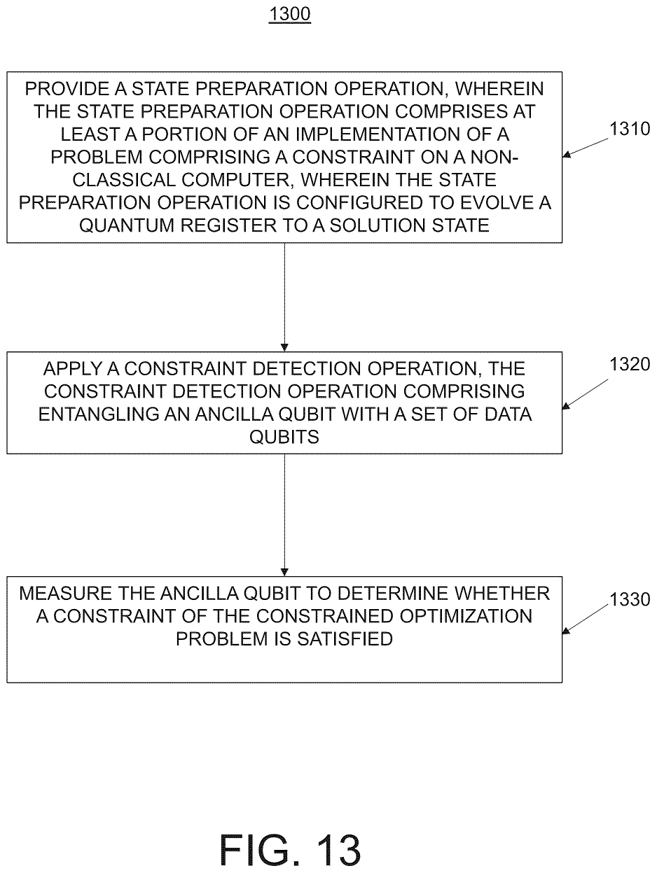

FIG. 13 is a flowchart of an example method for preparing a solution to a problem comprising a constraint on a non-classical computer;

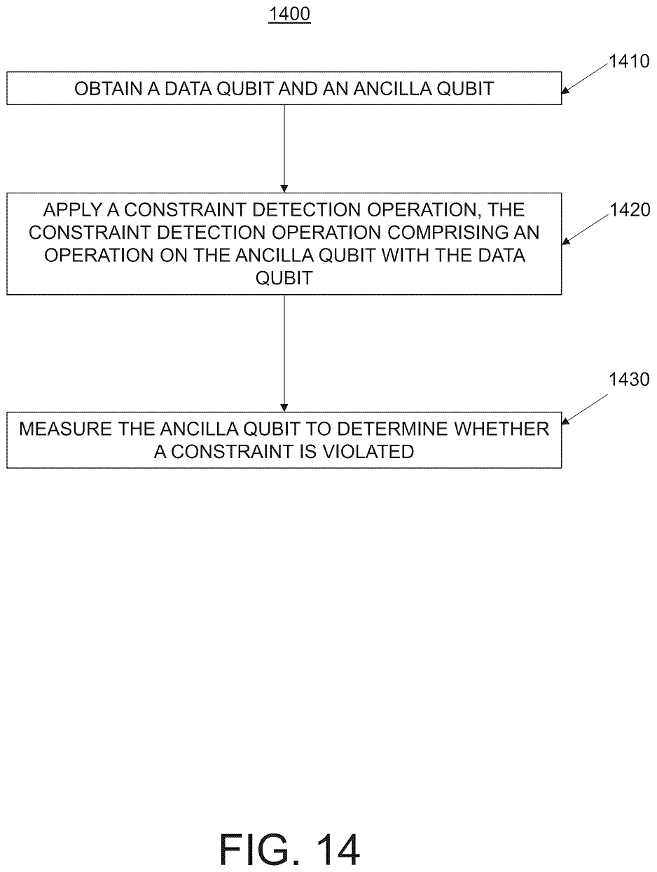

FIG. 14 is a flowchart of an example method for detecting a status of a constraint;

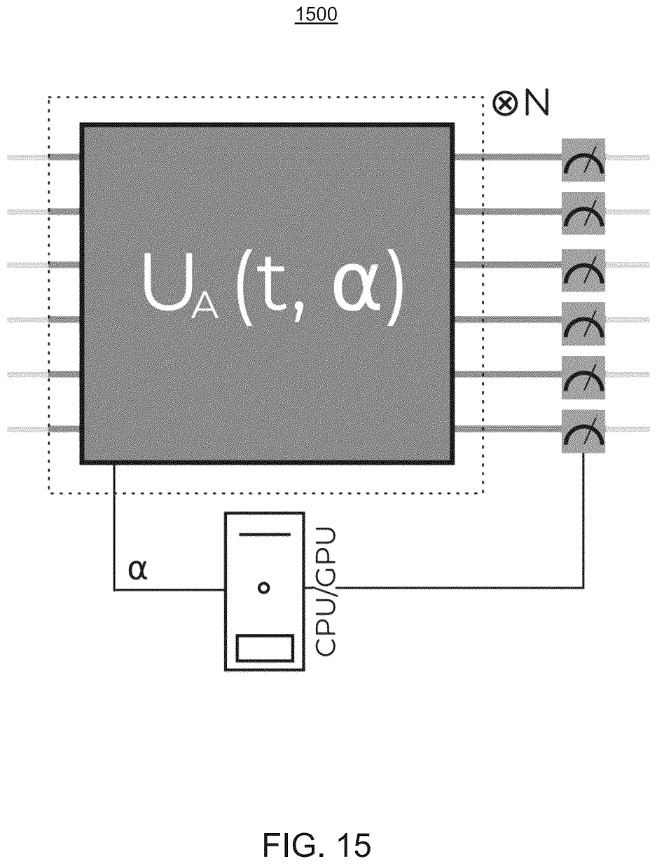

FIG. 15 is a schematic of an example process of implementing a state preparation unit;

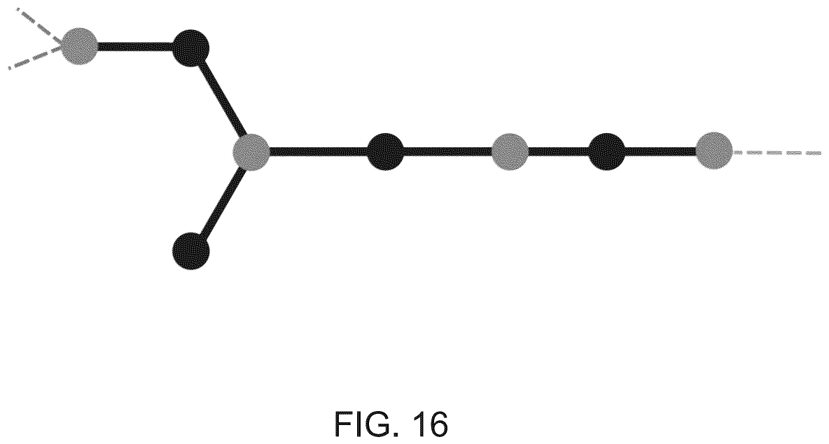

FIG. 16 is an example of constraint detection for the problem of finding a maximally independent set on a Y-shaped graph;

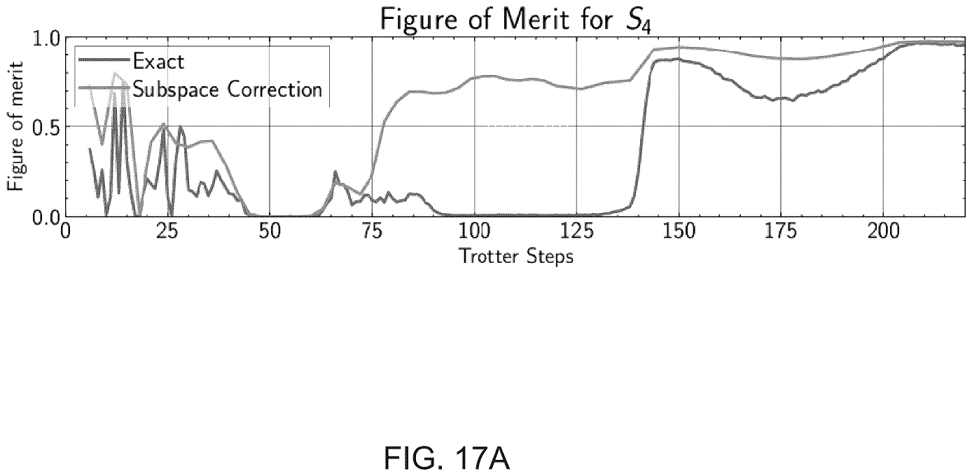

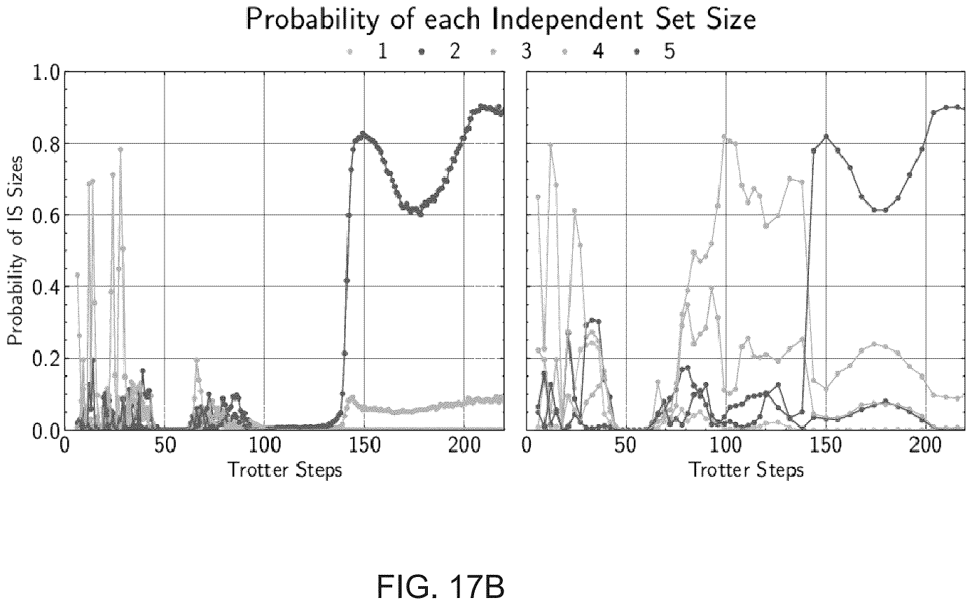

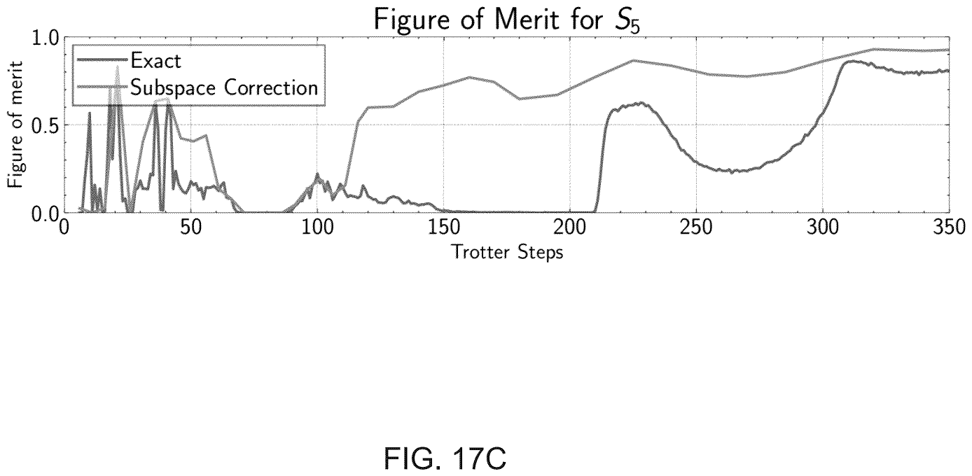

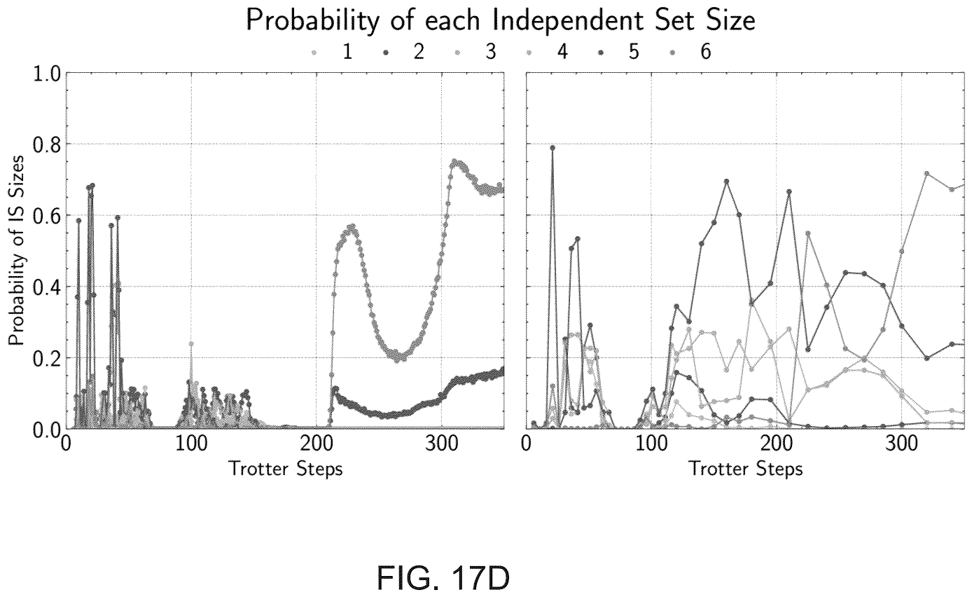

FIG. 17A plots the average size of the independent sets over the size of the maximum independent set for S₄ graphs;

FIG. 17B plots the probability of finding each independent set size for the exact algorithm and the algorithm with quantum subspace correction for S₄ graphs;

FIG. 17C plots the average size of the independent sets over the size of the maximum independent set for S₅ graphs;

FIG. 17D plots the probability of finding each independent set size for the exact algorithm and the algorithm with quantum subspace correction for S₅ graphs:

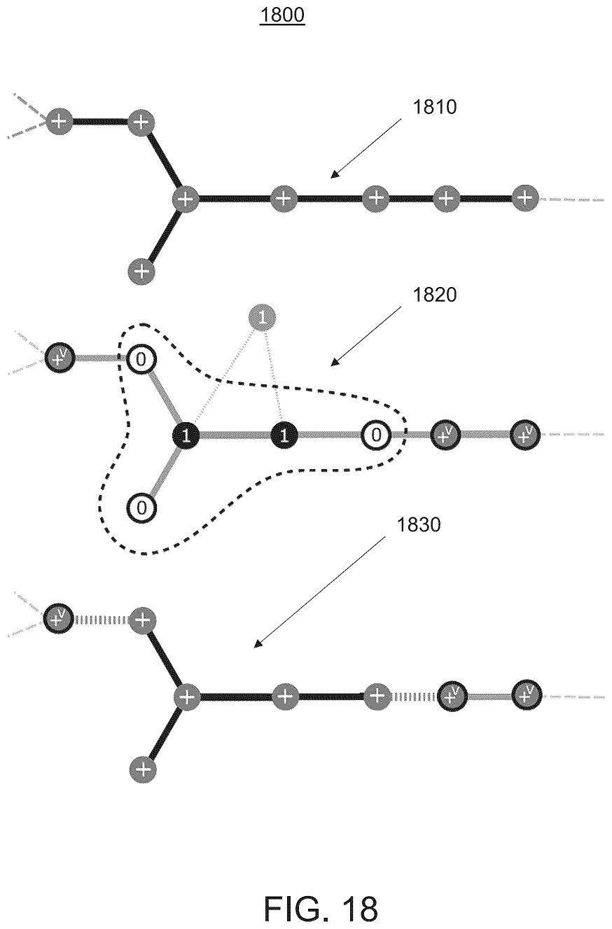

FIG. 18 illustrates an example process of syndrome extraction;

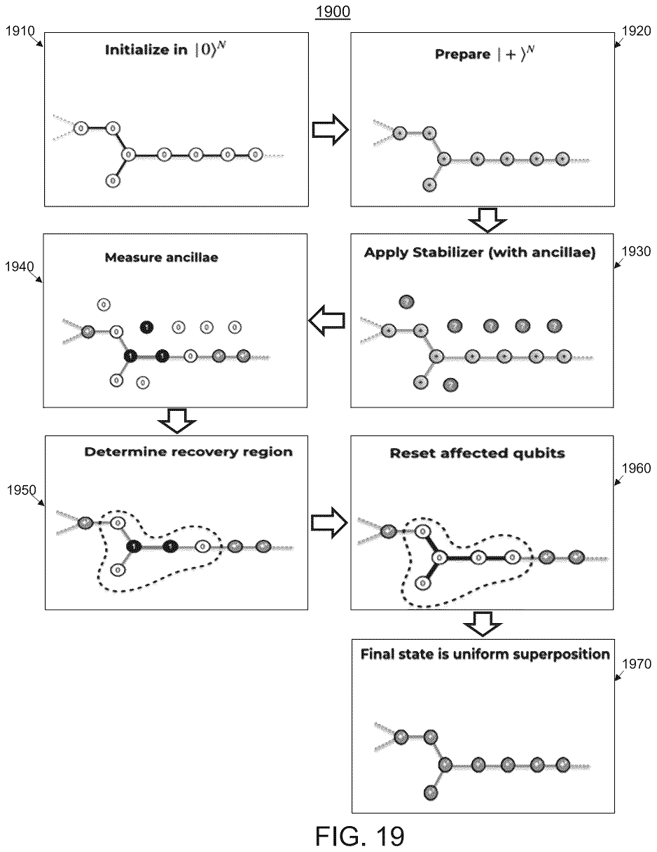

FIG. 19 illustrates an example of process of subspace correction for quantum partial rejection sampling;

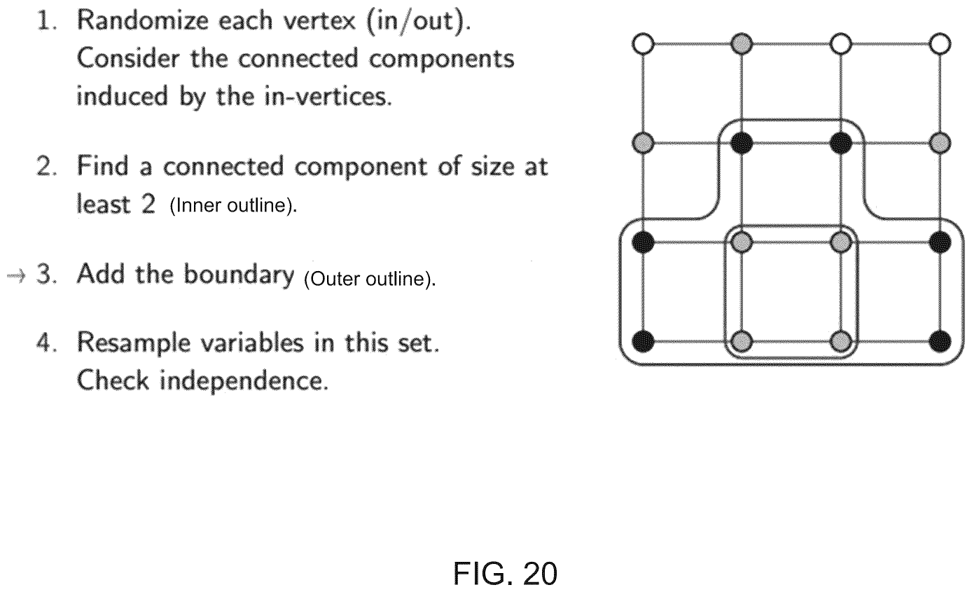

FIG. 20 illustrates an example classical algorithm of subspace correction as analogous to quantum partial rejection sampling of independent sets;

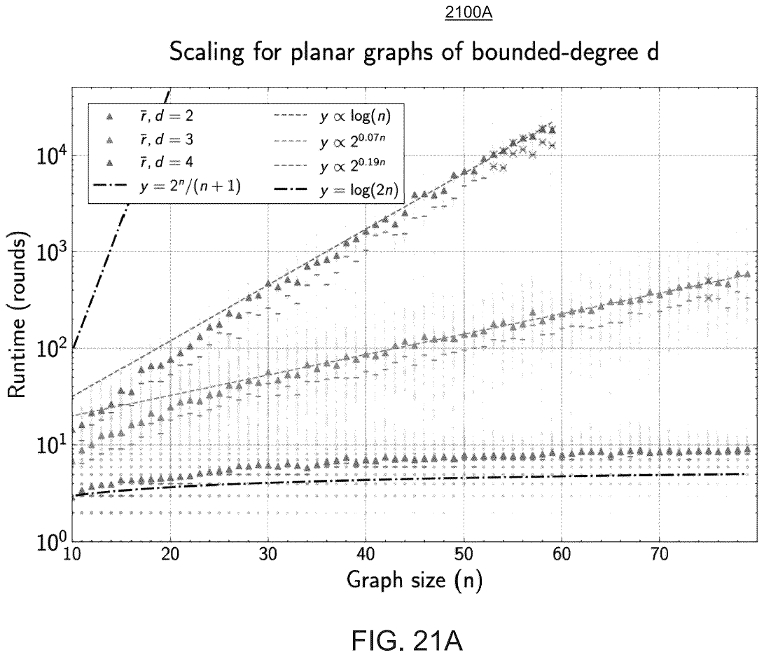

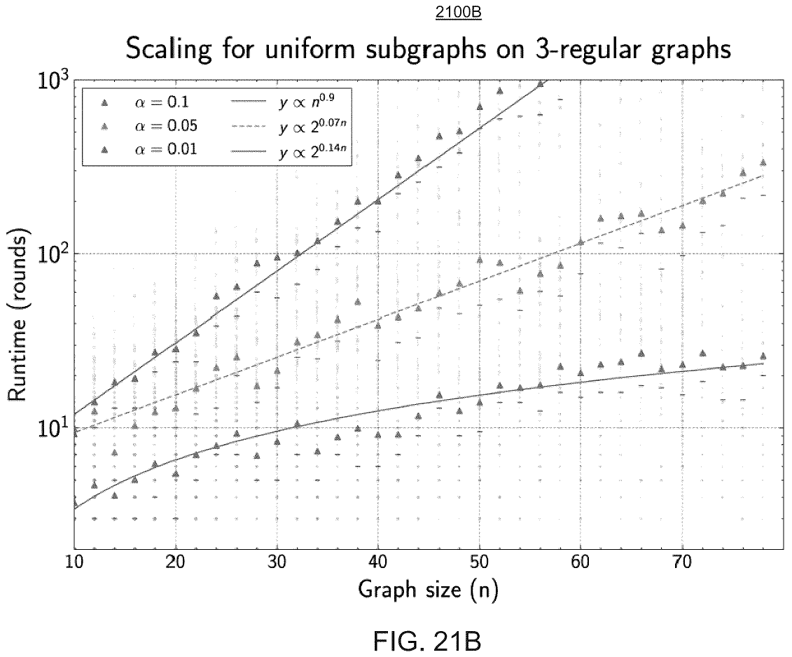

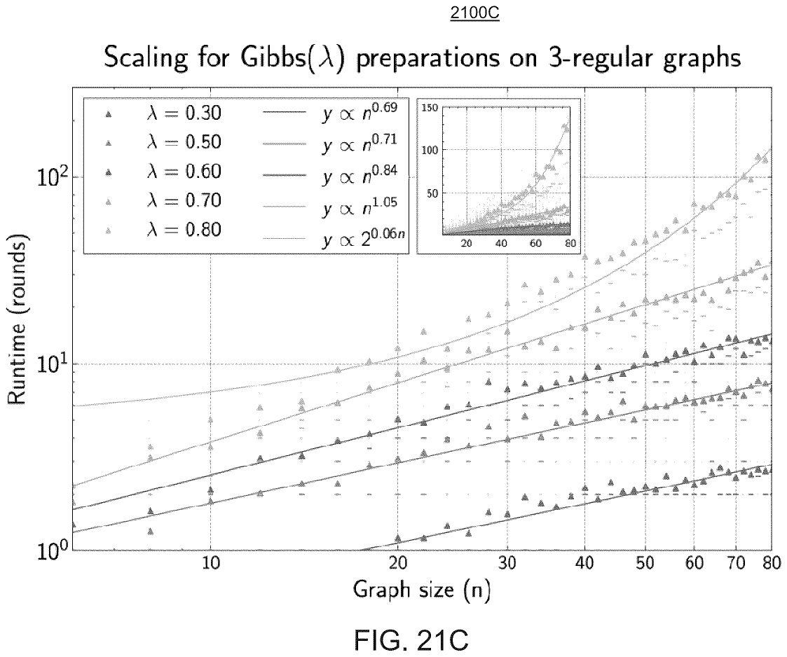

FIG. 21A plots runtime against graph size for uniform preparation on regular planar graphs;

FIG. 21B plots runtime against graph size for halting states with subgraphs;

FIG. 21C plots runtime against graph size for sublinear preparation of Gibbs distributions; and

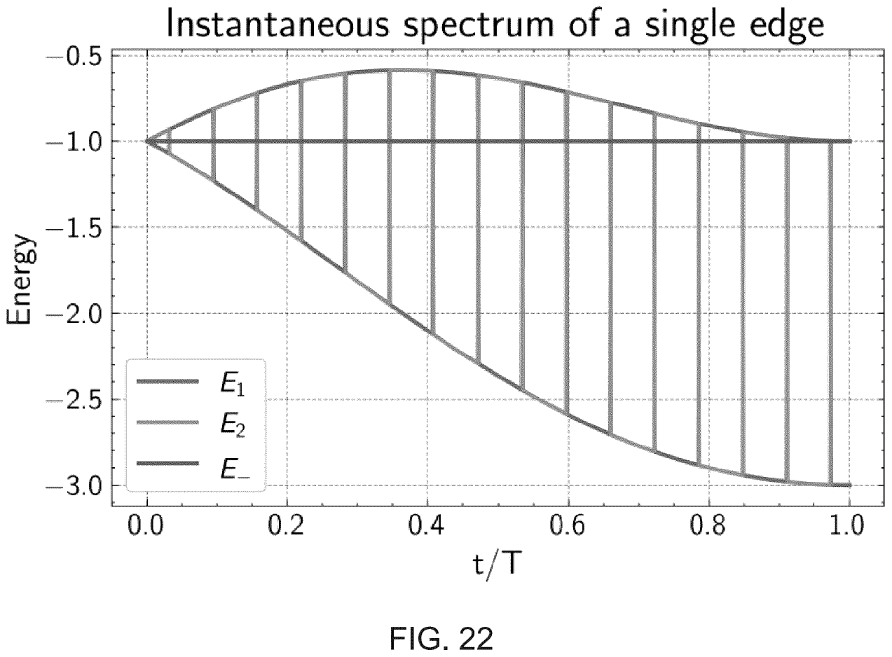

FIG. 22 plots an example graph of instantaneous spectrum of a single edge.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The systems, the methods, the computer-readable media, and the techniques disclosed herein for solving constrained optimization on quantum computers, like the variational quantum eigensolver (VQE) and quantum approximate optimization algorithm (QAOA), may implement cost functions by combining an optimization function with a constraint violation penalty function.

Advantageously, the present disclosure provides an optimization process or an optimization search which occurs within the constraint subspace. Like quantum error correction algorithms, a set of syndrome qubits may be used, separate from the data qubits, to monitor the progress of the quantum computation. Measurement of the syndrome qubits may be used to determine whether the constraints are satisfied. When a constraint violating qubit is identified, a recovery operation may be performed in order to return the qubit to a state which conforms to the constraint. Thus, the qubits used for the optimization inherently conform to the constraint without developing a cost function which incorporates both an optimization function and a constraint term. Methods and systems of the present disclosure use quantum resources more efficiently with a simpler optimization algorithm. As a further advantage, methods and systems of the present disclosure may effectively leverage the physical properties, such as the Rydberg blockade mechanism, of neutral atom quantum computers to reduce gate-depths and improve gate fidelity.

The present disclosure provides quantum algorithms, quantum hardware processes, and system and devices for implementing the same, for preparing constraint satisfying states during the course of an optimization algorithm running on quantum hardware. The algorithm may comprise the optimization algorithm itself and a subspace correction code.

The optimization algorithm may comprise a state preparation unitary matrix that progresses a quantum register to a solution state. The solution state may be an optimal solution. The solution state may be the solution to the optimization problem. The subspace correction code may comprise the manipulation of the quantum register by measurement and feedback based on the adherence of the state of the quantum register to constraints.

The optimization algorithm may comprise one or operations, which when implemented, are configured to solve an optimization problem. An optimization problem may refer to a problem that involves maximizing or minimizing an objective function along a domain to find a solution. The solution may be an optimal solution; however, in some cases, optimization problems may be terminated once the solution sufficiently approaches an optimal condition, e.g., reaching a set number of iteration, reaching a point where a change in the value of a solution is below a threshold, etc. Optimization problems may be continuous or discrete. In a discrete optimization problem, a solution such as an integer, a permutation, a graph, etc. is found from a countable set of possibilities, e.g., a discrete domain. In a continuous optimization problem, the optimal or best solution is found from a domain that is continuous. Discrete optimization problems may be generally more difficult to solve than continuous optimization problems.

In some cases, methods and systems of the present disclosure are implemented on a non-classical computer. In some cases, a non-classical computer comprises a quantum computer. In a quantum computer, data may be encoded into quantum bits (qubits), which can be in superpositions of states. A quantum register may be a system comprising multiple qubits, which the quantum analog of the classical processor register. A quantum computer may perform an operation by manipulating qubits within a quantum register. In quantum computing, a quantum logic gate may be a basic quantum circuit operating on a small number of qubits (e.g., one qubit, two qubits, three qubits, etc.). Like classical logic gates for conventional digital circuits, quantum logic gates are the building blocks of quantum circuits. Quantum gates may be unitary operators and may be described as unitary matrices relative to some basis.

The subspace correction code may comprise the manipulation of the quantum register by measurement and feedback based on the adherence of the state of the quantum register to constraints. The subspace correction code may comprise operations on one or more syndrome qubits. The quantum register may be divided into logical qubits and syndrome qubits. The quantum logic operations which form the quantum circuit may be performed on logical qubits. Syndrome qubits may comprise a set of support qubits outside the logic qubit set. In error correcting code, syndrome qubits may be used to provide redundancy. In the present disclosure, syndrome qubits may be used to determine adherence of the state of the quantum register to the correction.

Taking inspiration from error correcting codes, the systems, the methods, the computer-readable media, and the techniques disclosed herein implement constructing sets of operators to stabilize constraint subspaces that arise in Ising forms of various computational problems. The systems, the methods, the computer-readable media, and the techniques disclosed herein construct these stabilizers and demonstrate their efficacy in the problem of independent sets as well as demonstrating techniques for constrained problems (e.g., distribution preparation and depth reduction). The tools of the systems, the methods, the computer-readable media, and the techniques disclosed herein use new functionality of neutral atom quantum computing hardware as building blocks for algorithm development.

Using these tools, the systems, the methods, the computer-readable media, and the techniques disclosed herein construct a distribution preparation algorithm that can prepare Gibbs distributions over independent sets of a graph when coupled with a stopping conditions. For sub-critical values of the hardness parameter λ, the systems, the methods, the computer-readable media, and the techniques disclosed herein may be used to prepare some of these distributions in sub-linear time. Further, the systems, the methods, the computer-readable media, and the techniques disclosed herein may be used to reduce the depth for adiabatically preparing a good approximation to maximum independent set using quantum subspace correction in conjunction with a specialized adiabatic algorithm. In some cases, using the systems, the methods, the computer-readable media, and the techniques disclosed herein, constrained subspaces that are not difficult to prepare, but are nevertheless embedded in optimization problems of industrial or technological value may be prepared or maintained.

### Examples of Subspace Correction Coding

FIG. 10 is a schematic of an example process 1000 of implementing a subspace correction code of the present disclosure. Lines 1001, 1002, 1003, 1004, 1005, and 1006 show the time evolution each of six individual logical qubits. As the lines progress from left to right, time increases.

As shown, U_{A}(t) is a state preparation operation. The state preparation operation may be unitary. The state preparation unitary may comprise a time evolution of the quantum register. The state preparation unitary may be a portion of the optimization problem to be solved or may represent the entire optimization problem. The state preparation unitary may comprise one or more quantum logic gates. The state preparation unitary may evolve a state of one or more qubits along path 1001, 1002, 1003, 1004, 1005, and 1006.

As shown, Gc are constraint detection operations. A constraint detection operation may apply an entangling operation between a set of logical qubits subject to the constraint and a syndrome qubit (e.g., an ancilla). The type of operation implemented by the constraint detection operation may be set based on the constraint of the particular optimization problem as disclosed herein below.

While in the illustrated example, each constraint detection operation is shown to involve two logical qubits and an ancilla qubit, any number of qubits (e.g., logical or physical) and any number of ancilla qubits may be used. In some cases, one or more operations may be performed by one or more gates. For example, in some cases, a constraint detection operation may include 1 qubit to about 100 qubits. In some cases, a constraint detection operation may include 1 qubit to 2 qubits, 1 qubit to 3 qubits, 1 qubit to 4 qubits, 1 qubit to 5 qubits, 1 qubit to about 10 qubits, 1 qubit to about 25 qubits, 1 qubit to about 50 qubits, 1 qubit to about 100 qubits, 2 qubits to 3 qubits, 2 qubits to 4 qubits, 2 qubits to 5 qubits, 2 qubits to about 10 qubits, 2 qubits to about 25 qubits, 2 qubits to about 50 qubits, 2 qubits to about 100 qubits, 3 qubits to 4 qubits, 3 qubits to 5 qubits, 3 qubits to about 10 qubits, 3 qubits to about 25 qubits, 3 qubits to about 50 qubits, 3 qubits to about 100 qubits, 4 qubits to 5 qubits, 4 qubits to about 10 qubits, 4 qubits to about 25 qubits, 4 qubits to about 50 qubits, 4 qubits to about 100 qubits, 5 qubits to about 10 qubits, 5 qubits to about 25 qubits, 5 qubits to about 50 qubits, 5 qubits to about 100 qubits, about 10 qubits to about 25 qubits, about 10 qubits to about 50 qubits, about 10 qubits to about 100 qubits, about 25 qubits to about 50 qubits, about 25 qubits to about 100 qubits, or about 50 qubits to about 100 qubits. In some cases, a constraint detection operation may include 1 qubit, 2 qubits, 3 qubits, 4 qubits, 5 qubits, about 10 qubits, about 25 qubits, about 50 qubits, or about 100 qubits. In some cases, a constraint detection operation may include at least 1 qubit, 2 qubits, 3 qubits, 4 qubits, 5 qubits, about 10 qubits, about 25 qubits, or about 50 qubits. In some cases, a constraint detection operation may include at most 2 qubits, 3 qubits, 4 qubits, 5 qubits, about 10 qubits, about 25 qubits, about 50 qubits, or about 100 qubits. In some cases, the qubits may include more logical or physical qubits than ancilla qubits. In some cases, the qubits may include more ancilla qubits than logical or physical qubits. In some cases, the qubits may include approximately an equal number of logical or physical qubits and ancilla qubits.

After the constraint detection operation are applied, one or more ancillas may be measured at operation 1010. The illustrated example shows a processor (CPU/GPU), which may read out the measurement of each of the ancilla qubits. In some cases, the read-out may be loaded into the memory of a classical computation device such as a CPU, GPU, ASIC, etc. This processor may be the same as or similar to one or more components of the computer system 100 of FIG. 1. Based on the read-out values from the ancilla, the processor may determine whether a constraint violation has occurred. The processor may also determine the appropriate set of recovery operations, U_{R}, to perform. Although implemented in some cases as a classical computer, in other cases, the read-out may be implemented via classical logic gate (e.g., on an FPGA). In yet other cases, the read-out may be implemented via computing elements of a non-classical computer.

As shown, a set of unitary interactions (or non-unitary interactions, e.g., RESET) are applied to the quantum register to return it to the constrained subspace. For example, the unitary interaction may comprise an operator that is a surjective bounded operator on a Hilbert space that preserves the inner product. The set of interactions may be determined based on the type of error and constraint, as described herein below.

FIG. 15 illustrates another example process 1500 including a state preparation unit, U_{A}(t, α) with ancilla measurement. FIG. 15 illustrates a circuit executed with parameters α. As illustrated, the process 1500 may not integrate classical computing gates. In some cases, each gate of the process 1500 may be predetermined. In some cases, at least some of the gates of the process 1500 may be inserted while the process 1500 is running.

### Examples of Methods of Subspace Correction

Described herein are examples of the methods for constrained optimization using subspace correction. In some cases, the method may comprise providing a state preparation unitary operation, wherein the state preparation unitary operation comprises at least a portion of an implementation of a constrained optimization problem on the non-classical computer, and wherein the state preparation unitary operation is configured to evolve a quantum register to a solution state. In some cases, providing a unitary operation may comprise the computation, routing, optimization, and hardware application of the state preparation unitary operation for a desired length of time to evolve the quantum state.

In some cases, the method may comprise applying a constraint detection operation, the constraint detection operation comprising entangling an ancilla qubit with a set of logical qubits. In some examples, the constraint detection operation may comprise the computation, routing and optimization, and hardware application of controlled operations and ancilla measurements to collapse the quantum state either into or out of the constraint satisfying subspace and extracting the syndrome.

In some cases, the method may comprise measuring the ancilla qubit to determine whether a constraint of the constrained optimization problem is satisfied. In some cases, at a processor, the method comprises determining whether the constraint of the constrained optimization problem is satisfied.

In some cases, the method further comprises, subsequent to measuring the ancilla qubit, applying one or more recovery operations to the set of logical qubits, and wherein measuring the ancilla qubit comprises an indication that the constraint is not satisfied by the set of logical qubits. In some examples, the processor may determine a sequence of the one or more recovery operations based on an extent to which the constraint is not satisfied. In some cases, the method may comprise the classical computation of the extent of the constraint violation and the most acceptable recovery strategy to perform. In some cases, the method may comprise the computation, routing, optimization and hardware application of the recovery strategy onto the quantum register.

In some cases, the method comprises repeating the operations of the method until a stopping criterion is met. In some examples, the stopping criterion comprises reaching a threshold number of iterations or a threshold change in the solution state.

In some cases, the method further comprises subsequent to measuring the ancilla qubit outputting the solution state.

### Examples of Error Correction Applicability

As discussed, the systems, the methods, the computer-readable media, and the techniques disclosed herein may implement approaches that may be at least partially the same as or similar to error correction in quantum computers. Like quantum error correction algorithms, a set of syndrome qubits may be used, separate from the data qubits, to monitor the progress of the quantum computation.

The systems, the methods, the computer-readable media, and the techniques disclosed herein for subspace correction may generally have certain similarities with to approaches for error correction (e.g., error correction for qubit loss, bitflip loss, phase shift, etc.). However, instead of determining whether an error has occurred, measurement of the syndrome qubits may be used to determine whether constraints in a computational problem to be implemented on the non-classical computer are satisfied. When a constraint violating qubit is identified, a recovery operation may be performed in order to return the qubit to a state which conforms to the constraint. Thus, the qubits used for the optimization may conform to the constraint without developing a cost function which incorporates both an optimization function and a constraint term. In this respect, error correcting codes may be used to improve the calculation itself rather than to address for error.

Error Correction—Quantum error correction is a procedure for encoding quantum information in a distributed manner across many quantum systems in such a way that the information to be stored is protected from localized errors on the constituent systems, provided that these errors are sufficiently sparse. In some cases, the information to be stored and the constituent systems are both two-level quantum systems, or qubits. The information to be protected is encoded across many physical qubits, forming one or more logical qubits. Quantum computers based on trapped atoms may be subject to a number of different types of errors including errors generated by loss of qubit. In trapped atom quantum computers, a qubit may comprise atom in an array. That atom may be a neutral atom or an ion.

The process of detecting and correcting errors on the logical qubits amounts to measuring parities of a predetermined set of operators that act on the physical qubits and using the measured parities to diagnose and correct errors. In a simple example, a parity measurement checks the equality of two qubits to return a true or false answer, which can be used to determine whether a correction needs to occur. Additional measurements can be made for a system greater than two qubits. Since the physical qubits cannot be measured directly without collapsing the state of the logical system, these parities are measured using ancillary qubits (i.e., ancilla). Thus, there may be two types of physical qubits: data qubits on which the logical information is stored and ancilla qubits which are used to extract the desired parity checks.

In practice, an error correction cycle may include a sequence of gates to transfer parity values onto the ancilla qubits followed by measurement of the ancilla qubits. This process is known as syndrome extraction. Errors can occur at any point during the syndrome extraction process, including during readout of the ancilla qubits.

Error correcting codes may generally employ repeated implementations of the circuit implementing the quantum computation. As the circuit is implemented and re-implemented statistics may be generated on what errors occurred. Example errors include, for example, qubit loss, bit flips, loss of coherence, etc.

In some cases, error correction may include identification of an error (e.g., lost qubit, bitflip error, etc.) without stopping the circuit. For example, if a set of measurements are flagged as untrustworthy, the circuit may continue with other measurements and return to retake the measurements that were untrustworthy. For example, if a data qubit is fagged as missing, the circuit may continue on other qubits while the atom is replaced and a portion of a circuit comprising that qubit may be reimplemented.

In some cases, error correction may include identification of a lost qubit and replacement of the lost qubit without measurement of each or a plurality of data qubits. As noted above, a missing qubit may be identified in a round of syndrome measurements without measurement of the data qubit. Accordingly, an atom identified as missing may be replaced and a circuit may be continued without measurement of a data qubit.

In some cases, error correction may include identification of a lost qubit without loss of coherence of each or a plurality of data qubits. As noted, because the error correcting code uses measurements of syndrome qubits to identify atom loss, a data qubit may not need to be measured during around error correction. Accordingly, error correction may include continuous correction of atom loss or correction of atom loss mid-circuit.

Systems and methods of the present disclosure may be used in connection with error correction methodologies for quantum computing systems. An error correcting scheme (e.g., an implementation of an error correcting code) of the present disclosure may comprise a decoder and an error correcting code. A decoder may decode which errors occurred on which qubits. Once identified, these errors can be tracked and the information used to correct any subsequent measurement outcomes using the classical control software. The methods of updating the decoder described herein may not depend on the type of atom, the type of qubit, the type of error correction code, or the specific decoder used in the error correcting code. In some cases, an error correcting code may be of the class of stabilizer codes. If the two qubit-gate operation affects the Identity or a Pauli operation, then the matching graph passed to the decoder may be updated as described herein.

Systems and methods of the present disclosure may be used with various error correcting codes. An error correcting code may be a Shor style code. For example, in a Shor style code, repeated rounds of syndrome extraction may be implemented to overcome readout error and build confidence about the state of the system. The extracted syndrome information is then passed to a decoder to determine which errors have occurred and which corrections need to be applied.

Systems and methods of the present disclosure may be used with various stabilizer codes. A stabilizer code may be an error correcting code which uses stabilizers. A stabilizer code may be a class of error correcting code. The class of stabilizer codes may include toric codes, surface codes, etc. By repeatedly measuring a quantum system using a complete set of commuting stabilizers, the system may be forced into a simultaneous and unique eigenstate of all the stabilizers. One can measure the stabilizers without perturbing the system; when the measurement outcomes change, this corresponds to one or more qubit errors, and the quantum state is projected by the measurements onto a different stabilizer eigenstate.

An error correcting code may comprise a topological code. The class of topological codes may overlap with the class of stabilizer codes. A topological code may comprise a surface code, a color code, a toric code, etc. A topological code may also be referred to as a homological code. A topological code may comprise an array or lattice of qubits arranged on a surface (or higher dimensional structure). Systems and methods of the present disclosure may not generally change the underlying topology of a topological code.

Systems and methods disclosed herein may be used with various surface codes. A surface code may be implemented as a stabilizer code. For example, in the surface code literature, surface codes may comprise two types of qubits data qubits and measurement qubits (e.g., ancilla qubits). The data qubits may contain the information carried by the quantum circuit, whose error is to be corrected. The measurement qubits may be used to stabilize and manipulate the quantum state of the data qubit. In a surface code, the measurement qubits may comprise two types: measure-Z qubits and measure-X qubits. These two types of qubits may be called Z syndrome qubits and X-syndrome qubits respectively. The measure Z-qubits may measure the Z stabilizer. The measure X-qubits may measure the X stabilizer. In some cases, a surface code may be implemented with a decoder. In some cases, a surface code can address errors that occur during a surface code cycle as long as the errors that occur during each surface code cycle can be identified.

Systems and methods disclosed herein may employ surface codes. Surface codes disclosed herein may include, for example, variations upon the minimum-weight perfect matching algorithm to decode the surface code. However, many surface codes may be applicable to the systems and methods disclosed herein. A general description of surface codes is provided for example at Fowler, A. G., et al., Surface codes: Towards Practical Large-scale Quantum Computation, arXiv: 1208.0928 [quant-ph] 4 Aug. 2012, available at https://arxiv.org/pdf,1208.0928.pdf, which is incorporated by reference herein in its entirety.

Systems and methods disclosed herein may be used with various color codes. A color code may be implemented as a stabilizer code. For example, a color code may comprise a Steane code, etc. Systems and methods disclosed herein may be used with various Shor style codes, for example, a Bacon-shor code. A Shor style code may be implemented as a stabilizer code. Systems and methods disclosed herein may be used with various qLDPC codes, for example, hypergraph product codes. A qLDPC code may be implemented as a stabilizer code.

Systems and methods disclosed herein may be used with various decoders. An error correcting scheme (e.g., an implementation of an error correcting code) of the present disclosure may comprise a decoder and an error correction code. A decoder may decode which errors occurred on which qubits. Once identified, these errors can be tracked and the information used to correct subsequent measurement outcomes using the classical control software. Decoder algorithms may include, for example, minimum-weight perfect matching, union find, tensor network decoder, belief propagation with ordered statistics decoder, maximum likelihood decoder, and look up table decoders. Methods and systems of the present disclosure may be integrated with variations on the minimum-weight perfect matching such as sparse bloom and fusion blossom.

### Example Methods for Constraint Functionality

FIG. 13 is a flowchart of an example method 1300 for preparing a solution to a problem comprising a constraint on a non-classical computer. In some cases, preparing a solution to a problem comprising a constraint on a non-classical computer may comprise: providing a state preparation unit (1310); applying a constraint detection operation (1320); and measuring an ancilla qubit to determine whether a constraint is satisfied (1330).

Referring to FIG. 13, at the operation 1310 a state preparation operation may be provided. For example, the state preparation may comprise a unitary operation. In some cases, the state preparation operation comprises at least a portion of an implementation of a problem comprising a constraint on a non-classical computer. In some cases, the problem may comprise a constrained optimization problem. In one example, the constraint may comprise a one-hot coding constraint. In some embodiments, the constraint comprises a m-in-n constraint. In another example, the constraint comprises an independent set constraint. In another example, the constraint comprises a less than or equal to m-in-n constraint. In some cases, the state preparation operation is configured to evolve a quantum register to a solution state. In one example the quantum register comprises neutral atom qubits (e.g., strontium, ytterbium, etc.). In another example, the quantum register comprises nuclear-spin qubits. In another example, the quantum register comprises a set of qubits (e.g., data qubits, logical qubits, or physical qubits) and an ancilla qubit.

At the operation 1320, a constraint detection operation may be applied. In some cases, the constraint detection operation may comprise entangling an ancilla qubit with a set of data qubits. In some cases, the ancilla qubit is one of a set of ancilla qubits. In some cases, the set of data qubits comprise a set of logical qubits. In some cases, the set of data qubits comprise one or both of logical qubits or physical qubits. In some cases, the operation 1320 comprises applying a shelving pulse to the ancilla qubit to excite to a |clock 0 [symbol] state; applying a multiphoton excitation to the set of logical qubits from a 1-in-n state to a 1-in-(n+1) Rydberg state; applying a Rydberg to |clock 1 [symbol] pulse on the ancilla qubit; and deshelving the ancilla qubit. In other cases, the operation 1320 comprises applying a shelving pulse to the ancilla qubit to excite to a |clock 0 [symbol] state; applying a multiphoton excitation to the set of logical qubits from an n-in-n state to a m-in-(n+ancilla) Rydberg state; applying a Rydberg to |clock 1 [symbol] pulse on the ancilla qubit; and deshelving the ancilla qubit. In other cases, the operation 1320 comprises applying a Toffoli gate per edge. In other cases, the operation 1320 comprises, recursively for all m′ excitations greater than in: applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to clock 1) pulse on the ancilla qubit; and deshelving the ancilla qubit.

At the operation 1330, the ancilla qubit may be measured. In some cases, measuring the ancilla qubit may determine whether a constraint of the constrained optimization problem is satisfied. In cases where the ancilla qubit is one of a set of qubits, operation 1330 may comprise measuring the set of ancilla qubits. In some cases, measuring the ancilla qubit (or the set of ancilla qubits) may comprise collapsing at least part of a wavefunction into a new wavefunction, and determining whether the new wavefunction satisfies the constraint. In some cases, subsequent to operation 1330, the method 1300 may comprise applying one or more recovery operations to the set of data qubits when measuring the ancilla qubit in comprises an indication that the constraint is not satisfied. In some cases, subsequent to operation 1330, the method 1300 may comprise outputting the solution state.

FIG. 14 is a flowchart of an example method 1400 for detecting a status of a constraint. In some cases, detecting a status of a constraint may comprise: obtaining a data qubit and an ancilla qubit (1410), applying a constraint detection operation (1420); and measuring the ancilla qubit to determine whether a constraint is violated (1430).

Referring to FIG. 14, at the operation 1410, a data qubit and an ancilla qubit may be obtained. In some cases, the ancilla qubit may be one of a set of ancilla qubits. In some cases, the data qubit is one of a set of data qubits. In some cases, the set of data qubits are comprised of one or both of logical qubits or physical qubits.

At the operation 1420, a constraint detection operation may be applied. In some cases, the constrain detection operation may comprise an operation on the ancilla qubit with the data qubit. In some cases, the constraint detection operation may correspond to a constraint. In one example, the constraint may comprise a one-hot coding constraint. In some embodiments, the constraint comprises a m-in-n constraint. In another example, the constraint comprises an independent set constraint. In another example, the constraint comprises a less than or equal to m-in-n constraint. In some cases, the operation 1420 comprises applying a shelving pulse to the ancilla qubit to excite to a |clock 0 [symbol] state; applying a multiphoton excitation to the set of logical qubits from a 1-in-n state to a 1-in-(n+1) Rydberg state; applying a Rydberg to ═clock 1 [symbol] pulse on the ancilla qubit; and deshelving the ancilla qubit. In other cases, the operation 1420 comprises applying a shelving pulse to the ancilla qubit to excite to a |clock 0 [symbol] state; applying a multiphoton excitation to the set of logical qubits from an m-in-n state to a m-in-(n+ancilla) Rydberg state; applying a Rydberg to clock 1) pulse on the ancilla qubit; and deshelving the ancilla qubit. In other cases, the operation 1420 comprises applying a Toffoli gate per edge. In other cases, the operation 1420 comprises, recursively for all m′ excitations greater than in: applying a shelving pulse to the ancilla qubit to excite to a |clock 0 [symbol] state; applying a multiphoton excitation to the set of logical qubits from an in-in-n state to a m-in-(n ancilla) Rydberg state; applying a Rydberg to |clock 1 [symbol] pulse on the ancilla qubit; and deshelving the ancilla qubit.

At the operation 1430, the ancilla qubit may be measured. In some cases, measuring the ancilla qubit may help in determining whether the constraint is violated. In cases where the ancilla qubit is one of a set of qubits, operation 1430 may comprise measuring the set of ancilla qubits. In some cases, measuring the ancilla qubit (or the set of ancilla qubits) may comprise collapsing at least part of a wavefunction into a new wavefunction, and determining whether the new wavefunction satisfies the constraint. In some cases, subsequent to operation 1430, the method 1400 may comprise applying one or more recovery operations to the set of data qubits when measuring the ancilla qubit in comprises an indication that the constraint is not satisfied. In some cases, subsequent to operation 1430, the method 1400 may comprise outputting the solution state.

In some cases, one or more operations of one or both of the method 1300 or 1400 may be integrated within error correcting code. In some cases, the one or more operations disclosed above with respect to one or both of the methods 1300 or 1400 may be performed in any order. Further, at least one of the one or more operations disclosed above with respect to one or both of the method 1300 or 1400 may be repeated, e.g., iteratively. For example, in some cases, one or more operations of one or both of the method 1300 or 1400 may be repeated until a stopping criterion is met. In some cases, the stopping criterion comprises reaching a threshold number of iterations of a threshold change in the solution state.

### Example Applications to Maximum Independent Set

The following example illustrates an application of the systems, the methods, the computer-readable media, and the techniques disclosed herein to the maximum independent set problem. The maximal independent set is a problem in graph theory that seeks to identify the largest set that is not a subset of any other set. In other words, there is no vertex outside the independent set that may join it because it is maximal with respect to the independent set property. An independent set may be defined as: Given an undirected graph G=(V, E), an independent set comprises a subset of vertices I⊆V where no two vertices within I share an edge. Formally, for every u, v∈I, (u, v)∈/E.

A graph may be many maximal independent sets of widely varying sizes. The largest of, or possibly several equally large, maximal independent sets of a graph is called a maximum independent set. Maximum independent set is an NP-hard problem. Thus, it is difficult to solve on classical computers and is a promising target for quantum computation.

One example of the Ising form of the independent set problem is detailed in A. Lucas, Ising formulations of/many np problems, Frontiers in physics 2, 5 (2014), which is incorporated by reference herein for all purposes. In some cases of the independent set problem, each vertex in the graph corresponds to a qubit. When measured in the computational basis, the state of this qubit, which belongs to the set {0, 1}, may signify either exclusion (0) or inclusion (1) of the vertex in the set.

In some cases, for any two qubits that represent vertices connected by an edge, a measurement of |11 [symbol] state may indicate a violation of the independence constraint. In this way, an edge subspace that satisfies the independent set constraint, Vₑ, may be defined as any superposition over the basis states {|00 [symbol] , |01 [symbol] , |10 [symbol] }. The orthogonal complement of Vₑ on each edge is Vₑ and supported by the |11 [symbol] basis vector.

In some cases, for each edge, operator, ŝₑ may be such that all |ψ [symbol] ∈Vₑ are in the +1 eigenspace of ŝₑ, and all |ψ [symbol] ∈Vₑ are in the −1 eigenspace. This operator ŝₑ has the explicit form

$${\hat{s}}_{( i , j )} = \frac{1}{2} ( I + {Z}_{i} + {Z}_{j} - {Z}_{i} {Z}_{j} ) .$$

These operators have the following properties:
1. The operators {Ŝₑ} form a group:
   if Ŝₑ|ψ [symbol] =|ψ [symbol] and Ŝ_{e′}|ψ [symbol] =|ψ [symbol]
   then ŜₑŜ_{e′}|ψ [symbol] =|ψ [symbol]
2. The operators {Ŝₑ} are Abelian:
   if Ŝₑ|ψ [symbol] =|ψ [symbol] and Ŝ_{e′}|ψ [symbol] =|ψ [symbol]
   then ŜₑŜ_{e′}|ψ [symbol] =|ψ [symbol]
      The joint +1 eigenspace under all Ŝₑ for e∈E is:

$${\prod }_{e ∈ E} {\hat{S}}_{e} \vert ψ 〉 = + 1 \vert ψ 〉 for \vert ψ 〉 ∈ 𝒱$$

Given the properties of {ŝₑ}, this set of operators can be identified as the stabilizer of V, which represents the global subspace of all valid independent sets on a graph G=(V, E). For seeking the independent set with obeying states in a given graph G, quantum subspace correction may be applied to the relevant qubits. The result of measuring these stabilizers may create a violation graph that labels all edges where a violation of the independent set exists. Depending on the goal of the algorithm, a recovery can then be classically computed and implemented as unitary gates.

In some cases, measuring this stabilizer in practice may include finding the correct controlled unitary to implement onto an ancilla for a given set of constraints. The stabilizer for the independent set problem may, in some cases, correspond to a single Toffoli gate controlled on the edge qubits, acting on an ancilla. A primitive of this gate (CCZ) may be available as a native gate on neutral atom quantum computers due to the Rydberg interaction. Furthermore, in a restricted Clifford+T fault-tolerant quantum computing, Toffoli gates may be a low level building block using, for example, about 7 T-gates and about 8 Clifford gates. For a fully parallel implementation, the number of ancillae may be equivalent to |E|, potentially making use of the large numbers of qubits available on neutral atom quantum computing hardware. However, it may be possible to perform syndrome extraction with this stabilizing code using as few as one ancilla with repeated measurements and resets. In a fault-tolerant quantum computer, the stabilizing measurement rounds for quantum subspace correction may be mixed in with the regular quantum error correction cycle times, given that the error correction cycle may be long enough to allow for additional classical computation.

FIG. 18 illustrates an example process 1800 of syndrome extraction depiction with a violation and a recovery sequence. At a high level, the process 1800 includes initializing into the |+ [symbol] state at 1810, syndrome extraction at 1820, and recovering qubits into the |+ [symbol] state at 1830. Syndrome extraction depiction with a violation and the recovery sequence.

More specifically, in some cases, at 1810, a register is prepared in the |+ [symbol] ^{⊗N} state. In some cases, at 1820, a layer of Toffoli gates may be applied to the edges of a graph. On read-out of the ancilla, the state may be projected into V̅ₑ, while the vertices not dominated by the violation locations (illustrated as the three vertices not encircled in the dotted line) are in the |+^{V} [symbol] _{G} state for the violation free subgraph g. At 1820, then, in some cases, the syndrome graph having the location of violations, may be constructed. At 1830, in some cases, wherever a violation is found, both the vertices directly adjacent to edge violation and their neighbors are recovered. If two violations are within distance-1, the two violations may be merged into a larger cluster.

In some cases, 1810-1830 of the process 1800 may be repeated on affected edges. In other words, the process 1800 may be repeated on all edges with an unknown state (illustrated as the black and dashed edges). In some cases, this repetition may occur iteratively. In some cases, this repetition may occur until meeting a stopping criterion (e.g., as disclosed elsewhere herein).

FIG. 11 is an example of constraint detection for the problem of finding a maximally independent set on a 2-site graph Each node in the graph may be represented by a qubit. An ‘in’ node (filled circle) is a qubit in the |1 [symbol] state, whereas the empty circle is a qubit in the |0 [symbol] state.

In some cases, a register in a first state 1101 originally living within the constrained subspace is evolved under a state preparation unitary, U_{A}(dt), leading to the state being in a second state 1102 outside of the subspace, due to a contribution of |11 [symbol] .

Subsequently, a state detection gate Go is applied on the edge. In the problem of a maximally independent set of a two-state graph, if the edge is in state |11), the state may be flagged as outside the constraint. If the state is |00 [symbol] or |01 [symbol] , the state obeys the constraints. As shown there are two possible outcomes: the ancilla qubit is 0 with probability a²+b², leaving the superposition of valid states a/(a²+b²|10 [symbol] +b/(a+b²)|00 [symbol] with amplified probability amplitudes, yet otherwise undisturbed; or the result 1 such that the edge is known to be in state |11 [symbol] .

If the edge is known to be in state |11 [symbol] , a recovery can be applied to return it to a target state within the subspace.

FIG. 16 depicts another example of constraint detection for the problem of finding a maximally independent set. However, FIG. 16 extends the problem to a Y-shaped configuration. Notably, the systems, the methods, the computer-readable media, and the techniques disclosed herein may be applied to more complex problems of maximum independent set than just what is illustrated in FIG. 11 (such as the more complex problem illustrated in FIG. 16).

### Examples of Distribution Preparation

In some cases, preparing, manipulating, and extracting information from distributions may be computationally expensive for many graph-based problems, making these tasks an important focus in quantum computing applications research. The systems, the methods, the computer-readable media, and the techniques disclosed herein may demonstrate that the existence of a stabilizer on the Independent Set subspace may provide a subspace correcting algorithm that enables preparing probability distributions (or, e.g., partition functions) over independent sets of a graph G.

In some cases, the systems, the methods, the computer-readable media, and the techniques disclosed herein are applicable to the case for preparing a state |+^{V} [symbol] _{G} that encodes a perfectly uniform distribution over all independent sets of a graph G (V, E). This algorithm may extend to the case of preparing Gibbs distributions, denoted by |λ+V [symbol] _{G}.

Furthermore, in some cases, this algorithm may be a quantum analogue of perfect partial rejection sampling. The quantum-classical correspondence of this algorithm may enable certain run times (e.g., as disclosed herein), as-well as classically simulated run times on many classes of graphs, including those of large sizes, a luxury in quantum algorithm development, and a useful tool for application planning.

FIG. 19 illustrates an example process 1900 of subspace correction for quantum partial rejection sampling. As illustrated, the process 1900 illustrates for a given graph, G, applying a Hadamard Gate to qubits, forming a |+ [symbol] ^{N} state, applying stabilizers to all edges and coupled ancilla, reading out the ancilla to identify violations, and recovering to |+ [symbol] on all affected qubits. More specifically, the process 1900 includes operations of: initializing in |0 [symbol] ^{N} (1910); preparing |+ [symbol] ^{N} (1920); applying a stabilizer with ancillae (1930); measuring the ancillae (1940); determining a recovery region (1950); resetting affected qubits (1960); and obtaining a final state of uniform superposition (1970).

In some cases, one or more operations of the process 1900 of FIG. 19 may be performed in any order. Further, at least one of the one or more operations disclosed above with respect to the process may be repeated, e.g., iteratively. For example, in some cases, the process 1900 may be repeated until a stopping condition is met. This stopping condition may include, for example, a number of errors falling below a certain threshold. In one example, the threshold may be a nonzero number of errors. In another example, the threshold may be zero errors.

Referring to the process 1900 of FIG. 19, in some cases, application of Hadamard Gates to each of the data qubits may help prepare the data qubits from the |0 [symbol] state of 1910 into the |+ [symbol] state of 1920. In some cases, applying the stabilizer of 1930 may include applying a plurality of Toffoli gates (e.g., with each Toffoli gate applied to two data qubits and one ancilla qubit). In some cases, the ancillae at 1940 may be measured directly. Then, at 1950, based at least in part on this measurement, the recovery region may be identified at 1950. In some cases, resetting the affected qubits at 1960 includes resetting qubits in the recovery region back to the |0 [symbol] state. In some cases, at 1970, the final state of the qubits may be a uniform superposition of all independent sets.

Further, FIG. 20 illustrates an example classical algorithm of subspace correction as analogous to quantum partial rejection sampling of independent sets. The algorithm of the systems, the methods, the computer-readable media, and the techniques disclosed herein is a quantum analogue of partial rejection sampling. The classical version of the sampling independent sets is depicted as a process in FIG. 20. This classical process includes (A) randomizing each vertex; (B) finding a connected component of size at least two (shown as the inner outline encompassing four vertices); (C) adding the boundary (shown as the outer outline encompassing 10 vertices); and (D) resampling variables in this set, checking independence. Instead of a sample like in the classical algorithm, the quantum algorithm outputs the distribution as a quantum state. Advantageously, this quantum algorithm has high computational efficiency and freely provides runtime and extensions.

In some cases, a quantum approach to constructing the uniform distribution over all independent sets of a graph may use quantum subspace correction and Hadamard gates. The algorithm is visually demonstrated in the process 1800 of FIG. 18. For a given graph G (V, E), assume classical access to an immutable list of edges (E) and vertices (V). Assume a primary quantum register containing N=|V| qubits {qi}, whose state is represented by |ψ [symbol] . Assume an ancilla register with N_{A}=|E| qubits {aₑ}, represented by state |φ [symbol] . Also assume a mutable list of tuples A to track the edges containing violations and a list of integers B to track the vertices to be corrected. With these assumptions, the below algorithm provides uniform distribution preparation for the independent set.

Algorithm 1 Uniform Distribution Preparation for Independent Set

| 1: | \|ψ [symbol] ← \|+ [symbol] | [symbol] initialize quantum register |
|---|---|---|
| 2: | A ← E | [symbol] initialize list with all edges |
| 3: | B ← V | [symbol] initialize list with all vertices |
| 4: | while len(A) > 0 do | |
| 5: | \|φ [symbol] ← \|0 [symbol] | [symbol] reset ancillae |
| 6: | for e ∈ A do | |
| 7: | Toff(q_{e[0]}, q_{e[1]}, aₑ) | [symbol] extract syndrome |

| | |
|---|---|
| 8: | end for |
| 9: | A ← List[e for [symbol] ∈ A if Measure(aₑ) is 1] |
| 10: | B ← List[q_{υ} for υ in A ∪ Neighbor(A)] |
| 11: | for q_{υ} ∈ B do |
| 12: | \|q_{υ} [symbol] ← \|+ [symbol] |
| 13: | end for |
| 14: | end while |

Returns: [symbol] [symbol]
indicates data missing or illegible when filed

In some cases, Algorithm 1 will return a uniform distribution over independent sets (having extensions to Gibbs distributions). The intermediate state may be a uniform distribution at the completion of each step. For example, start the quantum register in the Hadamard basis [symbol] and the ancillas in the [symbol] state. In the bitstring basis, this is represented as:

$${{\vert + 〉 \vert 0 〉}_{a} = \frac{1}{{2}^{N / 2}} {\sum }_{k = 0}^{{2}^{N}} \vert k 〉 \vert 0 〉}_{a}$$

The stabilizing operators may be implemented by controlling a set of ancilla-targeting Toffolis on unknown edge states Consider a graph with N vertices and a single edge, this results in a state entangled across the registers:

$${{{Toff}_{{S}_{e}} {\vert + 〉 \vert 0 〉}_{a} = \frac{1}{{2}^{N / 2}} ( {\sum }_{k ∈ {𝒱}_{1}} \vert k 〉 \vert 0 〉}_{a} + {\sum }_{k ∈ {\overline{𝒱}}_{1}} \vert k 〉 \vert 1 〉}_{a} ) .$$

Both the left and right sums may be uniform superpositions over a set of bitstrings, with the left (right) being a uniform distribution of all states satisfying (violating) independence on the edge. Measuring the ancilla qubit applies projective measurements Π₀= [symbol] and Π₁= [symbol] . Hence, the state may always be collapsed into a uniform distribution. In the case that a violation is found on the edge, we have collapsed the state into:

$${{{{\text{?} \vert k 〉 \vert 1 〉}_{a} = \vert {+}^{v} 〉}_{g} \vert 1 〉}_{e} \vert 1 〉}_{a} ,$$

$$\text{?} \text{indicates text missing or illegible when filed}$$

where |+^{V} [symbol] _{G} is a uniform superposition of the independent set on the subgraph g=G/(A∪δ_{A}), which is G with the vertices of the violating edge and the neighboring vertices (δ_{A}) removed and |1 [symbol] ₑ=|11 [symbol] ᵢⱼ for the vertices (i, j)=e. The ancilla and violating qubits may be returned to the single qubit |0 [symbol] states and a Hadamard is applied to the violating qubits, preparing the state |+^{V} [symbol] _{G}+ [symbol] _{G}|0 [symbol] ₐ, where the procedure is repeated on the edge until success preparing the state |+^{V} [symbol] _{G} on the primary register. In some cases, for the more general case of |E| edges, a similar analysis shows that the distribution may be uniform. In this case, the distributions conditioned on the state of the ancilla register measurement still remain uniform.

As mentioned, the classical version of this algorithm may have a natural extension to Gibbs distributions. This is obtained by replacing the even sampling of each vertex from the {0, 1}, with drawing from a Bernoulli

$$( \frac{λ}{λ + 1} )$$

Distribution, where λ is the so-called hardness parameter. The final probability distribution from this process may assign a weight, up to an overall normalization, p(s)∝λ^{|s|} to a choice of bitstring from the set of independent sets, s∈IS, where s is the cardinality of the set and IS is the independent set. The extension of Algorithm 1 to prepare Gibbs distributions over IS similarly replaces the Hadamard gates, H, which prepare single qubits states |+ [symbol] with rotated gates, H_{λ}, that prepare the single qubit states. Algorithm 1 may be generalized to the following Algorithm 2 for a Gibbs distribution of the independent set:

Algorithm 2 Gibbs λ Distribution Preparation for Independent Set

| \|ψ [symbol] ← \|λ [symbol] | [symbol] initialize quantum register |
|---|---|
| A ← E | [symbol] initialize list with all edges |
| B ← V | [symbol] initialize list with all vertices |
| while len(A) > 0 do | |
| \|φ [symbol] ← \|0 [symbol] | [symbol] reset ancillae |
| for e ∈ A do | |
| Toff(q_{e[0]}, q_{e[1]}, aₑ) | [symbol] extract syndrome |

```
    end for
    A ← List[ [symbol] for [symbol] ∈ A if Measure(aₑ) is 1]
    B ← List[q_{υ} for υ in A ∪ Neighbor(A)]
    for q_{υ} ∈ B do
      |q_{υ} [symbol]   ← |λ₊ [symbol]
    end for
  end while
Returns: |ψ [symbol]   in the state |λ₊ν [symbol] [symbol] [symbol]
indicates data missing or illegible when filed
```

In some cases, the runtime of Algorithm 1 can be bounded analytically, or simulated classically without using quantum simulation techniques; instead, using the classical mapping to partial rejection sampling. To consider the runtime, generalize the case of the Gibbs distribution in hardness-parameter λ, where λ=1 corresponds to the uniform distribution case. This enables directly quoting the results of runtime analyses from the classical process. For graphs of bounded degree-d, the hardness parameters bounded by the inequality,

$$λ < \frac{1}{2 \sqrt{ed} - 1} ,$$

had a worst-case runtime that was, on average 0(n), and with a high probability of O(n log n). This is a lower bound on λ*d, which represents the largest X for which all graphs of bounded degree d converge with this expected runtime. With the knowledge of these analytical bounds, graph classes may be modeled up to size n=80 by directly applying the classical algorithm for partial rejection sampling to graphs chosen from random using either an appropriate random sampling function or construction of an unbiased graph sampling algorithm. Mean and median data may be calculated from samples (e.g., at least 100 samples) for each graph size point. These runtime results, shown in FIGS. 21A-21C, examine scaling for planar graphs, sub-graph approximations, and empirical results for Gibbs state preparation, finding sub-linear scaling on average for larger X values than the provided bounds on average case instances.

FIG. 21A provides an illustration of a graph 2100A corresponding to empirical runtimes for uniform preparation on regular planar graphs. Specifically the graph 2100A plots uniform preparation runtime vs. graph size in planar graphs of bounded-degree d, obtained by running the classical dual algorithm up to graph size n=80. Triangular data points represent mean runtimes for 200 random graphs for each n. “X” markers indicate that the runtime exceeded the maximum number of tried (5×10⁵ for d=4 and 5×10⁴ for d=3). For planar graphs of size d=3, the graph 2100A illustrates weakly exponential runtimes asymptotically for the average case. The dashed lines represent the best and worst possible runtimes for any graph of size n.

As shown in the log—log plot of the graph 2100A in FIG. 21A, the average runtime for planar graphs of bounded degree d=3 asymptotically limit to weak exponential scaling. FIG. 21A was made by running the algorithm for 200 random graphs per data point and recording the number of rounds required to reach the algorithm termination condition. The random graphs may be drawn from a custom script that uniformly samples planar graphs of a given bounded degree. The histogram of runtimes may be heavily skewed toward fewer rounds, as indicated visually and by the median (dashed points), with a long tail of low probability-high rounds events. Planar graphs of bounded degree d=4 are clearly exponential beyond a graph size of n=30, and d=2 has clear logarithmic scaling in graph size. Despite weakly exponential behavior, the number of quantum subspace correction rounds for graph sizes required for many real-life applications (e.g., as few as O(100)) may not be prohibitive to using the algorithm to prepare states for further processing if a uniform distribution was desired for the application. It is also important to remember that the number of rounds is not the number of repeated circuit executions, but is instead proportional to the total (logical) circuit depth.

FIG. 21B illustrates halting states on u with subgraphs. Specifically, FIG. 21B illustrates a graph 2100B. In the graph 2100B, triangular data points represent mean runtimes for 100 random graphs for each n. The dash marker represents the median. The graph 2100B illustrates scaling for preparation of ga subgraphs. The fit curves of the graph 2100B illustrate that, at least for graph sizes up to n˜80, halting states for α≥0.10 have runtimes that scale efficiently with graph size.

As depicted in the graph 2100B, rather than run the algorithm to completion, an early halting condition may be used based on the fraction of edges, α=|A|/|E|, that are permitted to have violations. This results in a termination into the state:

$${{\text{?} = \vert {+}^{v} 〉}_{{g}_{a}} \vert 1 〉}_{A} \vert 0 〉 {\partial }_{A} ,$$

$$\text{?} \text{indicates text missing or illegible when filed}$$

where g_{α}=GA∪∂_{A} is the subgraph less the vertices associated with violating edges.

In some cases, similar to the graph 2100A of FIG. 21A, in the graph 2100B, each data point represents runs from 100 random 3-regular graphs generated using a random regular graph generating function for all allowable graph sizes up to n=80 for d=3. The graph 2100B demonstrates with numerical evidence that for graph sizes up to n≈80, approximations with α≈0.1 can be prepared sub-linearly in the average case. These results may extend to larger graph sizes using a more streamlined simulation technique, or verified analytically. From such a state, application of a unitary operation on [symbol] may yield a target uniform state spanning a larger fraction of the states. For example, preparing |+^{V} [symbol] _{esequentially} on each violating edge e may provide a uniform distribution on the subgraph induced by G/B, where the boundary |0 [symbol] _{∂} a vertex states are collapsed. This, in practice on graphs small enough to simulate quantum circuits on (n≤15), may result in uniform distributions that span at least a subset of the independent set.

FIG. 21C illustrates sublinear preparation of Gibbs distributions. Specifically, FIG. 21C illustrates a graph 2100C with Gibbs preparation of various λ states on 3—regular graphs. While the loose analytical bound for efficient scaling for worst-case graphs are around λ*3˜0.15, empirically, average case graphs may scale sublinearly in rounds up to λ≈0.7. The inset provides the linear-linear view of the plot to show the phase-transition in hardness more clearly.

In some cases, the algorithm can be adapted to prepare Gibbs distributions over the independent sets, as states of the form of

$$\vert λ + v 〉 \text{?} = \text{?} {\sum }_{s ∈ IS} {λ}^{\vert s \vert} \vert s 〉 〈 s \vert ,$$

$$\text{?} \text{indicates text missing or illegible when filed}$$

where the normalization factor is:

$$\text{?} = {\sum }_{s ∈ IS} {λ}^{\vert s \vert} ,$$

$$\text{?} \text{indicates text missing or illegible when filed}$$

rather than uniform distributions. These distributions fully span the independent sets, but have a weight dependent on the chosen hardness parameter λ. The graph 2100C evaluates the expected runtime for preparing Gibbs distributions on 3—regular graphs for various λ values. As illustrated, each data point in the graph 2100C corresponds to 100 random graphs generated a random regular graph generating function (e.g., as disclosed elsewhere herein) for all allowable graph sizes up to n=80 for d:=3. While the limits worked out analytically refer to average runtimes of worst-case graphs in their respective classes, distributions for random graphs may be efficiently prepared, on average, up to about λ˜0.7. This result is notable considering the value of perfectly prepared q-sampling state when used as an input to other algorithms such as Grover's Search, Quantum Counting, or potential distribution comparison algorithms.

As illustrated in the FIGS. 21A-21C, mapping to classical runtimes is can present certain challenges as, for the case of direct sampling from perfect distributions, this algorithm may not produce a single sample more efficiently than a classical computer. However, the output of this algorithm may be the entire distribution amplitude encoded into the quantum register, while the output of the classical sampling algorithm may be a single bitstring. Notably, some algorithms for approximately uniform sampling using adiabatic and Markov methods are approximate preparations.

In some cases, the ability to produce perfect distributions, |ψ [symbol] =Σ_{sϵIs}\sqrt{pₛ|s}, with known distribution properties may be a useful resource, especially when these distributions can be prepared in sub-linear time like the Gibbs distributions for sub-critical λ. Such a resource state, which spans the entire basis of independent sets, may serve as the first step in an algorithm that probes quantitative proprieties of the graph. For example, using amplitude amplification, a set of independence number k can be found within O(N) time, where mₖ is the multiplicity of sets of independence k, for λ<λ*. Further, in some cases, states may be used as the inputs to distribution tests, for example, using orthogonality tests as.

Advantageously, another property of the distribution algorithms is that if the phases of the states in the distribution do not matter for the follow tip to the algorithm, then one only needs to correct for bit-flip errors during the state preparation. The result from a bit-flip corrected implementation of this code may still have a classical probability distribution encoded into the amplitude of states, but the phase from those states may be randomly distributed according to the mechanism of phase errors. This code may also be robust to leakage errors due to qubit loss, as detection of leakage and atom replacement can be built into the qubit subspace correction protocol.

### Examples of Applications to Constrained Optimization

In some cases, the systems, the methods, the computer-readable media, and the techniques disclosed herein may apply to constrained optimization problems of adiabatic depth reduction. In addition to the distribution preparation protocol disclosed herein with respect to FIGS. 21A-21C, quantum subspace correction may be used to stabilize constraint subspaces during the execution of an optimal state preparation algorithm. In some cases, one way constrained optimization problems may be distilled for quantum computation is to map them to an Ising-like Hamiltonian, e.g., as demonstrated in A. Lucas, Ising-formulations of many np problems, Frontiers in physics 2, 5 (2014), which is incorporated by reference herein for all purposes. The Hamiltonian of these problems may have a common structure, namely, they may be the sum of two component Hamiltonians, H=λH_{A}+H_{B}, where H_{A} encodes a set of constraints on the qubits as its lowest energy state, and H_{B} encodes the objective as its lowest energy states, and λ is a Lagrange multiplier that approximately signifies the importance of the constraints in the energy landscape. An adiabatic, or adiabatic-inspired algorithm may then be run to find the low-energy states of this problem.

In some cases, a challenge for such approaches is that such algorithms may return invalid (e.g., constraint violating) states with high probability. This may be either due to expressibility of parameterized variational ansatz, such as in a quantum approximate optimization algorithm, or due to errors from non-adiabatic terms in adiabatic evolution (or the Trotterization of the non-adiabatic terms in adiabatic evolution). The systems, the methods, the computer-readable media, and the techniques disclosed herein demonstrate how quantum subspace correction may improve adiabatic algorithms by explicitly constraining the algorithms to run in the intended subspace. Specifically, quantum subspace correction may help reduce the depth of optimization problems using adiabatic preparation. Disclosed herein are examples demonstrating using quantum subspace correction to reduce the circuit depth used to approximate solutions to maximum independent set for a given graph G=(VE).

In some cases, the Non-Abelian adiabatic evolution of the maximum independent set algorithm may be written by the constraint Hamiltonian.

$${H}_{A} = - Δ {\sum }_{( ij )} {Z}_{i} + {Z}_{j} - {Z}_{i} {Z}_{j} ,$$

where the sum runs over all edges [symbol] in G, Z, are Pauli-Z matrices acting on the 1-qubit subspace of the ith, and Δ is an energy scale. Therefore, the objective Hamiltonian is given by

$${H}_{B} = - {\sum }_{i} {Z}_{i} ,$$

such that maximizing the number of qubits in the single-qubit |1 [symbol] state minimizes the value of this term.

In some cases, a non-abelian adiabatic state preparation algorithm, UA(t), may be used, such as that of (1) H. Yu, F, Wilczek, and B. Wu, Quantum algorithm for approximating maximum independent sets, Chinese Physics Letters 38, 030304 (2021) or (2) B. Wu, H. Yu, and F. Wilczek, Quantum independent-set problem and non-abelian adiabatic mixing, Phys. Rev. A, 101, 012318 (2020), each of which are incorporated by reference herein for all purposes. Advantageously, with this algorithm there is a large gap protecting the independent set subspace at all points in the evolution. In some cases, the systems, the methods, the computer-readable media, and the techniques disclosed herein for state preparation differ from standard annealing that relies on ramping-out of a transverse field. Rather, the constraint Hamiltonian H_{A} is taken to be the problem Hamiltonian, and the optimization is carried out by a slow global rotation applied the quantum register. Prior to the start of the algorithm, the quantum register may be prepared in a least optimal state (e.g., a state that maximizes H_{B}) within V In the case of maximum independent set, this may simply be |0 [symbol] . The combined action of H_{A} and the slow global rotation induces mixing in the ground-state subspace, evolving the register toward the most optimal state while staying within V for a sufficiently slow rotation.

Notably the form of the constraint Hamiltonian provided about is, up to a resealing and shift, identical to the stabilizer for independent set. The sum of this Hamiltonian runs over edges, and on each edge, the Hamiltonian has the spectrum:

$${E}_{( ij )} = \begin{matrix}- Δ & {{{\vert 00 〉}_{ij} , \vert 01 〉}_{ij} , \vert 10 〉}_{ij} \\ 3 Δ & {\vert 11 〉}_{ij}\end{matrix} .$$

In some cases, the Hamiltonian contains a ΔE=4Δ gap between the ground state and the first excited state. The ground state subspace of this Hamiltonian, and hence the V of the full optimization problem, may be the set of the independent sets of a graph, G.

Assume the complex representation of the global SO(3) rotation over N qubits:

$${U}_{B} ( θ , φ ) = {( \begin{matrix}- cos ( θ / 2 ) & {e}^{i φ} sin ( θ / 2 ) \\ \text{?} sin ( θ / 2 ) & cos ( θ / 2 )\end{matrix} )}^{⊗ N} ,$$

$$\text{?} \text{indicates text missing or illegible when filed}$$

where θ=θ(t) and φ=φ(t) are parameterized functions of time. The ideal adiabatic evolution then takes the form

$${U}_{A} ( t ) \text{?} = \text{?} = \text{?} ,$$

$$\text{?} \text{indicates text missing or illegible when filed}$$

for H(t)=U_{B}(t)HU⁻¹_{B}(t).

In some cases, at the end of the evolution, a bit flip operation is applied to all qubits in the register, and the register may be read out in the computational basis. If the evolution was sufficiently slow enough, e.g., slow enough to not close the exponentially small gap in the effective gauge Hamiltonian, then the measured state will, with a high probability, be a maximum independent set.

In some cases to target a universal gate-based algorithm, the unitary evolution is Trotterized and converted to gates, which, may thereby introduce additional errors that lead to the quantum register returning invalid states when measured in the computational basis. A first-order Trotterization converts (U_{A}(t) into a form appropriate to transpile into a gate sequence:

$${U}_{A} ( t ) \approx \text{?} {U}_{B} ( ndt ) {{e}^{-}}^{{idtH}_{A}} {U}_{B}^{- 1} ( ndt ) \approx {U}_{B} ( {N}_{t} ) \text{?} {{e}^{-}}^{{idtH}_{A}} {U}_{B}^{- 1} ( ndt ) {U}_{B} ( ( n - 1 ) dt ) = {U}_{B} ( {N}_{t} ) \text{?} {δ U}_{A} ( n ) ,$$

$$\text{?} \text{indicates text missing or illegible when filed}$$

where in the second line the terms are shuffled such that after every application of δU_{A}(n), the quantum register is in the basis that the constraint H_{A} is applied in. The leftover U_{B}(t) is a full θ=π rotation of the register and can be conveniently omitted to prevent having to classically apply bit-flips to each element of the bitstring

In some cases, using parameter selections—restricting to a good approximation of adiabatic evolution in continuous time—Trotter step size may become the free parameter in this algorithm that controls depth. Trotter errors may, in some cases, play a dominant role in the creation of excitations out of the ground state manifold, unless, for example, the step size chosen is below the Trotter transition.

Turning to quantum subspace correction for non-Abelian maximum independent set, quantum subspace correction may be applied in the Trotterized algorithm by interleaving the stabilizer extraction and recovery gates between successive δU_{A}(n)—hence, while the quantum register is in the correct basis to respect constraints. In some cases, quantum subspace correction is not applied at every operation.

With focus on recovery operations, in some cases, because the state preparation may be adiabatic, the quantum register may remain in the instantaneous ground-state (e.g., or at least the low-energy manifold) of a time dependent Hamiltonian, which eventually evolves to have maximum independent set as the ground state. In the moving frame of a Hamiltonian dependent on parameters φ, a state evolves as:

$$\text{?} = ( \text{?} HU - \text{?} ) \text{?}$$

$$\text{?} \text{indicates text missing or illegible when filed}$$

Define Ā_{φ}=iU†∂_{φ}U so that in the moving frame, H̅=H+φA_{φ}, where H̅ with φ and its eigenvectors and eigenvalues may be calculated for a graph with two vertices and a single edge between them after a first-order expansion in slow parameters (\dot{θ}, \dot{φ}). In particular, the eigen states may be |11 [symbol] with an energy E₁₁=4Δ the Bell states are

$$\vert {ϕ}^{-} 〉 = \frac{1}{\sqrt{2}} ( \vert 01 〉 - \vert 10 〉 )$$

with an energy E=0 and a time d epend ent mixture of the remaining two eigenstates that are combinations of the {|00 [symbol] , |01 [symbol] , |10 [symbol] } basis states.

FIG. 22 illustrates a graph 2200 depicting an instantaneous spectrum of a single edge. The graph 2200 plots energy as a function of t/T. More specifically, the graph 2200 depicts exact instantaneous spectrum of the Non-Abelian Adiabatic algorithm for MIS, calculated for a single edge. As illustrated, the |- [symbol] Bell State always has constant energy in the moving frame. The ground state of the system is a time-dependent function of the remaining two constraint-satisfying basis states. The frequency of oscillation between the two states is dependent on φ.

In some cases, when running the ideal algorithm on a single edge, the exact recovery upon projecting into the violating state |11 [symbol] should be applying a unitary to prepare the lowest energy state at time t. This can be done by numerically computing the form of the lowest energy eigenstate at time t, and applying a gate sequence to prepare that two-qubit state.

In some cases, in a larger graph, this method of determining the correct recovery faces two challenges. The first is that finding the optimal target state of a recovery in the same way may include classically simulating the entire quantum system, which is self-defeating. Moreover, for a graph with multiple adjacent edges, syndrome extraction of violations may result in projecting boundary vertices into the |0 [symbol] state, similar to the sampling algorithm. This may result in an overall degradation of the solution as the objective is to find maximum independent set, or an approximation.

In some cases, despite these challenges, the systems, the methods, the computer-readable media, and the techniques disclosed herein provide using a simple recovery strategy inspired by the isolated edge case. Empirically, the systems, the methods, the computer-readable media, and the techniques disclosed herein provide tests of local recovery strategies into the independent set substance of general graphs under adiabatic evolution, including preparing violating edges into |00 [symbol] , |φ− [symbol] , and |+ [symbol] . In some cases, favorable results may be obtained when replacing the two qubit state of any detected violation with the wavefunction of the isolated edge system under the same evolution at the appropriate time t. This approximation may be effective in small graph sizes with low connectivity.

In some cases, quantum subspace correction may protect against Trotter errors, for example, as evidenced in how the algorithm outcomes behave as a function of Trotter step size with all other algorithm parameters held fixed.

FIG. 17A plots in graph 1700A the average size of the independent sets over the size of the maximum independent set for S₄ graphs. Specifically, the graph 1700A compares the bare non-Abelian adiabatic algorithm and the same algorithm using quantum subspace correction with the isolated edge recovery applied at regular intervals. As illustrated in the graph 1700A, solution quality dramatically improves in much fewer Trotter steps for subspace correction as compared to the exact solution. Similar behavior may be observed in graphs of different sizes, such as, via testing with random graphs. Accordingly, as illustrated in FIG. 17A, the isolated edge ansatz performs well in practice, demonstrating efficacy of more detailed recovery strategies that involve harder classical computations and larger recovery clusters that may reduce depths for adiabatic algorithms.

FIG. 17B plots in graph 1700B the probability of finding each independent set size for the exact algorithm and the algorithm with quantum subspace correction for S₄ graphs. On the left panel of the graph 1700B is the probability of finding each independent set size for the exact algorithm. On the right panel of the graph 1700B is the probability of finding each independent set size for the algorithm with quantum subspace correction. The graph 1700B, plotting the probability of finding different independent set solutions shows that the figure of merit of the graph 1700A is boosted by a high probability of finding a favorable approximation to maximum independent set. Further, as shown in the graphs 1700A and 1700B, asymptotically, the solutions converge to the same probabilities as the rate of errors vanish through the Trotter transition.

Findings similar to those of FIGS. 17A and 17B are illustrated FIG. 17C, which plots in graph 1700C the average size of the independent sets over the size of the maximum independent set for S₅ graphs and FIG. 17D, which plots in graph 17001), the probability of finding each independent set size for the exact algorithm and the algorithm with quantum subspace correction for S₅ graphs.

FIGS. 17A-17D may model findings of modeling Sₙ graphs that align with those of H. Yu, F. Wilczek, and B. Wu, Quantum algorithm for approximating maximum independent sets, Chinese Physics Letters 38, 030304 (2021), which is incorporated by reference herein for all purposes. The graphs of Yu et al. may feature an exponentially small gap in the instantaneous frame. In modeling the FIGS. 17A-17D, quantum subspace correction may be applied every 10 Trotter steps, or once every N_{T}/4, whichever is smaller. However, in practice, any number of Trotter steps may demonstrate this phenomenon (e.g., 1 step, about 5 steps, about 10 steps, about 25 steps, about 50 steps, about 100 steps, etc.)

For the recovery of FIGS. 17A-17D, a recovery may be similar to the isolated edge wavefunction disclosed elsewhere herein (e.g., limited by the functionality of commercially available simulators). Further, in some cases, syndrome extraction may be performed in a serial fashion on each edge. If during extraction, a violation of the constraint subspace is detected, the two corresponding edge qubits may be reset and prepared in the state that an isolated edge graph would be in under the same evolution protocol. In some cases, this algorithm may then move to the next edge in the graph.

Notably, this algorithm of FIGS. 17A-17D may have certain differences from reading out all ancillas and then determining a recovery. In some cases, the behavior of the adiabatic algorithm may be complicated (e.g., even in the exact case). For example, the small region of high probability to find a good approximation at O(10) steps may comprise an artifact that vanishes with increasing problem size and may be dependent on the numerical value of \dot{φ}. FIGS. 17A-17D may illustrate a focus on behavior at increasing step sizes, showing that at about half the depth of the transition in Trotter error for the exact case, there may be a transition in solution behavior in the quantum subspace correction version. In particular, FIGS. 17A-17D illustrate that, in some cases, one of the next best approximations to maximum independent set becomes the most probable bitstring. In some cases, the two solutions asymptotically converge as Trotter error vanishes.

### Examples of Hardware Implementation

The computational elements involving syndrome measurement and recovery, (e.g., to transfer information from the qubits in the quantum register to ancilla qubits for measurement, to implement the recovery transformation, etc.) involve large, multi-qubit gates that can be broken down into universal single and two-qubit gate sequences of increasing depth. On neutral atom devices, however, these sequences can be made to be a finite depth cost due to the mechanism of multi-qubit Rydberg blockades. The Rydberg blockade can be utilized, in combination with a number of laser pulses, to prepare states that are specifically beneficial for the syndrome extraction and recovery sequence of this algorithm.

A Rydberg state is a highly excited state of a neutral atom which exhibits relatively long-range dipolar forces. When a neighboring atom is near to the Rydberg excited atom, the electric field created by the Rydberg excited atom induces an energy shift in the adjacent atom conditioned on sufficient proximity of the Rydberg excited atom and its excitation in the Rydberg state. In some cases, when the Rydberg excited atom is sufficiently proximate the neighboring atom, the energy shift may be sufficiently large such that the transition between the ground state and the Rydberg state of the neighboring atom is detuned from the laser frequency and the Rydberg transition is strongly suppressed. In this case, the neighboring atom is said to be blockaded.

The following lists provides a number of constraint forms that appear in quadratic unconstrained binary optimization formulations of constrained optimization problems and their implementation on neutral-atom quantum computing hardware.

One-hot-encoding constraints: One-hot encoding constraints appear in QUBO Hamiltonians to ensure that only a single bit out of a group of n bits is in the |1 [symbol] or “hot” state. Detection of compliance with the constraint may comprise a finite Rydberg Blockade. The detection operations may comprise preparing an ancilla qubit in the |0 [symbol] state. Once the ancilla qubit is prepared, the detection operations may comprise: applying a shelving pulse to move the ancilla to the clock 0) state; applying a multiphoton excitation to the set of logical qubits to move them from a 1-in-n state to the 1-in-(n+1) Rydberg state; applying a |ryd [symbol] to |clock 1 [symbol] pulse on the ancilla qubit; deshelving the ancilla qubit, and readout of the ancilla qubit.

The recovery operations may comprise preparing a superposition of states over all possible registers containing a single qubit in the |1 [symbol] computational state. In another example, for smaller numbers of involved qubits (e.g., about nine), recovery can be accomplished on a constraint violating group by: applying RESET operation to affected qubits. Subsequent to the reset, a recovery operation comprises: a) shelving the qubits in the |0 [symbol] state to the |clock 0 [symbol] state; b) exciting the |clock 0 [symbol] state with a pulse to the |ryd [symbol] state for pi/sqrt(N) time; c) applying the Rydberg de-excitation beam to |clock 1 [symbol] ; and d) deshelving all qubits from the clock states.

m-in-n encodings: M-in-n constraints appear in QLTBO Hamiltonians to ensure that only in qubits out of a group of n bits is in the 1 state. To detect compliance with the constraint, in a first operation, an ancilla may be prepared in the |0 [symbol] state. In a second operation, a shelving pulse may be applied to the ancilla to place it in the |clock 0 [symbol] state; a multiphoton excitation may be applied to the logical qubits from in-in-n state to the m-in-n+ancilla Rydberg energy; applying Rydberg to |clock 1 [symbol] pulse on ancilla; deshelve the ancilla; and readout of the ancilla qubit.

The recovery operations may comprise preparing a superposition of states over all possible registers containing a m qubits in the |1 [symbol] computational state. In another example, for smaller numbers of involved qubits (e.g., about nine), recovery can be accomplished on a constraint violating group by: applying a RESET operation to affected qubits. Subsequent to the reset, a recovery operation comprises: a) shelving the qubits in the |0 [symbol] state to the |clock 0 [symbol] state; b) exciting the |clock 0 [symbol] state via multiphoton process to the |ryd [symbol] ; c) applying the Rydberg de-excitation beam to |clock 1 [symbol] ; and d) deshelving all qubits from the clock states.

Independent Set: The independent set constraint can be implemented by applying a single Toffoli gate per edge. For a single isolated edge projected to the |11 [symbol] state, recovery involves the gate sequences shown in FIG. 12.

Less than or equal to m-in-n, etc: The less than or equal to m-in-n constraint can be detected by for m′ excitations for m′ [symbol] m recursively: recursively for all m′ excitations greater than m: applying a shelving pulse to the ancilla qubit to excite to a |clock 0 [symbol] state; applying a multiphoton excitation to the set of logical qubits from an in-in-n state to a m-in-(n+ancilla) Rydberg state; applying a. Rydberg to |clock 1 [symbol] pulse on the ancilla qubit; and deshelving the ancilla qubit. In some cases, this process does not disturb the constraint subspace. A null result on each m′ [symbol] m may be a confirmation of being in the correct subspace.

### Examples of Additional Variational Parameters

In some cases, it may be possible to include additional variational parameters in the time evolution unitary that may be adjusted within the coherent execution of the algorithm, or in an external loop between successive executions of the algorithm in the vein of VQE. These parameters may tune quantities such as the rate at which the evolution unitary is applied, the frequency of subspace correction, meaningful parameters within the evolution unitary, parameters within the recovery strategy or recovery execution, or any other programmable or algorithmic components of the execution.

### Examples of Error Mitigation Modifications

In some cases, it may be possible to change or replace some of the subspace correction detection and recovery sequences and computations with equivalent processes that specifically mitigate or control errors that may arise on the neutral atom device. For example, such operations may detect additional errors such as atom loss and include a recovery process for the hardware error in addition to the constraint violation.

### Examples of Error Correction Modifications

In some cases, it may be possible to change the implementation of the constraint detection and recovery phases in a way that is compatible with error correction codes. It is possible to employ error correction codes to the interaction zone where detection and recovery operations take place.

### Neutral Atom Quantum Computing

As described, the systems, the methods, the computer-readable media, and the techniques disclosed herein may be applied in a neutral atom quantum computer with one or more spin % atoms. For example, the one or more atoms may comprise alkali atoms. The one or more atoms may comprise lithium (Li) atoms, sodium (Na) atoms, potassium (K) atoms, rubidium (Rb) atoms, or cesium (Cs) atoms. The one or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, or caesium-133 atoms. The one or more atoms may comprise alkaline earth atoms. The one or more atoms may comprise beryllium (Be) atoms, magnesium (Mg) atoms, calcium (Ca) atoms, strontium (Sr) atoms, or barium (Ba) atoms. The one or more atoms may comprise beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-134 atoms, barium-135 atoms, barium-136 atoms, barium-137 atoms, or barium-138 atoms. The one or more atoms may comprise rare earth atoms. The one or more atoms may comprise scandium (Sc) atoms, yttrium (Y) atoms, lanthanum (La) atoms, cerium (Ce) atoms, praseodymium (Pr) atoms, neodymium (Nd) atoms, samarium (Sm) atoms, europium (Eu) atoms, gadolinium (Gd) atoms, terbium (Tb) atoms, dysprosium (Dy) atoms, holmium (Ho) atoms, erbium (Er) atoms, thulium (Tm) atoms, ytterbium (Yb) atoms, or lutetium (Lu) atoms. The one or more atoms may comprise scandium-45 atoms, yttrium-89 toms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms.

The one or more atoms may comprise a single element selected from the group consisting of Li, Na, K, Rb, Cs, Be, Mg, Ca, Sr, and Ba. The one or more atoms may comprise a mixture of elements selected from the group consisting of Li, Na, K, Rb, Cs, Be, Mg, Ca, Sr, and Ba. The one or more atoms may comprise a natural isotopic mixture of one or more elements selected from the group consisting of Li, Na, K, Rb, Cs, Be, Mg, Ca, Sr, and Ba. The one or more atoms may comprise an isotopically enriched mixture of one or more elements selected from the group consisting of Li, Na, K, Rb, Cs, Be, Mg, Ca, Sr, and Ba. The one or more atoms may comprise a natural isotopic mixture of one or more elements selected from the group consisting of Sc, Y, La, Ce, Pr, Nd, Sm, Eu, Gd, Tb, Dy, Ho, Er, Tm, Yb, and Lu. The one or more atoms may comprise an isotopically enriched mixture of one or more elements selected from the group consisting of Sc, Y, La, Ce, Pr, Nd, Sm, Eu, Gd, Tb, Dy, Ho, Er, Tm, Yb, and Lu. atoms may comprise rare earth atoms. For instance, the one or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at least about 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.9%, 99.98%,99.99%, or more. The one or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymian-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at most about 99.99%, 99.98%, 99.97%, 99.96%, 99.95%, 99.94%, 9% 99.92%, 99.91%, 99.9%, 99.8%, 99.7%, 99.6%, 99.5%, 99.4%, 99.3%, 99.2%, 99.1%, 99%, 98%, 97%, 96%, 95% 94%, 93%, 92%, 91%, 90%, 80%, 70%,60%, 50%, or less. The one or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance that is within a range defined by any two of the preceding values.

The one or more atoms may comprise at least about 1, 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, or more atoms. The one or more atoms may comprise at most about 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or fewer atoms. The one or more atoms may comprise a number of atoms as defined by any two of the proceeding values. For example, the one or more atoms may comprise from about 75 to about 150 atoms. The one or more atoms may comprise neutral atoms. For example, the one or more atoms may comprise atoms that are not ionized (e.g., are in a neutral state). Each atom of the one or more atoms may be a neutral atom. For example, each atom of an array of atoms can be not ionized. The one or more atoms may comprise rare earth atoms (e.g., lanthanide series atoms (e.g., ytterbium, neodymium, lanthanum, erbium, etc.), scandium, yttrium, etc.), alkali atoms (e.g., sodium, potassium, etc.), alkali earth atoms (e.g., calcium, strontium (e.g., strontium-87 atoms), etc.), or the like, or any combination thereof.

As described, the driving fields of the systems, the methods, the computer-readable media, and the techniques disclosed herein (e.g., gate operations, quantum circuits, measurements, etc.) may be created by one or more lasers. The lasers may comprise one or more continuous wave lasers. The lasers may comprise one or more pulsed lasers. The lasers may comprise one or more gas lasers, such as one or more helium-neon (FleNe) lasers, argon (Ar) lasers, krypton (Kr) lasers, xenon (Xe) ion lasers, nitrogen (N₂) lasers, carbon dioxide (CO₂) lasers, carbon monoxide (CO) lasers, transversely excited atmospheric (TEA) lasers, or excimer lasers. For instance, the lasers may comprise one or more argon dimer (Ar₂) excimer lasers, krypton dimer (Kr₂) excimer lasers, fluorine dimer (F₂) excimer lasers, xenon dimer (Xe₂) excimer lasers, argon fluoride (ArF) excimer lasers, krypton chloride (KrCl) excimer lasers, krypton fluoride (KrF) excimer lasers, xenon bromide (XeBr) excimer lasers, xenon chloride (XeCl) excimer lasers, or xenon fluoride (XeF) excimer lasers. The laser may comprise one or more dye lasers.

The lasers may comprise one or more metal-vapor lasers, such as one or more helium-cadmium (HeCd) metal-vapor lasers, helium-mercury (HeHg) metal-vapor lasers, helium-selenium (HeSe) metal-vapor lasers, helium-silver (HeAg) metal-vapor lasers, strontium (Sr) metal-vapor lasers, neon-copper (NeCu) metal-vapor lasers, copper (Cu) metal-vapor lasers, gold (Au) metal-vapor lasers, manganese (Mn) metal-vapor laser, or manganese chloride (MnCl₂) metal-vapor lasers.

The lasers may comprise one or more solid-state lasers, such as one or more ruby lasers, metal-doped crystal lasers, or metal-doped fiber lasers. For instance, the lasers may comprise one or more neodymium-doped yttrium aluminum garnet (Nd:YAG) lasers, neodymium/chromium doped yttrium aluminum garnet (Nd/Cr:YAG) lasers, erbium-doped yttrium aluminum garnet (Er:YAG) lasers, neodymium-doped yttrium lithium fluoride (Nd:YF) lasers, neodymium-doped yttrium orthovanadate (ND:YVO₄) lasers, neodymium-doped yttrium calcium oxoborate (Nd:YCOB) lasers, neodymium glass (Nd:glass) lasers, titanium sapphire (Ti:sapphire) lasers, thulium-doped yttrium aluminum garnet (Tm:YAG) lasers, ytterbium-doped ytrrium aluminum garnet (Yb:YAG) lasers, ytterbium-doped glass (Yt:glass) lasers, holmium ytrrium aluminum garnet (Ho:YAG) lasers, chromium-doped zinc selenide (Cr:ZnSe) lasers, cerium-doped lithium strontium aluminum fluoride (Ce:LiSAF) lasers, cerium-doped lithium calcium aluminum fluoride (Ce:LiCAF) lasers, erbium-doped glass (Er:glass) lasers, erbium-ytterbium-codoped glass (Er/Yt:glass) lasers, uranium-doped calcium fluoride (Uf:CaF₂) lasers, or samarium-doped calcium fluoride (Sm:CaF₂) lasers.

The lasers may comprise one or more semiconductor lasers or diode lasers, such as one or more gallium nitride (CaN) lasers, indium gallium nitride (IniaN) lasers, aluminum gallium indium phosphide (AlGaInP) lasers, aluminum gallium arsenide (AlGaAs) lasers, indium gallium arsenic phosphide (InGaAsP) lasers, vertical cavity surface emitting lasers (VCSELs), or quantum cascade lasers.

The lasers may emit continuous wave laser light. The lasers may emit pulsed laser light. The lasers may have a pulse length of at least about 1 femtoseconds (fs), 2 fs, 3 fs, 4 fs, 5 fs, 6 fs, 7 fs, 8 fs, 9 fs, 10 fs, 20 fs, 30 fs, 40 fs, 50 fs, 60 fs, 70 fs, 80 fs, 90 fs, 100 fs, 200 fs, 300 fs, 400 fs, 500 fs, 600 fs, 700 fs, 800 fs, 900 fs, 1 picosecond (ps), 2 ps, 3 ps, 4 ps, 5 ps, 6 ps, 7 ps, 8 ps, 9 ps, 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 nanosecond (ns), 2 ns, 3 ns, 4 ns, 5 ns, 6 ns, 7 ns, 8 ns, 9 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1,000 ns, or more. The lasers may have a pulse length of at most about 1,000 ns, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, 9 ns, 8 ns, 7 ns, 6 ns, 5 ns, 4 ns, 3 ns, 2 ns, 1 ns, 900 ps, 800 ps, 700 ps, 600 ps, 500 ps, 400 ps, 300 ps, 200 ps, 100 ps, 90 ps, 80 ps, 70 ps, 60 ps, 50 ps, 40 ps, 30 ps, 20 ps, 10 ps, 9 ps, 8 ps, 7 ps, 6 ps, 5 ps, 4 ps, 3 ps, 2 ps, 1 ps, 900 fs, 800 fs, 700 fs, 600 fs, 500 fs, 400 fs, 300 fs, 200 fs, 100 fs, 90 fs, 80 fs, 70 fs, 60 fs, 50 fs, 40 fs, 30 fs, 20 fs, 10 fs, 9 fs, 8 fs, 7 fs, 6 fs, 5 fs, 4 fs, 3 fs, 2 fs, 1 fs, or less. The lasers may have a pulse length that is within a range defined by any two of the preceding values.

The lasers may have a repetition rate of at least about 1 hertz (Hz), 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz, 600 Hz, 700 Hz, 800 Hz, 900 Hz, 1 kilohertz (kHz), 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 megahertz (MHz), 2 MHz, 3 MHz, 4 MHz, 5 MHz, 6 MHz, 7 MHz, 8 MHz, 9 MHz, 10 MHz, 20 MHz, 30 MHz, 40 MHz, 50 MHz, 60 MHz, 70 MHz, 80 MHz, 90 MHz, 100 MHz, 200 MHz, 300 MHz, 400 MHz, 500 MHz, 600 MHz, 700 MHz, 800 MHz, 900 MHz, 1,000 MHz, or more. The lasers may have a repetition rate of at most about 1,000 MHz, 900 MHz, 800 MHz, 700 MHz, 600 MHz, 500 MHz, 400 MHz, 300 MHz, 200 MHz, 100 MHz, 90 MHz, 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, S kHz, 4 kHz, 3 kHz, 2 kHz, 1 kHz, 900 Hz, 800 Hz, 700 Hz, 600 Hz, 500 Hz, 400 Hz, 300 Hz, 200 Hz, 100 Hz, 90 Hz, 80 Hz, 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The lasers may have a repetition rate that is within a range defined by any two of the preceding values.

The lasers may emit light having a pulse energy of at least about 1 nanojoule (nJ), 2 nJ, 3 nJ, 4 nJ, 5 nJ, 6 nJ, 7 nJ, 8 nJ, 9 nJ, 10 nJ, 20 nJ, 30 nJ, 40 nJ, 50 nJ, 60 nJ, 70 nJ, 80 nJ, 90 nJ, 100 nJ, 200 nJ, 300 nJ, 400 nJ, 500 nJ, 600 nJ, 700 nJ, 800 nJ, 900 nJ, 1 microjoule (μJ), 2 μJ, 3 μJ, 4 μJ, 5 μJ, 6 μJ, 7 μJ, 8 J, 9 μJ, 10 μJ, 20 μJ, 30 μJ, 40 μJ, 50 μJ, 60 μJ, 70 J, 80 J, 90 J, 100 μJ, 200 μJ, 300 μJ, 400 μJ, 500 μJ, 600 μJ, 700 μJ, 800 μJ, 900 μJ, a least 1 millijoule (mJ), 2 mJ, 3 mJ, 4 mJ, 5 mJ, 6 mJ, 7 mJ, 8 mJ, 9 mJ, 10 mJ, 20 mJ, 30 mJ, 40 mJ, 50 mJ, 60 mJ 70 mJ, 80 mJ, 90 mJ, 100 mJ, 200 mJ, 300 mJ, 400 mJ, 500 mJ, 600 mJ, 700 mJ, 800 mJ, 900 mJ, a least 1 Joule (J), or more. The lasers may emit light having a pulse energy of at most about 1 J, 900 mJ, 800 mJ, 700 mJ, 600 mJ, 500 mJ, 400 mJ, 300 mJ, 200 mJ, 100 mJ, 90 mJ, 80 mJ, 70 mJ, 60 mJ, 50 mJ, 40 mJ, 30 mJ, 20 mJ, 10 mJ, 9 mJ, 8 mJ, 7 mJ, 6 mJ, 5 mJ, 4 mJ, 3 mJ, 2 mJ, 1 mJ, 900 μJ, 800 μJ, 700 μJ, 600 μJ, 500 μJ, 400 μJ, 300 μJ, 200 μJ, 100 μJ, 90 μJ, 80 μJ, 70 μJ, 60 μJ, 50 μJ, 40 μJ, 30 μJ, 20 μJ, 10 μJ, 9 μJ, 8 μJ, 7 μJ, 6 μJ, 5 μJ, 4 μJ, 3 μJ, 2 μJ, 1 μJ, 900 nJ, 800 nJ, 700 nJ, 600 nJ, 500 nJ, 400 nJ, 300 nJ, 200 nJ, 100 nJ, 90 nJ, 80 nJ, 70 nJ, 60 nJ, 50 nJ, 40 nJ 30 nJ, 20 nJ, 10 nJ, 9 nJ, 8 nJ, 7 nJ, 6 nJ, 5 nJ, 4 nJ, 3 nJ, 2 nJ, 1 nJ, or less. The lasers may emit light having a pulse energy that is within a range defined by any two of the preceding values.

The lasers may emit light having an average power of at least about 1 microwatt (μW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 400 μW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, 1 watt (W), 2 W, 3 W, 4 W, 5 W, 6 W, 7 W, 8 W, 9 W, 10 W, 20 W, 30 W, 40 W, 50 W, 60 W, 70 W, 80 W, 90 W, 100 W, 200 W, 300 W, 400 W, 500 W, 600 W, 700 W, 800 W, 900 W, 1,000 W, or more. The lasers may emit light having an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W, 10 W, 9 W, 8 W, 7 W, 6 W, 5 W, 4 W, 3 W, 2 W, 1 W, 900 mW, 800 mW, 700 mW, 600 mW, 500 mW, 400 mW, 300 mW, 200 mW, 100 mW, 90 mW, 80 mW, 70 mW, 60 mW, 50 mW, 40 mW, 30 mW, 20 mW, 10 mW, 9 mW, 8 mW, 7 mW, 6 mW, 5 mW, 4 mW, 3 mW, 2 mW, 1 mW, 900 μW, 800 μW, 700 μW, 600 μW, 500 μW, 400 μW, 300 μW, 200 μW, 100 μW, 90 μW, 80 μW, 70 μW, 60 μW, 50 μW, 40 μW, 30 μW, 20 μW, 10 μW, 9 μW, 8 μW, 7 μW, 6 μW, 5 μW, 4 μW, 3 μW, 2 μW, 1 μW, or more. The lasers may emit light having a power that is within a range defined by any two of the preceding values.

The lasers may emit light comprising one or more wavelengths in the ultraviolet (UV), visible, or infrared (IR) portions of the electromagnetic spectrum. The lasers may emit light comprising one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, 1,010 nm, 1,020 nm, 1,030 nm, 1,040 nm, 1,050 nm, 1,060 nm, 1.070 nm, 1,080 nm, 1,090 nm, 1,100 nm, 1,110 nm, 1,120 nm, 1,130 nm, 1,140 nm, 1,150 nm, 1,160 nm, 1,170 nm, 1,180 nm, 1,190 nm, 1,200 nm, 1,210 nm, 1,220 nm, 1,230 nm, 1,240 nm, 1,250 nm, 1,260 nm, 1,270 nm, 1,280 nm, 1,290 nm, 1,300 nm, 1,310 nm, 1,320 nm, 1,330 nm, 1,340 nm, 1,350 nm, 1,360 nm, 1,370 nm, 1,380 nm, 1,390 nm, 1,400 nm, or more. The lasers may emit light comprising one or more wavelengths of at most about 1,400 nm, 1,390 nm, 1,380 nm, 1,370 nm, 1,360 nm, 1,350 nm, 1,340 nm, 1,330 nm, 1,320 nm, 1,310 nm, 1,300 nm, 1,290 nm, 1,280 nm, 1,270 nm, 1,260 nm, 1,250 nm, 1,240 nm, 1,230 nm, 1,220 nm, 1,210 nm, 1,200 nm, 1,190 nm, 1,180 nm, 1,170 n, 1,160 nm, 1,150 nm, 1,140 nm, 1,130 nm, 1,120 nm, 1,110 nm, 1,100 nm, 1,090 nm, 1,080 nm, 1,070 nm, 1,060 nm, 1,050 nm, 1,040 nm, 1,030 nm, 1,020 nm, 1,010 nm, 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm. The lasers may emit light comprising one or more wavelengths that are within a range defined by any two of the preceding values.

The lasers may emit light having a bandwidth of at least about 1×10⁻¹⁵ nm, 2×10⁻¹⁵ nm, 3×10⁻¹⁵ nm, 4×10⁻¹⁵ nm, 5×10⁻¹⁵ nm, 6×10⁻¹⁵ nm, 7×10⁻¹⁵ nm, 8×10⁻¹⁵ nm, 9×10⁻¹⁵ nm, 1×10⁻¹⁴ nm, 2×10⁻¹⁴ nm, 3×10⁻¹⁴ nm, 4×10⁻¹⁴ nm, 5×10⁻¹⁴ nm, 6×10⁻¹⁴ nm, 7×10⁻¹⁴ nm, 8×10⁻¹⁴ nm, 9×10⁻¹⁴ nm, 1×10⁻¹³ nm, 2×10⁻¹³ nm, 3×10⁻¹³ nm, 4×10⁻¹³ nm, 5×10⁻¹³ nm, 6×10⁻¹³ nm, 7×10⁻¹³ nm, 8−10⁻¹³ nm, 9×10⁻¹³ nm, 1×10⁻¹² nm, 2×10⁻¹² nm, 3×10⁻¹² nm, 4×10⁻¹² nm, 5×10⁻¹² nm, 6×10⁻¹² nm, 7×10⁻¹² nm, 8×10⁻¹² nm, 9×10⁻¹² nm, 1×10⁻¹¹ nm, 2×10⁻¹¹ nm, 3×10⁻¹¹ nm, 4×10⁻¹¹ nm, 5×10⁻¹¹ nm, 6×10⁻¹¹ nm, 7×10⁻¹¹ nm, 8×10⁻¹¹ nm, 9×10⁻¹¹ nm, 1×10⁻¹⁰ nm, 2×10⁻¹⁰ nm, 3×10⁻¹⁰ nm, 4×10⁻¹⁰ nm, 5×10⁻¹⁰ nm, 6×10⁻¹⁰ nm, 7×10⁻¹⁰ nm, 8×10⁻¹⁰ nm, 9×10⁻¹⁰ nm, 1×10⁻⁹ nm, 2×10⁻⁹ nm, 3×10⁻⁹ nm, 4×10⁻⁹ nm, 5×10⁻⁹ nm, 6×10⁻⁹ nm, 7×10⁻⁹ nm, 8×10⁻⁹ nm, 9×10⁻⁹ nm, 1×10⁻⁸ nm, 2×10⁻⁸ nm, 3×10⁻⁸ nm, 4×10⁻⁸ nm, 5×10⁻⁸ nm, 6×10⁻⁸ nm, 7×10⁻⁸ nm, 9×10⁻⁸ nm, 9×10⁻⁸ nm, 1×10⁻⁷ nm, 2×10⁻⁷ nm, 3×10⁻⁷ nm, 4×10⁻⁷ nm, 5×10⁻⁷ nm, 6×10⁻⁷ nm, 7×10⁻⁷ nm, 8×10⁻⁷ nm, 9×10⁻⁷ nm, 1×10⁻⁶ nm, 2×10⁻⁶ nm, 3×10⁻⁶ nm, 4×10⁻⁶ nm, 5×10⁻⁶ nm, 6×10⁻⁶ nm, 7×10⁻⁶ nm, 8×10⁻⁶ nm, 9×10⁻⁶ nm, 1×10⁻⁵ nm, 2×10⁻⁵ nm, 3×10⁻⁵ nm, 4×10⁻⁵ nm, 5×10⁻⁵ nm, 6×10⁻⁵ nm, 7×10⁻⁵ nm, 8×10⁻⁵ nm, 9×10⁻⁵ nm, 1×10⁻⁴ nm, 2×10⁻⁴ nm, 4×10⁻⁴ nm, 5×10⁻⁴ nm, 6×10⁻⁴ nm, 7×10⁻⁴ nm, 8×10⁻⁴ nm, 9×10⁻⁴ nm, 1×10⁻³ nm, or more. The lasers may emit light having a bandwidth of at most about 1×10⁻³ nm, 9×10⁻⁴ nm, 8×10⁻⁴ nm, 7×10⁻⁴ nm, 6×10⁻⁴ nm, 5×10⁻⁴ nm, 4×10⁻⁴ nm, 3×10⁻⁴ nm, 2×10⁻⁴ nm, 1×10⁻⁴ nm, 9×10⁻⁵ nm, 8×10⁻⁵ nm, 7×10⁻⁵ nm, 6×10⁻⁵ nm, 5×10⁻⁵ nm, 4×10⁻⁵ nm, 3×10⁻⁵ nm, 2×10⁻⁵ nm, 1×10⁻⁵ nm, 9×10⁻⁶ nm, 8×10⁻⁶ nm, 7×10⁻⁶ nm, 6×10⁻⁶ nm, 5×10⁻⁶ nm, 4×10⁻⁶ nm, 3×10⁻⁶ nm, 2×10⁻⁶ nm, 1×10⁻⁶ nm, 9×10⁻⁷ nm, 8×10⁻⁷ nm, 7×10⁻⁷ nm, 6×10⁻⁷ nm, 5×10⁻⁷ nm, 4×10⁻⁷ nm, 3×10⁻⁷ nm, 2×10⁻⁷ nm, 1×10⁻⁷ nm, 9×10⁻⁸ nm, 8×10⁻⁸ nm, 7×10⁻⁸ nm, 6×10⁻⁸ nm, 5×10⁻⁸ nm, 4×10⁻⁸ nm, 3×10⁻⁸ nm, 2×10⁻⁸ nm, 1×10⁻⁸ nm, 9×10⁻⁹ nm, 8×10⁻⁹ nm, 7×10⁻⁹ nm, 6×10⁻⁹ nm, 5×10⁻⁹ nm, 4×10⁻⁹ nm, 3×10⁻⁹ nm, 2×10⁻⁹ nm, 1×10⁻⁹ nm, 9×10⁻¹⁰ nm, 8×10⁻¹⁰ nm, 7×10⁻¹⁰ nm, 6×10⁻¹⁰ nm, 5×10⁻¹⁰ nm, 4×10⁻¹⁰ nm, 3×10⁻¹⁰ nm, 2×10⁻¹⁰ nm, 1×10⁻¹⁰ nm, 9×10⁻¹¹ nm, 8×10⁻¹¹ nm, 7×10⁻¹¹ nm, 6×10⁻¹¹ nm, 5×10⁻¹¹ nm, 4×10⁻¹¹ nm, 3×10⁻¹¹ nm, 2×10⁻¹¹ nm, 1×10⁻¹¹ nm, 9×10⁻¹² nm, 8×10⁻¹² nm, 7×10⁻¹² nm, 6×10⁻¹² nm, 5×10⁻¹² nm, 4×10⁻¹² nm, 3×10⁻¹² nm, 2×10⁻¹² nm, 1×10⁻¹² nm, 9×10⁻¹³ nm, 8×10⁻¹³ nm, 7×10⁻¹³ nm, 6×10⁻¹³ nm, 5×10⁻¹³ nm, 4×10⁻¹³ nm, 3×10⁻¹³ nm, 2×10⁻¹³ nm, 1×10⁻¹³ nm, 9×10⁻¹⁴ nm, 8×10⁻¹⁴ nm, 7×10⁻¹⁴ nm, 6×10⁻¹⁴ nm, 5×10⁻¹⁴ nm, 4×10⁻¹⁴ nm, 3×10⁻¹⁴ nm, 2×10⁻¹⁴ nm, 1×10⁻¹⁴ nm, 9×10⁻¹⁵ nm, 8×10⁻¹⁵ nm, 7×10⁻¹⁵ nm, 6×10⁻¹⁵ nm, 5×10⁻¹⁵ nm, 4×10⁻¹⁵ nm, 3×10⁻¹⁵ nm, 2×10⁻¹⁵ nm, 1×10⁻¹⁵ nm, or less. The lasers may emit light having a bandwidth that is within a range defined by any two of the preceding values.

### Classical Algorithms

Systems and method of the present disclosure may also include various classical algorithms which when implemented by a processor perform various operations of the methods herein.

### Example of Systems for Performing a Non-Classical Computation

FIG. 2 shows an example of a system 200 for performing a non-classical computation. The non-classical computation may comprise a quantum computation. The quantum computation may comprise a gate-model quantum computation.

The system 200 may comprise one or more trapping units 210. The trapping units may comprise one or more optical trapping units. The optical trapping units may comprise any optical trapping unit described herein, such as an optical trapping unit described herein with respect to FIG. 3A. The optical trapping units may be configured to generate a plurality of optical trapping sites. The optical trapping units may be configured to generate a plurality of spatially distinct optical trapping sites. For instance, the optical trapping units may be configured to generate at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more optical trapping sites. The optical trapping units may be configured to generate at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer optical trapping sites. The optical trapping units may be configured to trap a number of optical trapping sites that is within a range defined by any two of the preceding values.

The optical trapping units may be configured to trap a plurality of atoms. For instance, the optical trapping units may be configured to trap at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,00, 100,000, 200,000, 300,000, 400,000, 500,000, 600,000, 700,000, 800,000, 900,000, 1,000,000, or more atoms. The optical trapping units may be configured to trap at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer atoms. The optical trapping units may be configured to trap a number of atoms that is within a range defined by any two of the preceding values.

Each optical trapping site of the optical trapping units may be configured to trap at least about 1, 2, 3, 4, 5, 6, 7, 8, 9, 10, or more atoms. Each optical trapping site may be configured to trap at most about 10, 9, 8, 7, 6, 5, 4, 3, 2, 1, or fewer atoms. Each optical trapping site may be configured to trap a number of atoms that is within a range defined by any two of the preceding values. Each optical trapping site may be configured to trap a single atom.

One or more atoms of the plurality of atoms may comprise qubits, as described herein (for instance, with respect to FIG. 4). Two or more atoms may be quantum mechanically entangled. Two or more atoms may be quantum mechanically entangled with a coherence lifetime of at least about 1 microsecond (μs), 2 μs, 3 μs, 4 μs, 5 μs, 6 μs, 7 μs, 8 μs, 9 μs, 10 μs 20 μs 30 μs 40 μs, 50 μs, 60 μs, 70 μs, 80 μs, 90 μs, 100 μs, 200 μs, 300 μs, 400 μs, 500 μs, 600 μs, 700 μs, 800 μs, 900 μs, 1 millisecond (ms), 2 ms, 3 ms, 4 ms, 5 ms, 6 ms, 7 ms, 8 ms, 9 ms, 10 ms, 20 ms, 30 ms, 40 ms, 50 ms, 60 ms, 70 ms, 80 ms, 90 ms, 100 ms, 200 ms, 300 ms, 400 ms, 500 ms, 600 ms, 700 μs, 800 ms, 900 ms, 1 second (s), 2 s, 3 s, 4 s, 5 s, 6 s, 7 s, 8 s, 9 s, 10 s, or more. Two or more atoms may be quantum mechanically entangled with a coherence lifetime of at most about 10 s, 9 s, 8 s, 7 s, 6 s, 5 s, 4 s, 3 s, 2 s, 1 s, 900 ms, 800 ms, 700 ms, 600 ms, 500 ms, 400 ms, 300 ms, 200 ms, 100 ms, 90 ms, 80 ms, 70 ms, 60 ms, 50 ms, 40 ms, 30 ms, 20 ms, 10 ms, 9 ms, 8 ms, 7 ms, 6 ms, 5 ms, 4 ms, 3 ms, 2 ms, 1 ms, 900 μs, 800 μs, 700 μs, 600 μs, 500 μs, 400 μs, 300 μs, 200 μs, 100 μs, 90 μs, 80 μs, 70 μs, 60 μs, 50 μs, 40 μs, 30 μs, 20 μs, 10 μs, 9 μs, 8 μs, 7 μs, 6 μs, 5 μs, 4 μs, 3 μs, 2 μs, 1 μs, or less. Two or more atoms may be quantum mechanically entangled with a coherence lifetime that is within a range defined by any two of the preceding values. One or more atoms may comprise neutral atoms. One or more atoms may comprise uncharged atoms.

One or more atoms may comprise alkali atoms. One or more atoms may comprise lithium (Li) atoms, sodium (Na) atoms, potassium (K) atoms, rubidium (Rb) atoms, or cesium (Cs) atoms. One or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, or caesium-133 atoms. One or more atoms may comprise alkaline earth atoms. One or more atoms may comprise beryllium (Be) atoms, magnesium (Mg) atoms, calcium (Ca) atoms, strontium (Sr) atoms, or barium (Ba) atoms. One or more atoms may comprise beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, or barium-138 atoms. One or more atoms may comprise rare earth atoms. One or more atoms may comprise scandium (Sc) atoms, yttrium (Y) atoms, lanthanum (La) atoms, cerium (Ce) atoms, praseodymium (Pr) atoms, neodymium (Nd) atoms, samarium (Sm) atoms, europium (Eu) atoms, gadolinium (Gd) atoms, terbium (Tb) atoms, dysprosium (Dy) atoms, holmium (Ho) atoms, erbium (Er) atoms, thulium (Tm) atoms, ytterbium (Yb) atoms, or lutetium (Lu) atoms. One or more atoms may comprise scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms.

The plurality of atoms may comprise a single element selected from the group consisting of Li, Na, K, Rb, Cs, Be, Mg, Ca, Sr, and Ba. The plurality of atoms may comprise a mixture of elements selected from the group consisting of Li, Na, K, Rb, Cs, Be, Mg, Ca, Sr, and Ba. The plurality of atoms may comprise a natural isotopic mixture of one or more elements selected from the group consisting of Li, Na, K, Rb, Cs, Be, Mg, Ca, Sr, and Ba. The plurality of atoms may comprise an isotopically enriched mixture of one or more elements selected from the group consisting of Li, Na, K, Rb, Cs, Be, Mg, Ca, Sr, and Ba. The plurality of atoms may comprise a natural isotopic mixture of one or more elements selected from the group consisting of Sc, Y, La, Ce, Pr, Nd, Sm. Eu, Gd, Tb, Dy, Ho, Er, Tm, Yb, and Lu. The plurality of atoms may comprise an isotopically enriched mixture of one or more elements selected from the group consisting of Sc, Y, La, Ce, Pr, Nd, Sm, Eu, Gd, Tb, Dy, Ho, Er, Tm, Yb, and Lu. atoms may comprise rare earth atoms. For instance, the plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at least about 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, or more. The plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at most about 99.99%, 99.98%, 99.97%, 99.96%, 99.95%, 99.94%, 99.93%, 99.92%, 99.91%, 99.9%, 99.8%, 99.7%, 99.6%, 99.5%, 99.4%, 993%, 99.2%, 99.1%, 99%, 98%, 97%, 96%, 95%, 94%, 93%, 92%, 91%, 90%, 80%, 70%, 60%, 50%, or less. The plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance that is within a range defined by any two of the preceding values.

The system 200 may comprise one or more first electromagnetic delivery units 220. The first electromagnetic delivery units may comprise any electromagnetic delivery unit described herein, such as an electromagnetic delivery unit described herein with respect to FIG. 4. The first electromagnetic delivery units may be configured to apply first electromagnetic energy to one or more atoms of the plurality of atoms. Applying the first electromagnetic energy may induce the atoms to adopt one or more superposition states of a first atomic state and a second atomic state that is different from the first atomic state.

The first atomic state may comprise a first single-qubit state. The second atomic state may comprise a second single-qubit state. The first atomic state or second atomic state may be elevated in energy with respect to a ground atomic state of the atoms. The first atomic state or second atomic state may be equal in energy with respect to the ground atomic state of the atoms.

The first atomic state may comprise a first hyperfine electronic state and the second atomic state may comprise a second hyperfine electronic state that is different from the first hyperfine electronic state. For instance, the first and second atomic states may comprise first and second hyperfine states on a multiplet manifold, such as a triplet manifold. The first and second atomic states may comprise first and second hyperfine states, respectively, on a ³P₁ or ³P₂ manifold. The first and second atomic states may comprise first and second hyperfine states, respectively, on a ³P₁ or ³P₂ manifold of any atom described herein, such as a strontium-87 ³P₁ manifold or a strontium-87 ³P₂ manifold.

In some cases, the first and second atomic states are first and second hyperfine states of a first electronic state. Optical excitation may be applied between a first electronic state and a second electronic state. The optical excitation may excite the first hyperfine state and/or the second hyperfine state to the second electronic state. A single-qubit transition may comprise a two-photon transition between two hyperfine states within the first electronic state using a second electronic state as an intermediate state. To drive a single-qubit transition, a pair of frequencies, each detuned from a single-photon transition to the intermediate state, may be applied to drive a two-photon transition. In some cases, the first and second hyperfine states are hyperfine states of the ground electronic state. The ground electronic state may not decay by spontaneous or stimulated emission to a lower electronic state. The hyperfine states may comprise nuclear spin states.

In some cases, the hyperfine states comprise nuclear spin states of a strontium-87 ¹S₀ manifold and the qubit transition drives one or both of two nuclear spin states of strontium-87 ¹S₀ to a state detuned from or within the ³P₂ or ³P₁ manifold. In some cases, the one-qubit transition is a two photon Raman transition between nuclear spin states of strontium-87 ¹S₀ via a state detuned from or within the ³P₂ or ³P₁ manifold. In some cases, the nuclear spin states may be Stark shifted nuclear spin states. A Stark shift may be driven optically. An optical Stark shift may be driven off resonance with any, all, or a combination of a single-qubit transition, a two-qubit transition, a shelving transition, an imaging transition, etc.

In some cases, the hyperfine states comprise nuclear spin states of a ytterbium atom.

The first atomic state may comprise a first nuclear spin state and the second atomic state may comprise a second nuclear spin state that is different from the first nuclear spin state. The first and second atomic states may comprise first and second nuclear spin states, respectively, of a quadrupolar nucleus. The first and second atomic states may comprise first and second nuclear spin states, respectively, of a spin-1, spin-3/2, spin-2, spin-5/2, spin-3, spin-7/2, spin-4, or spin-9/2 nucleus. The first and second atomic states may comprise first and second nuclear spin states, respectively, of any atom described herein, such as first and second spin states of strontium-87.

For first and second nuclear spin states associated with a nucleus comprising a spin greater than 1/2 (such as a spin-1, spin-3/2, spin-2, spin-5/2, spin-3, spin-7/2, spin-4, or spin-9/2 nucleus), transitions between the first and second nuclear spin states may be accompanied by transitions between other spin states on the nuclear spin manifold. For instance, for a spin-9/2 nucleus in the presence of a uniform magnetic field, all of the nuclear spin levels may be separated by equal energy. Thus, a transition (such as a Raman transition) designed to transfer atoms from, for instance, an m_{N}=9/2 spin state to an m_{N}=7/2 spin state, may also drive m_{N}=7/2 to m_{N}=5/2 m_{N}=5/2 to m_{N}=3/2, m_{N}=3/2 to m_{N}=1/2, m_{N}=−1/2 to m_{N}=−1/2, m_{N}=−1/2 to m_{N}=−3/2, m_{N}=−3/2 to m_{N}=−5/2, m_{N}=−5/2 to m_{N}=−7/2, and m_{N}=−7/2 to m_{N}=−9/2, where m_{N} is the nuclear spin state. Similarly, a transition (such as a Raman transition) designed to transfer atoms from, for instance, an m_{N}=9/2 spin state to an m_{N}=5/2 spin state, may also drive m_{N}=7/2 to m_{N}=3/2, m_{N}=5/2 to m_{N}=1/2, m_{N}=−3/2 to m_{N}=−1/2, m_{N}=1/2 to m_{N}=−3/2, m_{N}=−1/2 to m_{N}=−5/2, m_{N}=−3/2 to m_{N}=−7/2, and m_{N}=−5/2 to m_{N}=−9/2. Such a transition may thus not be selective for inducing transitions between particular spin states on the nuclear spin manifold.

It may be desirable to instead implement selective transitions between particular first and second spins states on the nuclear spin manifold. This may be accomplished by providing light from a light source that provides an AC Stark shift and pushes neighboring nuclear spin states out of resonance with a transition between the desired transition between the first and second nuclear spin states. For instance, if a transition from first and second nuclear spin states having m_{N}=−9/2 and m_{N}=−7/2 is desired, the light may provide an AC Stark shift to the m_{N}=−5/2 spin state, thereby greatly reducing transitions between the m_{N}=−7/2 and m_{N}=−5/2 states. Similarly, if a transition from first and second nuclear spin states having m_{N}=−9/2 and M_{N}=−5/2 is desired, the light may provide an AC Stark shift to the m_{N}=−1/2 spin state, thereby greatly reducing transitions between the m_{N}=−5/2 and m_{N}=−1/2 states. This may effectively create a two-level subsystem within the nuclear spin manifold that is decoupled from the remainder of the nuclear spin manifold, greatly simplifying the dynamics of the qubit systems. It may be advantageous to use nuclear spin states near the edge of the nuclear spin manifold (e.g., m_{N}=−9/2 and m_{N}=−7/2, m_{N}=7/2 and m_{N}=9/2, m_{N}=−9/2 and m_{N}=−5/2, or m_{N}=5/2 and m_{N}=−9/2 for a Spin-9/2 nucleus) such that only one AC Stark shift is required. Alternatively, nuclear spin states farther from the edge of the nuclear spin manifold (e.g., m_{N}=−5/2 and m_{N}=−3/2 or m_{N}=−5/2 and m_{N}=−1/2) may be used and two AC Stark shifts may be implemented (e.g., at m_{N}=−7/2 and m_{N}=−1/2 or m_{N}=−9/2 and m_{N}=3/2).

Stark shifting of the nuclear spin manifold may shift neighboring nuclear spin states out of resonance with the desired transition between the first and second nuclear spin states and a second electronic state or a state detuned therefrom. Stark shifting may decrease leakage from the first and second nuclear spin state to other states in the nuclear spin manifold. Starks shifts may be achievable up to 100s of kHz for less than 10 mW beam powers. Upper state frequency selectivity may decrease scattering from imperfect polarization control. Separation of different angular momentum states in the ³P₁ manifold may be many gigahertz from the single and two-qubit gate light. Leakage to other states in the nuclear spin manifold may lead to decoherence. The Rabi frequency for two-qubit transitions (e.g., how quickly the transition can be driven) may be faster than the decoherence rate. Scattering from the intermediate state in the two-qubit transition may be a source of decoherence. Detuning from the intermediate state may improve fidelity of two-qubit transitions.

Qubits based on nuclear spin states in the electronic ground state may allow exploitation of long-lived metastable excited electronic states (such as a ³P₀ state in strontium-87) for qubit storage. Atoms may be selectively transferred into such a state to reduce cross-talk or to improve gate or detection fidelity. Such a storage or shelving process may be atom-selective using the SLMs or AODs described herein. A shelving transition may comprise a transition between the ¹S₀ state in strontium-87 to the ³P₀ or ³P₂ state in strontium-87.

The clock transition (also a “shelving transition” or a “storage transition” herein) may be qubit-state selective. The upper state of the clock transition may have a very long natural lifetime, e.g., greater than 1 second. The linewidth of the clock transition may be much narrower than the qubit energy spacing. This may allow direct spectral resolution. Population may be transferred from one of the qubit states into the clock state. This may allow individual qubit states to be read out separately, by first transferring population from one qubit state into the clock state, performing imaging on the qubits, then transferring the population back into the ground state from the clock state and imaging again. In some cases, a magic wavelength transition is used to drive the clock transition.

The clock light for shelving can be atom-selective or not atom-selective. In some cases, the clock transition is globally applied (e.g., not atom selective). A globally applied clock transition may include directing the light without passing through a microscope objective or structuring the light. In some cases, the clock transition is atom-selective. Clock transition which are atom-selective may potentially allow us to improve gate fidelities by minimizing cross-talk. For example, to reduce cross talk in an atom, the atom may be shelved in the clock state where it may not be affected by the light. This may reduce cross-talk between neighboring qubits undergoing transitions. To implement atom-selective clock transitions, the light may pass through one or more microscope objectives and/or may be structured on one or more of a spatial light modulator, digital micromirror device, crossed acousto-optic deflectors, etc.

The system 200 may comprise one or more readout units 230. The readout units may comprise one or more readout optical units. The readout optical units may be configured to perform one or more measurements of the one or more superposition states to obtain the non-classical computation. The readout optical units may comprise one or more optical detectors. The detectors may comprise one or more photomultiplier tubes (PMTs), photodiodes, avalanche diodes, single-photon avalanche diodes, single-photon avalanche diode arrays, phototransistors, reverse-biased light emitting diodes (LEDs), charge coupled devices (CCDs), or complementary metal oxide semiconductor (CMOS) cameras. The optical detectors may comprise one or more fluorescence detectors. The readout optical unit may comprise one or more objectives, such as one or more objective having a numerical aperture (NA) of at least about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, or more. The objective may have an NA of at most about 1, 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, or less. The objective may have an NA that is within a range defined by any two of the preceding values.

The one or more readout optical units 230 may make measurements, such as projective measurements, by applying light resonant with an imaging transition. The imaging transition may cause fluorescence. An imaging transition may comprise a transition between the ¹S₀ state in strontium-87 to the ¹P₁ state in strontium-87. The ¹P₁ state in strontium-87 may fluoresce. The lower state of the qubit transition may comprise two nuclear spin states in the ¹S₀ manifold. The one or more states may be resonant with the imaging transition. A measurement may comprise two excitations. In a first excitation, one of the two lower states may be excited to the shelving state (e.g., ³P₀ state in strontium-87). In a second excitation, the imaging transition may be excited. The first transition may reduce cross-talk between neighboring atoms during computation. Fluorescence generated from the imaging transition may be collected on one or more readout optical units 230.

The imaging units may be used to determine if one or more atoms were lost from the trap. The imaging units may be used to observe the arrangement of atoms in the trap.

The system 200 may comprise one or more vacuum units 240. The one or more vacuum units may comprise one or more vacuum pumps. The vacuum units may comprise one or more roughing vacuum pumps, such as one or more rotary pumps, rotary vane pumps, rotary piston pumps, diaphragm pumps, piston pumps, reciprocating piston pumps, scroll pumps, or screw pumps. The one or more roughing vacuum pumps may comprise one or more wet (for instance, oil-sealed) or dry roughing vacuum pumps. The vacuum units may comprise one or more high-vacuum pumps, such as one or more cryosorption pumps, diffusion pumps, turbomolecular pumps, molecular drag pumps, turbo-drag hybrid pumps, cryogenic pumps, ions pumps, or getter pumps.

The vacuum units may comprise any combination of vacuum pumps described herein. For instance, the vacuum units may comprise one or more roughing pumps (such as a scroll pump) configured to provide a first stage of rough vacuum pumping. The roughing vacuum pumps may be configured to pump gases out of the system 200 to achieve a low vacuum pressure condition. For instance, the roughing pumps may be configured to pump gases out of the system 200 to achieve a low vacuum pressure of at most about 10³ Pascals (Pa). The vacuum units may further comprise one or more high-vacuum pumps (such as one or more ion pumps, getter pumps, or both) configured to provide a second stage of high vacuum pumping or ultra-high vacuum pumping. The high-vacuum pumps may be configured to pump gases out of the system 200 to achieve a high vacuum pressure of at most about 10 ⁻³ Pa or an ultra-high vacuum pressure of at most about 10⁻⁶ Pa once the system 200 has reached the low vacuum pressure condition provided by the one or more roughing pumps.

The vacuum units may be configured to maintain the system 200 at a pressure of at most about 10⁻⁶ Pa, 9×10⁻⁷ Pa, 8×10⁻⁷ Pa, 7×10⁻⁷ Pa, 6×10⁻⁷ Pa, 5×10⁻⁷ Pa, 4×10⁻⁷ Pa, 3×10⁻⁷ Pa, 2×10⁻⁷ Pa, 10⁻⁷ Pa, 9×10⁻⁸ Pa, 8×10⁻⁸ Pa, 7×10⁻⁸ Pa, 6×10⁻⁸ Pa, 5×10⁻⁸ Pa, 4×10⁻⁸ Pa, 3×10⁻⁸ Pa, 2×10⁻⁸ Pa, 10⁻⁸ Pa, 9×10⁻⁹ Pa, 8×10⁻⁹ Pa, 7×10⁻⁹ Pa, 6×10⁻⁹ Pa, 5×10⁻⁹ Pa, 4×10⁻⁹ Pa, 3×10⁻⁹ Pa, 2×10⁻⁹ Pa, 10⁻⁹ Pa, 9×10⁻¹⁰ Pa, 8×10⁻¹⁰ Pa, 7×10⁻¹⁰ Pa, 6×10⁻¹⁰ Pa, 5×10⁻¹⁰ Pa, 4×10⁻¹⁰ Pa, 3×10⁻¹⁰ Pa, 2×10⁻¹⁰ Pa, 10⁻¹⁰ Pa, 9×10⁻¹¹ Pa, 8×10⁻¹¹ Pa, 7×10⁻¹¹ Pa, 6×10⁻¹¹ Pa, 5×10⁻¹¹ Pa, 4×10⁻¹¹ Pa, 3×10⁻¹¹ Pa, 2×10⁻¹¹ Pa, 10⁻¹¹ Pa, 9×10⁻¹² Pa, 8×10⁻¹² Pa, 7×10⁻¹² Pa, 6×10⁻¹² Pa, 5×10⁻¹² Pa, 4×10⁻¹² Pa, 3×10⁻¹² Pa, 2×10⁻¹² Pa, 10⁻¹² Pa, or lower. The vacuum units may be configured to maintain the system 200 at a pressure of at least about 10⁻¹² Pa, 2×10−12 Pa, 3×10−12 Pa, 4×10−12 Pa, 5×10−12 Pa, 6×10−12 Pa, 7×10−12 Pa, 8×10−12 Pa, 9×10−12 Pa, 10⁻¹¹ Pa, 2×10⁻¹¹ Pa, 3×10⁻¹¹ Pa, 4×10⁻¹¹ Pa, 5×10⁻¹¹ Pa, 6×10⁻¹¹ Pa, 7×10⁻¹¹ Pa, 8×10⁻¹¹ Pa, 9×10⁻¹¹ Pa, 10⁻¹⁰ Pa, 2×10⁻¹⁰ Pa, 3×10⁻¹⁰ Pa, 4×10⁻¹⁰ Pa, 5×10⁻¹⁰ Pa, 6×10⁻¹⁰ Pa, 7×10⁻¹⁰ Pa, 8×10⁻¹⁰ Pa, 9×10⁻¹⁰ Pa, 10⁻⁹ Pa, 2×10⁻⁹ Pa, 3×10⁻⁹ Pa, 4×10⁻⁹ Pa, 5×10⁻⁹ Pa, 6×10⁻⁹ Pa, 7×10⁻⁹ Pa, 8×10⁻⁹ Pa, 9×10⁻⁹ Pa, 10⁻⁸ Pa, 2×10⁻⁸ Pa, 3×10⁻⁸ Pa, 4×10⁻⁸ Pa, 5×10⁻⁸ Pa, 6×10⁻⁸ Pa, 7×10⁻⁸ Pa, 8×10⁻⁸ Pa, 9×10⁻⁸ Pa, 10⁻⁷ Pa, 2×10⁻⁷ Pa, 3×10⁻⁷ Pa, 4×10⁻⁷ Pa, 5×10⁻⁷ Pa, 6×10⁻⁷ Pa, 7×10⁻⁷ Pa, 8×10⁻⁷ Pa, 9×10⁻⁷ Pa, 10⁻⁶ Pa, or higher. The vacuum units may be configured to maintain the system 200 at a pressure that is within a range defined by any two of the preceding values.

The system 200 may comprise one or more state preparation units 250. The state preparation units may comprise any state preparation unit described herein, such as a state preparation unit described herein with respect to FIG. 5. The state preparation units may be configured to prepare a state of the plurality of atoms.

The system 200 may comprise one or more atom reservoirs 260. The atom reservoirs may be configured to supply one or more replacement atoms to replace one or more atoms at one or more optical trapping sites upon loss of the atoms from the optical trapping sites. The atom reservoirs may be spatially separated from the optical trapping units. For instance, the atom reservoirs may be located at a distance from the optical trapping units.

Alternatively or in addition, the atom reservoirs may comprise a portion of the optical trapping sites of the optical trapping units. A first subset of the optical trapping sites may be utilized for performing quantum computations and may be referred to as a set of computationally-active optical trapping sites, while a second subset of the optical trapping sites may serve as an atom reservoir. For instance, the first subset of optical trapping sites may comprise an interior array of optical trapping sites, while the second subset of optical trapping sites comprises an exterior array of optical trapping sites surrounding the interior array. The interior array may comprise a rectangular, square, rectangular prism, or cubic array of optical trapping sites.

The system 200 may comprise one or more atom movement units 270. The atom movement units may be configured to move the one or more replacement atoms from the one or more atoms reservoirs to the one or more optical trapping sites. For instance, the one or more atom movement units may comprise one or more electrically tunable lenses, acousto-optic deflectors (AODs), or spatial light modulators (SLMs).

The system 200 may comprise one or more entanglement units 280. The entanglement units may be configured to quantum mechanically entangle at least a first atom of the plurality of atoms with at least a second atom of the plurality of atoms. The first or second atom may be in a superposition state at the time of quantum mechanical entanglement. Alternatively or in addition, the first or second atom may not be in a superposition state at the time of quantum mechanical entanglement. The first atom and the second atom may be quantum mechanically entangled through one or more magnetic dipole interactions, induced magnetic dipole interactions, electric dipole interactions, or induced electric dipole interactions. The entanglement units may be configured to quantum mechanically entangle any number of atoms described herein.

The entanglement units may also be configured to quantum mechanically entangle at least a subset of the atoms with at least another atom to form one or more multi-qubit units. The multi-qubit units may comprise two-qubit units, three-qubit units, four-qubit units, or n-qubit units, where n may be 5, 6, 7, 8, 9, 10, or more. For instance, a two-qubit unit may comprise a first atom quantum mechanically entangled with a second atom, a three-qubit unit may comprise a first atom quantum mechanically entangled with a second and third atom, a four-qubit unit may comprise a first atom quantum mechanically entangled with a second, third, and fourth atom, and so forth. The first, second, third, or fourth atom may be in a superposition state at the time of quantum mechanical entanglement. Alternatively or in addition, the first, second, third, or fourth atom may not be in a superposition state at the time of quantum mechanical entanglement. The first, second, third, and fourth atom may be quantum mechanically entangled through one or more magnetic dipole interactions, induced magnetic dipole interactions, electric dipole interactions, or induced electric dipole interactions.

The entanglement units may comprise one or more Rydberg units. The Rydberg units may be configured to electronically excite the at least first atom to a Rydberg state or to a superposition of a Rydberg state and a lower-energy atomic state, thereby forming one or more Rydberg atoms or dressed Rydberg atoms. The Rydberg units may be configured to induce one or more quantum mechanical entanglements between the Rydberg atoms or dressed Rydberg atoms and the at least second atom. The second atom may be located at a distance of at least about 200 nanometers (nm), 300 nm, 400 nm, 500 nm, 600 nm, 700 nm, 800 nm, 900 nm, 1 micrometer (μm), 2 μm, 3 μm, 4 μm, 5 μm, 6 μm, 7 μm, 8 μm, 9 μm, 10 μm, or more from the Rydberg atoms or dressed Rydberg atoms. The second atom may be located at a distance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, or less from the Rydberg atoms or dressed Rydberg atoms. The second atom may be located at a distance from the Rydberg atoms or dressed Rydberg atoms that is within a range defined by any two of the preceding values. The Rydberg units may be configured to allow the Rydberg atoms or dressed Rydberg atoms to relax to a lower-energy atomic state, thereby forming one or more two-qubit units. The Rydberg units may be configured to induce the Rydberg atoms or dressed Rydberg atoms to relax to a lower-energy atomic state. The Rydberg units may be configured to drive the Rydberg atoms or dressed Rydberg atoms to a lower-energy atomic state. For instance, the Rydberg units may be configured to apply electromagnetic radiation (such as RF radiation or optical radiation) to drive the Rydberg atoms or dressed Rydberg atoms to a lower-energy atomic state. The Rydberg units may be configured to induce any number of quantum mechanical entanglements between any number of atoms of the plurality of atoms.

The Rydberg units may comprise one or more light sources (such as any light source described herein) configured to emit light having one or more ultraviolet (UV) wavelengths. The UV wavelengths may be selected to correspond to a wavelength that forms the Rydberg atoms or dressed Rydberg atoms. For instance, the light may comprise one or more wavelengths of at least about 200 nm, 210 nm 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, or more. The light may comprise one or more wavelengths of at most about 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm, or less. The light may comprise one or more wavelengths that are within a range defined by any two of the preceding values. For instance, the light may comprise one or more wavelengths that are within a range from 300 nm to 400 nm.

The Rydberg units may be configured to induce a two-photon transition to generate an entanglement. The Rydberg units may be configured to induce a two-photon transition to generate an entanglement between two atoms. The Rydberg units may be configured to selectively induce a two-photon transition to selectively generate an entanglement between two atoms. For instance, the Rydberg units may be configured to direct electromagnetic energy (such as optical energy) to particular optical trapping sites to selectively induce a two-photon transition to selectively generate the entanglement between the two atoms. The two atoms may be trapped in nearby optical trapping sites. For instance, the two atoms may be trapped in adjacent optical trapping sites. The two-photon transition may be induced using first and second light from first and second light sources, respectively. The first and second light sources may each comprise any light source described herein (such as any laser described herein). The first light source may be the same or similar to a light source used to perform a single-qubit operation described herein. Alternatively, different light sources may be used to perform a single-qubit operation and to induce a two-photon transition to generate an entanglement. The first light source may emit light comprising one or more wavelengths in the visible region of the optical spectrum (e.g., within a range from 400 nm to 800 nm or from 650 nm to 700 nm). The second light source may emit light comprising one or more wavelengths in the ultraviolet region of the optical spectrum (e.g., within a range from 200 nm to 400 nm or from 300 nm to 350 nm). The first and second light sources may emit light having substantially equal and opposite spatially-dependent frequency shifts.

The Rydberg atoms or dressed Rydberg atoms may comprise a Rydberg state that may have sufficiently strong interatomic interactions with nearby atoms (such as nearby atoms trapped in nearby optical trapping sites) to enable the implementation of multi-qubit operations. The Rydberg states may comprise a principal quantum number of at least about 50, 60, 70, 80, 90, 100, or more. The Rydberg states may comprise a principal quantum number of at most about 100, 90, 80, 70, 60, 50, or less. The Rydberg states may comprise a principal quantum number that is within a range defined by any two of the preceding values. The Rydberg states may interact with nearby atoms through van der Waals interactions. The van der Waals interactions may shift atomic energy levels of the atoms. 12271 State selective excitation of atoms to Rydberg levels may enable the implementation of multi-qubit operations. The multi-qubit operations may comprise two-qubit operations, three-qubit operations, or n-qubit operations, where n is 4, 5, 6, 7, 8, 9, 10, or more. Two-photon transitions may be used to excite atoms from a ground state (such as a ¹S₀ ground state) to a Rydberg state (such as an n³S₁ state, wherein n is a principal quantum number described herein). State selectivity may be accomplished by a combination of laser polarization and spectral selectivity. The two-photon transitions may be implemented using first and second laser sources, as described herein. The first laser source may emit pi-polarized light, which may not change the projection of atomic angular momentum along a magnetic field. The second laser may emit circularly polarized light, which may change the projection of atomic angular momentum along the magnetic field by one unit. The first and second qubit levels may be excited to Rydberg level using this polarization. However, the Rydberg levels may be more sensitive to magnetic fields than the ground state so that large splittings (for instance, on the order of 100s of MHz) may be readily obtained. This spectral selectivity may allow state selective excitation to Rydberg levels.

Multi-qubit operations (such as two-qubit operations, three-qubit operations, four-qubit operations, and so forth) may rely on energy shifts of levels due to van der Waals interactions described herein. Such shifts may either prevent the excitation of one atom conditional on the state of the other or change the coherent dynamics of excitation of the two-atom system to enact a two-qubit operation. In some cases, “dressed states” may be generated under continuous driving to enact two-qubit operations without requiring full excitation to a Rydberg level (for instance, as described in www.arxiv.org/abs/1605.05207, which is incorporated herein by reference in its entirety for all purposes).

The system 200 may comprise one or more second electromagnetic delivery units (not shown in FIG. 2). The second electromagnetic delivery units may comprise any electromagnetic delivery unit described herein, such as an electromagnetic delivery unit described herein with respect to FIG. 4. The first and second electromagnetic delivery units may be the same. The first and second electromagnetic delivery units may be different. The second electromagnetic delivery units may be configured to apply second electromagnetic energy to the one or more multi-qubit units. The second electromagnetic energy may comprise one or more pulse sequences. The first electromagnetic energy may precede, be simultaneous with, or follow the second electromagnetic energy.

The pulse sequences may comprise any number of pulses. For instance, the pulse sequences may comprise at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more pulses. The pulse sequences may comprise at most about 1,000, 900, 800, 700, 600, 500,400, 300, 200, 100, 90, 80, 70, 60, 50,40, 30, 20, 10, 9, 8, 7, 6, 5, 4, 3, 2, or 1 pulses. The pulse sequences may comprise a number of pulses that is within a range defined by any two of the preceding values. Each pulse of the pulse sequence may comprise any pulse shape, such as any pulse shape described herein.

The pulse sequences may be configured to decrease the duration of time required to implement multi-qubit operations, as described herein (for instance, with respect to Example 3). For instance, the pulse sequences may comprise a duration of at least about 10 nanoseconds (ns), 29 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 microsecond (μs), 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, or more. The pulse sequences may comprise a duration of at most about 100 μs, 90 μs, 80 μs, 70 μs, 60 μs, 50 μs, 40 μs, 30 μs, 20 μs, 10 μs, 9 μs, 8 μs, 7 μs, 6 μs, 5 μs, 4 μs, 3 μs, 2 μs, 1 μs, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, or less. The pulse sequences may comprise a duration that is within a range defined by any two of the preceding values.

The pulse sequences may be configured to increase the fidelity of multi-qubit operations, as described herein. For instance, the pulse sequences may enable multi-qubit operations with a fidelity of at least about 0.5, 0.6, 0.7, 0.8, 0.9, 0.91, 0.92, 0.93, 0.94, 0.95, 0.96, 0.97, 0.98, 0.99, 0.991, 0.992, 0.993, 0.994, 0.995, 0.996, 0.997, 0.998, 0.999, 0.9991, 0.9992, 0.9993, 0.9994, 0.9995, 0.9996, 0.9997, 0.9998, 0.9999, 0.99991, 0.99992, 0.99993, 0.99994, 0.99995, 0.99996, 0.99997, 0.99998, 0.99999, 0.999991, 0.999992, 0.999993, 0.999994, 0.999995, 0.999996, 0.999997, 0.999998, 0.999999, or more. The pulse sequences may enable multi-qubit operations with a fidelity of at most about 0.999999, 0.999998, 0.999997, 0.999996, 0.999995, 0.999994, 0.999993, 0.999992, 0.999991, 0.99999, 0.99998, 0.99997, 0.99996, 0.99995, 0.99994, 0.99993, 0.99992, 0.99991, 0.9999, 0.9998, 0.9997, 0.9996, 0.9995, 0.9994, 0,9993, 0.9992, 0.9991, 0.999, 0.998, 0.997, 0.996, 0.995, 0.994, 0.993, 0.992, 0.991, 0.99, 0.98, 0.97, 0.96, 0.95, 0.94, 0.93, 0.92, 0.91, 0.9, 0.8, 0.7, 0.6, 0.5, or less. The pulse sequences may enable multi-qubit operations with a fidelity that is within a range defined by any two of the preceding values.

The pulse sequences may enable the implementation of multi-qubit operations on non-adiabatic timescales while maintaining effectively adiabatic dynamics. For instance, the pulse sequences may comprise one or more of shortcut to adiabaticity (STA) pulse sequences, transitionless quantum driving (TQD) pulse sequences, superadiabatic pulse sequences, counterdiabatic driving pulse sequences, derivative removal by adiabatic gate (DRAG) pulse sequences, and weak anharmonicity with average Hamiltonian (Wah Wah) pulse sequences. For instance, the pulse sequences may be similar to those described in M. V. Berry, “Transitionless Quantum Driving,” Journal of Physics A: Mathematical and Theoretical 42(36), 365303 (2009), www,doi.org/10.1088/1751-8113/42/36/365303; Y.-Y. Jau et al., “Entangling Atomic Spins with a Strong Rydberg-Dressed Interaction,” Nature Physics 12(1), 71-74 (2016); T. Keating et al., “Robust Quantum Logic in Neutral Atoms via Adiabatic Rydberg Dressing,” Physical Review A 91, 012337 (2015); A. Mitra et al., “Robust Mölmer-Sörenson Gate for Neutral Atoms Using Rapid Adiabatic Rydberg Dressing,” www.arxiv.org/abs/1911.04045 (2019); or L. S. Theis et al., “Counteracting Systems of Diabaticities Using DRAG Controls: The Status after 10 Years,” Europhysics Letters 123(6), 60001 (2018), each of which is incorporated herein by reference in its entirety for all purposes.

The pulse sequences may further comprise one or more optimal control pulse sequences. The optimal control pulse sequences may be derived from one or more procedures, including gradient ascent pulse engineering (GRAPE) methods, Krotov's method, chopped basis methods, chopped random basis (CRAB) methods, Nelder-Mead methods, gradient optimization using parametrization (GROUP) methods, genetic algorithm methods, and gradient optimization of analytic controls (GOAT) methods. For instance, the pulse sequences may be similar to those described in N. Khaneja et al., “Optimal Control of Coupled Spin Dynamics: Design of NMR Pulse Sequences by Gradient Ascent Algorithms,” Journal of Magnetic Resonance 172(2), 296-305 (2005); or J. T. Merrill et al., “Progress in Compensating Pulse Sequences for Quantum Computation,” Advances in Chemical Physics 154, 241-294 (2014), each of which is incorporated by reference in its entirety for all purposes.

### Example of Cloud Computing

The system 200 may be operatively coupled to a digital computer described herein (such as a digital computer described herein with respect to FIG. 1) over a network described herein (such as a network described herein with respect to FIG. 1). The network may comprise a cloud computing network.

### Example of Optical Trapping Units

FIG. 3A shows an example of an optical trapping unit 210. The optical trapping unit may be configured to generate a plurality 211 of spatially distinct optical trapping sites, as described herein. For instance, as shown in FIG. 3B, the optical trapping unit may be configured to generate a first optical trapping site 211a, second optical trapping site 211b, third optical trapping site 211c, fourth optical trapping site 211d, fifth optical trapping site 211e, sixth optical trapping site 211f, seventh optical trapping site 211g, eighth optical trapping site 211h, and ninth optical trapping site 211i, as depicted in FIG. 3A. The plurality of spatially distinct optical trapping sites may be configured to trap a plurality of atoms, such as first atom 212a, second atom 212b, third atom 212c, and fourth atom 212d, as depicted in FIG. 3A. As depicted in FIG. 3B, each optical trapping site may be configured to trap a single atom. As depicted in FIG. 3B, some of the optical trapping sites may be empty (i.e., not trap an atom).

As shown in FG. 3B, the plurality of optical trapping sites may comprise a two-dimensional (2D) array. The 2D array may be perpendicular to the optical axis of optical components of the optical trapping unit depicted in FIG. 3A. Alternatively, the plurality of optical trapping sites may comprise a one-dimensional (ID) array or a three-dimensional (3D) array.

Although depicted as comprising nine optical trapping sites filled by four atoms in FIG. 3B, the optical trapping unit 210 may be configured to generate any number of spatially distinct optical trapping sites described herein and may be configured to trap any number of atoms described herein.

Each optical trapping site of the plurality of optical trapping sites may be spatially separated from each other optical trapping site by a distance of at least about 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, or more. Each optical trapping site may be spatially separated from each other optical trapping site by a distance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, or less. Each optical trapping site maybe spatially separated from each other optical trapping site by a distance that is within a range defined by any two of the preceding values.

The optical trapping sites may comprise one or more optical tweezers. Optical tweezers may comprise one or more focused laser beams to provide an attractive or repulsive force to hold or move the one or more atoms. The beam waist of the focused laser beams may comprise a strong electric field gradient. The atoms may be attracted or repelled along the electric field gradient to the center of the laser beam, which may contain the strongest electric field. The optical trapping sites may comprise one or more optical lattice sites of one or more optical lattices. The optical trapping sites may comprise one or more optical lattice sites of one or more one-dimensional (1D) optical lattices, two-dimensional (2D) optical lattices, or three-dimensional (3D) optical lattices. For instance, the optical trapping sites may comprise one or more optical lattice sites of a 2D optical lattice, as depicted in FIG. 3B.

The optical lattices may be generated by interfering counter-propagating light (such as counter-propagating laser light) to generate a standing wave pattern having a periodic succession of intensity minima and maxima along a particular direction. A ID optical lattice may be generated by interfering a single pair of counter-propagating light beams. A 2D optical lattice may be generated by interfering two pairs of counter-propagating light beams. A 3D optical lattice may be generated by interfering three pairs of counter-propagating lights beams. The light beams may be generated by different light sources or by the same light source. Therefore, an optical lattice may be generated by at least about 1, 2, 3, 4, 5, 6, or more light sources or at most about 6, 5, 4, 3, 2, or 1 light sources.

Returning to the description of FIG. 3A, the optical trapping unit may comprise one or more light sources configured to emit light to generate the plurality of optical trapping sites as described herein. For instance, the optical trapping unit may comprise a single light source 213, as depicted in FIG. 3A. Though depicted as comprising a single light source in FIG. 3A, the optical trapping unit may comprise any number of light sources, such as at least about 1, 2, 3, 4, 5, 6, 7, 8, 9, 10, or more light sources or at most about 10, 9, 8, 7, 6, 5, 4, 3, 2, or 1 light sources. The light sources may comprise one or more lasers. The lasers may be configured to operate at a resolution limit of the lasers. For example, the lasers can be configured to provide diffraction limited spot sizes for optical trapping.

The lasers may comprise one or more continuous wave lasers. The lasers may comprise one or more pulsed lasers. The lasers may comprise one or more gas lasers, such as one or more helium-neon (HeNe) lasers, argon (Ar) lasers, krypton (Kr) lasers, xenon (Xe) ion lasers, nitrogen (N₂) lasers, carbon dioxide (CO₂) lasers, carbon monoxide (CO) lasers, transversely excited atmospheric (TEA) lasers, or excimer lasers. For instance, the lasers may comprise one or more argon dimer (Ar₂) excimer lasers, krypton dimer (Kr₂) excimer lasers, fluorine dimer (F₂) excimer lasers, xenon dimer (Xe₂) excimer lasers, argon fluoride (ArF) excimer lasers, krypton chloride (KrCl) excimer lasers, krypton fluoride (KrF) excimer lasers, xenon bromide (XeBr) excimer lasers, xenon chloride (XeCl) excimer lasers, or xenon fluoride (XeF) excimer lasers. The laser may comprise one or more dye lasers.

The lasers may comprise one or more metal-vapor lasers, such as one or more helium-cadmium (HeCd) metal-vapor lasers, helium-mercury (HeHg) metal-vapor lasers, helium-selenium (HeSe) metal-vapor lasers, helium-silver (HeAg) metal-vapor lasers, strontium (Sr) metal-vapor lasers, neon-copper (NeCu) metal-vapor lasers, copper (Cu) metal-vapor lasers, gold (Au) metal-vapor lasers, manganese (Mn) metal-vapor laser, or manganese chloride (MnCl₂) metal-vapor lasers.

The lasers may comprise one or more solid-state lasers, such as one or more ruby lasers, metal-doped crystal lasers, or metal-doped fiber lasers. For instance, the lasers may comprise one or more neodymium-doped yttrium aluminum garnet (Nd:YAG) lasers, neodymium/chromium doped yttrium aluminum garnet (Nd/Cr:YAG) lasers, erbium-doped yttrium aluminum garnet (Er:YAG) lasers, neodymium-doped yttrium lithium fluoride (Nd:YLF) lasers, neodymium-doped yttrium orthovanadate (ND:YVO₄) lasers, neodymium-doped yttrium calcium oxoborate (Nd:YCOB) lasers, neodymium glass (Nd:glass) lasers, titanium sapphire (Ti:sapphire) lasers, thulium-doped yttrium aluminum garnet (Tm:YAG) lasers, ytterbium-doped yttrium aluminum garnet (Yb:YAG) lasers, ytterbium-doped glass (Yt:glass) lasers, holmium yttrium aluminum garnet (Ho:YAG) lasers, chromium-doped zinc selenide (Cr:ZnSe) lasers, cerium-doped lithium strontium aluminum fluoride (Ce:LiSAF) lasers, cerium-doped lithium calcium aluminum fluoride (Ce:LiCAF) lasers, erbium-doped glass (Er:glass) lasers, erbium-ytterbium-codoped glass (Er/Yt:glass) lasers, uranium-doped calcium fluoride (U:CaF₂) lasers, or samarium-doped calcium fluoride (Sm:CaF₂) lasers.

The lasers may comprise one or more semiconductor lasers or diode lasers, such as one or more gallium nitride (CaN) lasers, indium gallium nitride (InGaN) lasers, aluminum gallium indium phosphide (AlGaJnP) lasers, aluminum gallium arsenide (AlGaAs) lasers, indium gallium arsenic phosphide (InGaAsP) lasers, vertical cavity surface emitting lasers (VCSELs), or quantum cascade lasers.

The lasers may emit continuous wave laser light. The lasers may emit pulsed laser light. The lasers may have a pulse length of at least about 1 femtoseconds (fs), 2 fs, 3 fs, 4 fs, 5 fs, 6 fs, 7 fs, 8 fs, 9 fs, 10 fs, 20 fs, 30 fs, 40 fs, 50 fs, 60 fs, 70 fs, 80 fs, 90 fs, 100 fs, 200 fs, 300 fs, 400 fs, 500 fs, 600 fs, 700 fs, 800 fs, 900 fs, 1 picosecond (ps), 2 ps, 3 ps, 4 ps, 5 ps, 6 ps, 7 ps, 8 ps, 9 ps, 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 nanosecond (ns), 2 ns, 3 ns, 4 ns, 5 ns, 6 ns, 7 ns, 8 ns, 9 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1,000 ns, or more. The lasers may have a pulse length of at most about 1,000 ns, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, 9 ns, 8 ns, 7 ns, 6 ns, 5 ns, 4 ns, 3 ns, 2 ns, 1 ns. 900 ps, 800 ps, 700 ps, 600 ps, 500 ps, 400 ps, 300 ps, 200 ps, 100 ps, 90 ps, 80 ps, 70 ps, 60 ps, 50 ps, 40 ps, 30 ps, 20 ps, 10 ps, 9 ps, 8 ps, 7 ps, 6 ps, 5 ps, 4 ps, 3 ps, 2 ps, 1 ps, 900 fs, 800 ps, 700 fs, 600 fs, 500 fs, 400 fs, 300 fs, 200 fs, 100 fs, 90 fs, 80 fs, 70 fs, 60 fs, 50 fs, 40 fs, 30 fs, 20 fs, 10 fs, 9 fs, 8 fs, 7 fs, 6 fs, 5 fs, 4 fs, 3 fs, 2 fs, 1 fs, or less. The lasers may have a pulse length that is within a range defined by any two of the preceding values.

The lasers may have a repetition rate of at least about 1 hertz (Hz), 2 Hz, ³ Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz. 600 Hz, 700 Hz, 800 Hz, 900 Hz, 1 kilohertz (kHz), 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 megahertz (MHz), 2 MHz, 3 MHz, 4 MHz, 5 MHz, 6 MHz, 7 MHz, 8 MHz, 9 MHz, 10 MHz, 20 MHz, 30 MHz, 40 MHz, 50 MHz, 60 MHz, 70 MHz, 80 MHz, 90 MHz, 100 MHz, 200 MHz, 300 MHz, 400 MHz, 500 MHz, 600 MHz, 700 MHz, 800 MHz, 900 MHz, 1,000 MHz, or more. The lasers may have a repetition rate of at most about 1,000 MHz, 900 MHz, 800 MHz, 700 MHz, 600 MHz, 500 MHz, 400 MHz, 300 MHz, 200 MHz, 100 MHz, 90 MHz, 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, 900 Hz, 800 Hz, 700 Hz, 600 Hz, 500 Hz, 400 Hz, 300 Hz, 200 Hz, 100 Hz, 90 Hz, 80 Hz, 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The lasers may have a repetition rate that is within a range defined by any two of the preceding values.

The lasers may emit light having a pulse energy of at least about 1 nanojoule (nJ), 2 nJ, 3 nJ, 4 nJ, 5 nJ, 6 nJ, 7 nJ, 8 nJ, 9 nJ, 10 nJ, 20 nJ, 30 nJ, 40 nJ, 50 nJ, 60 nJ, 70 nJ, 80 nJ, 90 nJ, 100 nJ, 200 nJ, 300 nJ, 400 nJ, 500 nJ, 600 nJ, 700 nJ, 800 nJ, 900 nJ, 1 microjoule (μJ), 2 μJ, 3 μJ, 4 μJ, 5 μJ, 6 μJ, 7 μJ, 8 μJ, 9 μJ, 10 μJ, 20 μJ, 30 μJ, 40 μJ, 50 μJ, 60 μJ, 70 μJ, 80 μJ, 90 μJ, 100 μJ, 200 μJ, 300 μJ, 400 μJ, 500 μJ, 600 μJ, 700 μJ, 800 μJ-, 900 μJ, a least 1 millijoule (mJ), 2 mJ, 3 mJ, 4 mJ, 5 mJ, 6 mJ, 7 mJ, 8 mJ, 9 mJ, 10 mJ, 20 mJ, 30 mJ, 40 mJ, 50 mJ, 60 mJ, 70 mJ, 80 mJ, 90 mJ, 100 mJ, 200 mJ, 300 ml, 400 nJ, 500 mJ, 600 mJ, 700 mJ, 800 mJ, 900 mJ, a least 1 Joule (J), or more. The lasers may emit light having a pulse energy of at most about 1 J, 900 mJ, 800 mJ, 700 mJ, 600 mJ, 500 mJ, 400 mJ, 300 mJ, 200 nJ, 100 mJ, 90 mJ, 80 mJ, 70 nJ, 60 mJ, 50 mJ, 40 mJ, 30 mJ, 20 mJ, 10 mJ, 9 mJ, 8 mJ, 7 mJ, 6 mJ, 5 mJ, 4 mJ, 3 mJ, 2 mJ, 1 mJ, 900 μJ, 800 μJ, 700 J, 600 μJ, 500 μJ, 400 μJ, 300 μJ, 200 μJ, 100 μJ, 90 μJ, 80 μJ, 70 μJ, 60 μJ, 50 μJ, 40 μJ, 30 μJ, 20 μJ, 10 μJ, 9 μJ, 8 μJ, 7 μJ, 6 μJ, 5 μJ, 4 μJ, 3 μJ, 2 μJ, 1 μJ, 900 nJ, 800 nJ, 700 nJ, 600 nJ, 500 nJ, 400 nJ, 300 nJ, 200 nJ, 100 nJ, 90 nJ, 80 nJ, 70 nJ, 60 nJ, 50 nJ, 40 nJ, 30 nJ, 20 nJ, 10 nJ, 9 nJ, 8 nJ, 7 nJ, 6 nJ, 5 nJ, 4 nJ, 3 nJ, ² nJ, 1 nJ, or less. The lasers may emit light having a pulse energy that is within a range defined by any two of the preceding values.

The lasers may emit light having an average power of at least about 1 microwatt (μW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 400 μW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, 1 watt (W), 2 W, 3 W, 4 W, 5 W, 6 W, ⁷ W, 8 W, 9 W, 10 W, 20 W, 30 W, 40 W, 50 W, 60 W, 70 W, 80 W, 90 W, 100 W, 200 W, 300 W, 400 W, 500 W, 600 W, 700 W, 800 W, 900 W, 1,000 W, or more. The lasers may emit light having an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W, 10 W, 9 W, 8 W, 7 W, 6 W, 5 W, 4 W, 3 W, 2 W, 1 W, 900 mW, 800 mW, 700 mW, 600 mW, 500 mW, 400 mW, 300 mW, 200 mW, 100 mW, 90 mW, 80 mW, 70 mW, 60 mW, 50 mW, 40 mW, 30 mW, 20 mW, 10 mW, 9 mW, 8 mW, 7 mW, 6 mW, 5 mW, 4 mW, 3 mW, 2 mW, 1 mW, 900 μW, 800 μW, 700 μW, 600 μW, 500 μW, 400 μW, 300 μW, 200 μW, 100 μW, 90 μW, 80 μW, 70 μW, 60 μW, 50 μW, 40 μW, 30 μW, 20 μW, 10 μW, 9 μW, 8 μW, 7 μW, 6 μW, 5 μW, 4 μW, 3 μW, 2 μW, 1 μW, or more. The lasers may emit light having a power that is within a range defined by any two of the preceding values.

The lasers may emit light comprising one or more wavelengths in the ultraviolet (UV), visible, or infrared (IR) portions of the electromagnetic spectrum. The lasers may emit light comprising one or more wavelengths of at least about 200 nim, 210 nim, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 rm, 940 nm, 950 nm, 960 nm, 970 nm, 980 nm, 990 nm, 1,000 nm, 1,010 nm, 1,020 nm, 1,030 nm, 1,040 nm, 1,050 nm, 1,060 nm, 1,070 nm, 1,080 nm, 1,090 nm, 1,100 nm, 1,110 nm, 1,120 nm, 1,130 nm, 1,140 nm, 1,150 nm, 1,160 nm. 1,170 nm, 1,180 nm, 1,190 nm, 1,200 nm. 1,210 nm, 1,220 nm, 1,230 nm, 1,240 nm, 1,250 nm, 1,260 nm, 1,270 nm, 1,280 nm, 1,290 nm, 1,300 nm, 1,310 nm, 1,320 nm, 1,330 nm, 1,340 nm, 1,350 nm, 1,360 nm, 1,370 nm, 1,380 nm, 1,390 nm, 1,400 nm, or more. The lasers may emit light comprising one or more wavelengths of at most about 1,400 nm, 1,390 nm, 1,380 nm, 1,370 n, 1,360 nm, 1,350 nm, 1,340 nm, 1,330 nm, 1,320 nm, 1,310 nm, 1,300 nm, 1,290 nm, 1,280 nm, 1,270 n, 1,260 nm, 1,250 nm, 1,240 nm, 1,230 nm, 1,220 nm, 1,210 nm, 1,200 nm, 1,190 nm, 1,180 nm, 1,170 n, 1,160 nm, 1,150 nm, 1,140 nm, 1,130 nm, 1,120 nm, 1,110 nm, 1,100 nm, 1,090 nm, 1,080 nm, 1,070 n, 1,060 nm, 1,050 nm, 1,040 nm, 1,030 nm, 1,020 nm, 1,010 nm, 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 6410 nm, 630 m, 620 nm, 610 nm, 600 nm, 590 nm, 580 nm, 570 nm, 560 nm, 550 nm, 540 nm, 530 nm, 520 n, 510 n, 500 nm, 490 nm, 480 nm, 470 nm, 460 nm, 450 nm, 440 nm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm. The lasers may emit light comprising one or more wavelengths that are within a range defined by any two of the preceding values.

The lasers may emit light having a bandwidth of at least about 1×10−15 nm, 2×10⁻¹⁵ nm, 3×10⁻¹⁵ nm, 4×10⁻¹⁵ nm, 5×10⁻¹⁵ nm, 6×10⁻¹⁵ nm, 7×10⁻¹⁵ nm, 8×10⁻¹⁵ nm, 9×10⁻¹⁵ nm, 1×10⁻¹⁴ nm, 2×10⁻¹⁴ nm, 3×10⁻¹⁴ nm, 4×10⁻¹⁴ nm, 5×10⁻¹⁴ nm, 6×10⁻¹⁴ nm, 7×10⁻¹⁴ nm, 8×10⁻¹⁴ nm, 9×10⁻¹⁴ nm, 1×10⁻¹³ nm, 2×10⁻¹³ nm, 3×10⁻¹³ nm, 4×10⁻¹³ nm, 5×10⁻¹³ nm, 6×10⁻¹³ nm, 7×10⁻¹³ nm, 8×10⁻¹³ nm, 9×10⁻¹³ nm, 1×10⁻¹² nm, 2×10⁻¹² nm, 3×10⁻¹² nm, 4×10⁻¹² nm, 5×10⁻¹² nm, 6×10⁻¹² nm, 7×10⁻¹² nm, 8×10⁻¹² nm, 9×10⁻¹² nm, 1×10⁻¹¹ nm, 2×10⁻¹¹ nm, 3×10⁻¹¹ nm, 4×10⁻¹¹ nm, 5×10⁻¹¹ nm, 6×10⁻¹¹ nm, 7×10⁻¹¹ nm, 8×10⁻¹¹ nm, 9×10⁻¹¹ nm, 1×10⁻¹⁰ nm, 2×10⁻¹⁰ nm, 3×10⁻¹⁰ nm, 4×10⁻¹⁰ nm, 5×10⁻¹⁰ nm, 6×10⁻¹⁰ nm, 7×10⁻¹⁰ nm, 8×10⁻¹⁰ nm, 9×10⁻¹⁰ nm, 1×10⁻⁹ nm, 2×10⁻⁹ nm, 3×10⁻⁹ nm, 4×10⁻⁹ nm, 5×10⁻⁹ nm, 6×10⁻⁹ nm, 7×10⁻⁹ nm, 8×10⁻⁹ nm, 9×10⁻⁹ nm, 1×10⁻⁸ nm, 2×10⁻⁸ nm, 3×10⁻⁸ nm, 4×10⁻⁸ nm, 5×10⁻⁹ nm, 6×10⁻⁸ nm, 7×10⁻⁸ nm, 8×10⁻⁸ nm, 9×10⁻⁸ nm, 1×10⁻⁷ nm, 2×10⁻⁷ nm, 3×10⁻⁷ nm, 4×10⁻⁷ nm, 5×10⁻⁷ nm, 6×10⁻⁷ nm, 7×10⁻⁷ nm, 8×10⁻⁷ nm, 9×10⁻⁷ nm, 1×10⁻⁶ nm, 2×10⁻⁶ nm, 3×10⁻⁶ nm, 4×10⁻⁶ nm, 5×10⁻⁶ nm, 6×10⁻⁶ nm, 7×10⁻⁶ nm, 8×10⁻⁶ nm, 9×10⁻⁶ nm, 1×10⁻⁵ nm, 2×10⁻⁵ nm, 3×10⁻⁵ nm, 4×10⁻⁵ nm, 5×10⁻⁵ nm, 6×10⁻⁵ nm, 7×10⁻⁵ nm, 8×10⁻⁵ nm, 9×10⁻⁵ nm, 1×10⁻⁴ nm, 2×10⁻⁴ nm, 3×10⁻⁴ nm, 4×10⁻⁴ nm, 5×10⁻⁴ nm, 6×10⁻⁴ nm, 7×10⁻⁴ nm, 8×10⁻⁴ nm, 9×10⁻⁴ nm, 1×10⁻³ nm, or more. The lasers may emit light having a bandwidth of at most about 1×10−3 nm, 9×10⁻⁴ nm, 9×10⁻⁴ nm, 7×10⁻⁴ nm, 6×10⁻⁴ nm, 5×10⁻⁴ nm, 4×10⁻⁴ nm, 3×10⁻⁴ nm, 2×10⁻⁴ nm, 1×10⁻⁴ nm, 9×10⁻⁵ nm, 8×10⁻⁵ nm, 7×10⁻⁵ nm, 6×10⁻⁵ nm, 5×10⁻⁵ nm, 4×10⁻⁵ nm, 3×10⁻⁵ nm, 2×10⁻⁵ nm, 1×10⁻⁵ nm, 9×10⁻⁶ nm, 8×10⁻⁶ nm, 7×10⁻⁶ nm, 6×10⁻⁶ nm, 5×10⁻⁶ nm, 4×10⁻⁶ nm, 3×10⁻⁶ nm, 2×10⁻⁶ nm, 1×10⁻⁶ nm, 9×10⁻⁷ nm, 8×10⁻⁷ nm, 7×10⁻⁷ nm, 6×10⁻⁷ nm, 5×10⁻⁷ nm, 4×10⁻⁷ nm, 3×10⁻⁷ nm, 2×10⁻⁷ nm, 1×10⁻⁷ nm, 9×10⁻⁸ nm, 8×10⁻⁸ nm, 7×10⁻⁸ nm, 6×10⁻⁸ nm, 5×10⁻⁸ nm, 4×10⁻⁸ nm, 3×10⁻⁸ nm, 2×10⁻⁸ nm, 1×10⁻⁸ nm, 9×10⁻⁹ nm, 8×10⁻⁹ nm, 7×10⁻⁹ nm, 6×10⁻⁹ nm, 5×10⁻⁹ nm, 4×10⁻⁹ nm, 3×10⁻⁹ nm, 2×10⁻⁹ nm, 1×10⁻⁹ nm, 9×10⁻¹⁰ nm, 8×10⁻¹⁰ nm, 7×10⁻¹⁰ nm, 6×10⁻¹⁰ nm, 5×10⁻¹⁰ nm, 4×10⁻¹⁰ nm, 3×10⁻¹⁰ nm, 2×10⁻¹⁰ nm, 1×10⁻¹⁰ nm, 7×10⁻¹⁰ nm, 6×10⁻¹⁰ nm, 5×10⁻¹⁰ nm, 4×10⁻¹⁰ nm, 3×10⁻¹⁰ nm, 2×10⁻¹⁰ nm, 1×10⁻¹⁰ nm, 9×10⁻¹¹ nm, 8×10⁻¹¹ nm, 7×10⁻¹¹ nm, 6×10⁻¹¹ nm, 5×10⁻¹¹ nm, 4×10⁻¹¹ nm, 3×10⁻¹¹ nm, 2×10⁻¹¹ nm, 1×10⁻¹¹ nm, 9×10⁻¹² nm, 8×10⁻¹² nm, 7×10⁻¹² nm, 6×10⁻¹² nm, 5×10⁻¹² nm, 4×10⁻¹² nm, 3×10⁻¹² nm, 2×10⁻¹² nm, 1×10⁻¹² nm, 9×10⁻¹³ nm, 8×10⁻¹³ nm, 7×10⁻¹³ nm, 6×10⁻¹³ nm, 5×10⁻¹³ nm, 4×10⁻¹³ nm, 3×10⁻¹³ nm, 2×10⁻¹² nm, 1×10⁻¹³ nm, 9 10⁻¹⁴ nm, 8×10⁻¹⁴ nm, 7×10⁻¹⁴ nm, 6×10⁻¹⁴ nm, 5×10⁻¹⁴ nm, 4×10⁻¹⁴ nm, 3×10⁻¹⁴ nm, 2×10⁻¹⁴ nm, 1×10⁻¹⁴ nm, 9×10⁻¹⁵ nm, 8×10⁻¹⁵ nm, 7×10⁻¹⁵ nm, 6×10⁻¹⁵ nm, 5×10⁻¹⁵ nm, 4×10⁻¹⁵ nm, 3×10⁻¹⁵ nm, 2×10⁻¹⁵ nm, 1×10⁻¹⁵ nm, or less. The lasers may emit light having a bandwidth that is within a range defined by any two of the preceding values.

The light sources may be configured to emit light tuned to one or more magic wavelengths corresponding to the plurality of atoms. A magic wavelength corresponding to an atom may comprise any wavelength of light that gives rise to equal or nearly equal polarizabilities of the first and second atomic states. The magic wavelengths for a transition between the first and second atomic states may be determined by calculating the wavelength-dependent polarizabilities of the first and second atomic states and finding crossing points. Light tuned to such a magic wavelength may give rise to equal or nearly equal differential light shifts in the first and second atomic states, regardless of the intensity of the light emitted by the light sources. This may effectively decouple the first and second atomic states from motion of the atoms. The magic, wavelengths may utilize one or more scalar or tensor light shifts. The scalar or tensor light shifts may depend on magnetic sublevels within the first and second atomic states.

For instance, group III atoms and metastable states of alkaline earth or alkaline earth-like atoms may possess relatively large tensor shifts whose angle relative to an applied magnetic field may be tuned to cause a situation in which scalar and tensor shifts balance and give a zero or near zero differential light shift between the first and second atomic states. The angle θ may be tuned by selecting the polarization of the emitted light. For instance, when the emitted light is linearly polarized, the total polarizability α may be written as a sum of the scalar component α_{scalar} and the tensor component αₛₑₙₛₒᵣ:

$$α = {α}_{scalar} + ( 3 cos {θ}^{2} - 1 ) {α}_{tensor}$$

By choosing θ appropriately, the polarizability of the first and second atomic states may be chosen to be equal or nearly equal, corresponding to a zero or near zero differential light shift and the motion of the atoms may be decoupled.

The light sources may be configured to direct light to one or more optical modulators (OMs) configured to generate the plurality of optical trapping sites. For instance, the optical trapping unit may comprise an OM 214 configured to generate the plurality of optical trapping sites. Although depicted as comprising one OM in FIG. 3A, the optical trapping unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more digital micromirror devices (DMDs). The OMs may comprise one or more liquid crystal devices, such as one or more liquid crystal on silicon (LCoS) devices. The OMs may comprise one or more spatial light modulators (SLMs). The OMs may comprise one or more acousto-optic deflectors (AODs) or acousto-optic modulators (AOMs). The OMs may comprise one or more electro-optic deflectors (EODs) or electro-optic modulators (EOMs).

The GM may be optically coupled to one or more optical element to generate a regular array of optical trapping sites. For instance, the OM may be optically coupled to optical element 219, as shown in FIG. 3A. The optical elements may comprise lenses or microscope objectives configured to re-direct light from the OMs to form a regular rectangular grid of optical trapping sites.

For instance, as shown in FIG. 3A, the OM may comprise an SLM, DMD, or LCoS device. The SLM, DMD, or LCoS device may be imaged onto the back focal plane of the microscope objectives. This may allow for the generation of an arbitrary configuration of optical trapping sites in two or three dimensions.

Alternatively or in addition, the OMs may comprise first and second AODs. The active regions of the first and second AODs may be imaged onto the back focal plane of the microscope objectives. The output of the first AOD may be optically coupled to the input of the second AOD. In this manner, the second AOD may make a copy of the optical output of the first AOD. This may allow for the generation of optical trapping sites in two or three dimensions.

Alternatively or in addition, the OMs may comprise static optical elements, such as one or more microlens arrays or holographic optical elements. The static optical elements may be imaged onto the back focal plane of the microscope objectives. This may allow for the generation of an arbitrary configuration of optical trapping sites in two or three dimensions.

The optical trapping unit may comprise one or more imaging units configured to obtain one or more images of a spatial configuration of the plurality of atoms trapped within the optical trapping sites. For instance, the optical trapping unit may comprise imaging unit 215. Although depicted as comprising a single imaging unit in FIG. 3A, the optical trapping unit may comprise any number of imaging units, such as at least about 1, 2, 3, 4, 5, 6, 7, 8, 9, 10, or more imaging unit: or at most about 10, 9, 8, 7, 6, 5, 4, 3, 2, or 1 imaging units. The imaging units may comprise one or more lens or objectives. The imaging units may comprise one or more PMTs, photodiodes, avalanche photodiodes, phototransistors, reverse-biased LEDs, CCDs, or CMOS cameras. The imaging unit may comprise one or more fluorescence detectors. The images may comprise one or more fluorescence images, single-atom fluorescence images, absorption images, single-atom absorption images, phase contrast images, or single-atom phase contrast images.

The optical trapping unit may comprise one or more spatial configuration artificial intelligence (AI) units configured to perform one or more AI operations to determine the spatial configuration of the plurality of atoms trapped within the optical trapping sites based on the images obtained by the imaging unit. For instance, the optical trapping unit may comprise spatial configuration AI unit 216. Although depicted as comprising a single spatial configuration AI unit in FIG. 3A, the optical trapping unit may comprise any number of spatial configuration AI units, such as at least about 1, 2, 3, 4, 5, 6, 7, 8, 9, 10, or more spatial configuration AI units or at most about 10, 9, 8, 7, 6, 5, 4, 3, 2, or 1 spatial configuration AI units. The AI operations may comprise any machine learning (ML) or reinforcement learning (RL) operations described herein.

The optical trapping unit may comprise one or more atom rearrangement units configured to impart an altered spatial arrangement of the plurality of atoms trapped with the optical trapping sites based on the one or more images obtained by the imaging unit. For instance, the optical trapping unit may comprise atom rearrangement unit 217. Although depicted as comprising a single atom rearrangement unit in FIG. 3A, the optical trapping unit may comprise any number of atom rearrangement units, such as at least about 1, 2, 3, 4, 5, 6, 7, 8, 9, 10, or more atom rearrangement units or at most about 10, 9, 8, 7, 6, 5, 4, 3, 2, or 1 atom rearrangement units.

The optical trapping unit may comprise one or more spatial arrangement artificial intelligence (AI) units configured to perform one or more AI operations to determine the altered spatial arrangement of the plurality of atoms trapped within the optical trapping sites based on the images obtained by the imaging unit. For instance, the optical trapping unit may comprise spatial arrangement AI unit 218. Although depicted as comprising a single spatial arrangement AI unit in FIG. 3A, the optical trapping unit may comprise any number of spatial arrangement A units, such as at least about 1, 2, 3, 4, 5, 6, 7, 8, 9, 10, or more spatial arrangement AI units or at most about 10, 9, 8, 7, 6, 5, 4, 3, 2, or 1 spatial arraignment AI units. The AI operations may comprise any machine learning (ML) or reinforcement learning (RL) operations described herein.

In some cases, the spatial configuration AI units and the spatial arrangement AI units may be integrated into an integrated AI unit. The optical trapping unit may comprise any number of integrated AI units, such as at least about 1, 2, 3, 4, 5, 6, 7, 8, 9, 10, or more integrated AI units, or at most about 10, 9, 8, 7, 6, 5, 4, 3, 2, or 1 integrated A units.

The atom rearrangement unit may be configured to alter the spatial arrangement in order to obtain an increase in a filling factor of the plurality of optical trapping sites. A filling factor may be defined as a ratio of the number of computationally active optical trapping sites occupied by one or more atoms to the total number of computationally active optical trapping sites available in the optical trapping unit or in a portion of the optical trapping unit. For instance, initial loading of atoms within the computationally active optical trapping sites may give rise to a filling factor of less than 100%, 90%, 80%, 70%, 60%, 50%, or less, such that atoms occupy fewer than 100%, 90%, 70%, 60%, 50%, or less of the available computationally active optical trapping sites, respectively. It may be desirable to rearrange the atoms to achieve a filling factor of at least about 50%, 60%, 70%, 80%, 90%, or 100%. By analyzing the imaging information obtained by the imaging unit, the atom rearrangement unit may attain a filling factor of at least about 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, or more. The atom rearrangement unit may attain a filling factor of at most about 99.99%, 99.98%, 99.97%, 99.96%, 99.95%, 99.94%, 99.93%, 99.92%, 99.91%, 99.9%, 99.8%, 99.7%, 99.6%, 99.5%, 99.4%, 99.3%, 99.2%, 99.1%, 99%, 98%, 97%, 96%, 95%, 94%, 93%, 92%, 91%, 90%, 80%, 70%, 60%, 50%, or less. The atom rearrangement unit may attain a filling factor that is within a range defined by any two of the preceding values.

By way of example, FIG. 3C shows an example of an optical trapping unit that is partially filled with atoms. As depicted in FIG. 3C, initial loading of atoms within the optical trapping sites may give rise to a filling factor of 44.4% (4 atoms filling 9 available optical trapping sites). By moving atoms from different regions of the optical trapping unit (not shown in FIG. 3C) to unoccupied optical trapping sites or by moving atoms from an atom reservoir described herein, a much higher filling factor may be obtained, as shown in FIG. 3D.

FIG. 3D shows an example of an optical trapping unit that is completely filled with atoms. As depicted in FIG. 3D, fifth atom 212e, sixth atom 212f, seventh atom 212g, eighth atom 212h, and ninth atom 212i may be moved to fill unoccupied optical trapping sites. The fifth, sixth, seventh, eighth, and ninth atoms may be moved from different regions of the optical trapping unit (not shown in FIG. 3C) or by moving atoms from an atom reservoir described herein. Thus, the filling factor may be substantially improved following rearrangement of atoms within the optical trapping sites. For instance, a filling factor of up to 100% (such 9 atoms filling 9 available optical trapping sites, as shown in FIG. 3D) may be attained.

Atom rearrangement may be performed by (i) acquiring an image of the optical trapping unit, identifying filled and unfilled optical trapping sites, (ii) determining a set of moves to bring atoms from filled optical trapping sites to unfilled optical trapping sites, and (iii) moving the atoms from filled optical trapping sites to unfilled optical trapping sites. Operations (i), (ii), and (iii) may be performed iteratively until a large filling factor is achieved. Operation (iii) may comprise translating the moves identified in operation (ii) to waveforms that may be sent to an arbitrary waveform generator (AWG) and using the AWG to drive AODs to move the atoms. The set of moves may be determined using the Hungarian algorithm described in W. Lee et al, “Defect-Free Atomic Array Formation Using Hungarian Rearrangement Algorithm,” Physical Review A 95, 053424 (2017), which is incorporated herein by reference in its entirety for all purposes.

### Example of Electromagnetic Delivery Units

FIG. 4 shows an example of an electromagnetic delivery unit 220. The electromagnetic delivery unit may be configured to apply electromagnetic energy to one or more atoms of the plurality of atoms, as described herein. The electromagnetic delivery unit may comprise one or more light sources, such as any light source described herein. The electromagnetic energy may comprise optical energy. The optical energy may comprise any repetition rate, pulse energy, average power, wavelength, or bandwidth described herein.

The electromagnetic delivery unit may comprise one or more microwave or radiofrequency (RF) energy sources, such as one or more magnetrons, klystrons, traveling-wave tubes, gyrotrons, field-effect transistors (FETs), tunnel diodes, Gunn diodes, impact ionization avalanche transit-time (IMPATT) diodes, or masers. The electromagnetic energy may comprise microwave energy or RF energy. The RF energy may comprise one or more wavelengths of at least about 1 millimeter (mm), 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1 meter (m), 2 m, 3 m, 4 m, 5 n, 6 m, 7 m, 8 m, 9 m, 10 m, 20 m, 30 m, 40 m, 50 m, 60 m, 70 m, 80 m, 90 m, 100 m, 200 m, 300 m, 400 m, 500 m, 600 m, 700 m, 800 m, 900 m, 1 kilometer (km), 2 km, 3 km, 4 km, 5 km, 6 km, 7 km, 8 km, 9 km, 10 km, or more. The RF energy may comprise one or more wavelengths of at most about 10 km, 9 km, 8 km, 7 km, 6 km, 5 km, 4 km, 3 km, 2 km, 1 km, 900 m, 800 m, 700 m, 600 m, 500 m, 400 m, 300 m, 200 m, 100 m, 90 m, 80 m, 70 m, 60 m, 50 m, 40 m, 30 m, 20 m, 10m, 9 m, 8m, 7 m, 6 m, 5 m, 4 m, 3 m, 2 m, 1 m, 900 mm, 800 mm, 700 mm, 600 mm, 500 mm, 400 mm, 300 mm, 200 mm, 100 mm, 90 mm, 80 mm, 70 mm, 60 mm, 50 mm, 40 mm, 30 mm, 20 mm, 10 mm, 9 mm, 8 mm, 7 mm, 6 mm, 5 mm, 4 mm, 3 mm, 2 mm, 1 mm, or less. The RF energy may comprise one or more wavelengths that are within a range defined by any two of the preceding values.

The RF energy may comprise an average power of at least about 1 micro watt (μW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 400 μW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, 1 Watt (W), 2 W, 3 W, 4 W, 5 W, 6 W, 7 W, 8 W, 9 W, 10 W, 20 W, 30 W, 40 W, 50 W, 60 W, 70 W, 80 W, 90 W, 100 W, 200 W, 300 W, 400 W, 500 W, 600 W, 700 W, 800 W, 900 W, 1,000 W, or more. The RF energy may comprise an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W, IOW, 9 W, 8 W, 7 W, 6 W, 5 W, 4 W, 3 W, 2 W, 1 W, 900 mW, 800 mW, 700 mW, 600 mW, 500 mW, 400 mW, 300 mW, 200 mW, 100 mW, 90 mW, 80 mW, 70 mW, 60 mW, 50 mW, 40 mW, 30 mW, 20 mW, 10 mW, 9 mW, 8 mW, 7 mW, 6 mW, 5 mW, 4 mW, 3 mW, 2 mW, 1 mW, 900 μW, 800 μW, 700 μW, 600 μW, 500 μW, 400 μW, 300 μW, 200 μW, 100 μW, 90 μW, 80 μW, 70 μW, 60 μW, 50 μW, 40 μW, 30 μW, 20 μW, 10 μW, 9 μW, 8 μW, 7 μW, 6 μW, 5 μW, 4 μW, 3 μW, 2 μW, 1 μW, or less. The RF energy may comprise an average power that is within a range defined by any two of the preceding values.

The electromagnetic delivery unit may comprise one or more light sources, such as any light source described herein. For instance, the electromagnetic delivery unit may comprise light source 221. Although depicted as comprising a single light source in FIG. 4, the electromagnetic delivery unit may comprise any number of light sources, such as at least about 1, 2, 3, 4, 5, 6, 7, 8, 9, 10, or more light sources or at most about 10, 9, 8, 7, 6, 5, 4, 3, 2, or 1 light sources.

The light sources may be configured to direct light to one or more OMs configured to selectively apply the electromagnetic energy to one or more atoms of the plurality of atoms. For instance, the electromagnetic delivery unit may comprise OM 222. Although depicted as comprising a single OM in FIG. 4, the electromagnetic delivery unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more SLMs, AODs, or AOMs. The OMs may comprise one or more DMDs. The OMs may comprise one or more liquid crystal devices, such as one or more LCoS devices.

The electromagnetic delivery unit may comprise one or more electromagnetic energy artificial intelligence (AI) units configured to perform one or more A operations to selectively apply the electromagnetic energy to the atoms. For instance, the electromagnetic delivery unit may comprise AI unit 223. Although depicted as comprising a single AL unit in FIG. 4, the electromagnetic delivery unit may comprise any number of AI units, such as at least about 1, 2, 3, 4, 5,6, 7, 8, 9, 10, or more AI units or at most about 10, 9, 8, 7, 6, 5, 4, 3, 2, or 1 AI units. The AI operations may comprise any machine learning (ML) or reinforcement learning (RL) operations described herein.

The electromagnetic delivery unit may be configured to apply one or more single-qubit operations (such as one or more single-qubit gate operations) on the qubits described herein. The electromagnetic delivery unit may be configured to apply one or more two-qubit operations (such as one or more two-qubit gate operations) on the two-qubit units described herein. Each single-qubit or two-qubit operation may comprise a duration of at least about 10 nanoseconds (ns), 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 microsecond (μs), 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, or more. Each single-qubit or two-qubit operation may comprise a duration of at most about 100 μs, 90 μs, 80 μs, 70 μs, 60 μs, 50 μs, 40 μs, 30 μs, 20 μs, 10 μs, 9 μs, 8 μs, 7 μs, 6 μs, 5 μs, 4 μs, 3 μs, 2 μs, 1 μs, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, or less. Each single-qubit or two-qubit operation may comprise a duration that is within a range defined by any two of the preceding values. The single-qubit or two-qubit operations may be applied with a repetition frequency of at least 1 kilohertz (kHz), 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1,000 kHz, or more. The single-qubit or two-qubit operations may be applied with a repetition frequency of at most 1,000 kHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, or less. The single-qubit or two-qubit operations may be applied with a repetition frequency that is within a range defined by any two of the preceding values.

The electromagnetic delivery unit may be configured to apply one or more single-qubit operations by inducing one or more Raman transitions between a first qubit state and a second qubit state described herein. The Raman transitions may be detuned from a ³P₀ or ³P₁ line described herein. For instance, the Raman transitions may be detuned by at least about 1 kHz, 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 MHz, 2 MHz, 3 MHz, 4 MHz, 5 MHz, 6 MHz, 7 MHz, 8 MHz, 9 MHz, 10 MHz, 20 MHz, 30 MHz, 40 MHz, 50 MHz, 60 MHz, 70 MHz, 80 MHz, 90 MHz, 100 MHz, 200 MHz, 300 MHz, 400 MHz, 500 MHz, 600 MHz, 700 MHz, 800 MHz, 900 MHz, 1 MHz, or more. The Raman transitions may be detuned by at most about 1 GHz, 900 MHz, 800 MHz, 700 MHz, 600 MHz, 500 MHz, 400 MHz, 300 MHz, 200 MHz, 100 MHz, 90 MHz, 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, or less. The Raman transitions may be detuned by a value that is within a range defined by any two of the preceding values.

Raman transitions may be induced on individually selected atoms using one or more spatial light modulators (SLMs) or acousto-optic deflectors (AODs) to impart a deflection angle and/or a frequency shift to a light beam based on an applied radiofrequency (RF) signal. The SLM or AOD may be combined with an optical conditioning system that images the SLM or AOD active region onto the back focal plane of a microscope objective. The microscope objective may perform a spatial Fourier transform on the optical field at the position of the SLM or AOD. As such, angle (which may be proportional to RF frequency) may be converted into position. For example, applying a comb of radio frequencies to an AOD may generate a linear array of spots at a focal plane of the objective, with each spot having a finite extent determined by the characteristics of the optical conditioning system (such as the point spread function of the optical conditioning system).

To perform a Raman transition on a single atom with a single SLM or AOD, a pair of frequencies may be applied to the SLM or AOD simultaneously. The two frequencies of the pair may have a frequency difference that matches or nearly matches the splitting energy between the first and second qubit states. For instance, the frequency difference may differ from the splitting energy by at most about 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, 900 Hz, 800 Hz, 700 Hz, 600 Hz, 500 Hz, 400 Hz, 300 Hz, 200 Hz, 100 Hz, 90 Hz, 80 Hz, 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The frequency difference may differ from the splitting energy by at least about 1 Hz, 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz, 600 Hz, 700 Hz, 800 Hz, 900 Hz, 1 kHz, 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 MHz, or more. The frequency difference may differ from the splitting energy by about 0 Hz. The frequency difference may differ from the splitting energy by a value that is within a range defined by any two of the preceding values. The optical system may be configured such that the position spacing corresponding to the frequency difference is not resolved and such that light at both of the two frequencies interacts with a single atom.

The electromagnetic delivery units may be configured to provide a beam with a characteristic dimension of at least about 10 nm, 50 nm, 75 nm, 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, 900 nm, 925 nm, 950 nm, 975 nm, 1 micrometer (μm), 1.5 μm, 2 μm, 2.5 μm 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, or more. The electromagnetic delivery units may be configured to provide a beam with a characteristic dimension of at most about 10 μm, 9.5 μm, 9 μm, 8.5 μm, 8 μm, 7.5 μm, 7 μm, 6.5 μm, 6 μm, 5.5 μm, 5 μm, 4.5 μm, 4 μm, 3.5 μm, 3 μm, 2.5 μm, 2 μm, 1.5 μm, 1 μm, 975 nm, 950 nm, 925 nm, 900 nm, 875 nm, 850 nm, 825 nm, 800 nm, 775 nm, 750 nm, 725 nm, 700 nm, 675 nm, 650 nm, 625 nm, 600 nm, 575 nm, 550 nm, 525 nm, 500 nm, 475 nm, 450 nm, 425 nm, 400 nm, 375 nm, 350 nm, 325 nm, 300 nm, 275 nm, 250 nm, 225 nm, 200 nm, 175 nm, 150 nm, 125 nm, 100 nm, 75 nm, 25 nm, 10 nm, or less. The electromagnetic delivery units may be configured to provide a beam with a characteristic dimension as defined by any two of the proceeding values. For example, the beam can have a characteristic dimension of about 1.5 micrometers to about 2.5 micrometers. Examples of characteristic dimensions include, but are not limited to, a Gaussian beam waist, the full width at half maximum (FWHM) of the beam size, the beam diameter, the 1/e² width, the D4s width, the D86 width, and the like. For example, the beam may have a Gaussian beam waist of at least about 1.5 micrometers.

The characteristic dimension of the beam may be bounded at the low end by the size of the atomic wavepacket of an optical trapping site. For example, the beam can be formed such that the intensity variation of the beam over the trapping site is sufficiently small as to be substantially homogeneous over the trapping site. In this example, the beam homogeneity can improve the fidelity of a qubit in the trapping site. The characteristic dimension of the beam may be bounded at the high end by the spacing between trapping sites. For example, a beam can be forned such that it is small enough that the effect of the beam on a neighboring trapping site/atom is negligible. In this example, the effect may be negligible if the effect can be minimized by techniques such as, for example, composite pulse engineering. The characteristic dimension may be different from a maximum achievable resolution of the system. For example, a system can have a maximum resolution of 700 nm, but the system may be operated at 1.5 micrometers. In this example, the value of the characteristic dimension may be selected to optimize the performance of the system in view of the considerations described elsewhere herein. The characteristic dimension may be invariant for different maximally achievable resolutions. For example, a system with a maximum resolution of 500 nm and a system with a maximum resolution of 2 micrometers may both be configured to operate at a characteristic dimension of 2 micrometers. In this example, 2 micrometers may be the optimal resolution based on the size of the trapping sites.

### Example of Integrated Optical Trapping Units and Electromagnetic Delivery Units

The optical trapping units and electromagnetic delivery units described herein may be integrated into a single optical system. A microscope objective may be used to deliver electromagnetic radiation generated by an electromagnetic delivery unit described herein and to deliver light for trapping atoms generated by an optical trapping unit described herein. Alternatively or in addition, different objectives may be used to deliver electromagnetic radiation generated by an electromagnetic delivery unit and to deliver light from trapping atoms generated by an optical trapping unit.

A single SLM or AOD may allow the implementation of qubit operations (such as any single-qubit or two-qubit operations described herein) on a linear array of atoms. Alternatively or in addition, two separate SLMs or AODs may be configured to each handle light with orthogonal polarizations. The light with orthogonal polarizations may be overlapped before the microscope objective. In such a scheme, each photon used in a two-photon transition described herein may be passed to the objective by a separate SLM or AOD, which may allow for increased polarization control. Qubit operations may be performed on a two-dimensional arrangement of atoms by bringing light from a first SLM or AOD into a second SLM or AOD that is oriented substantially orthogonally to the first SLM or AOD via an optical relay. Alternatively or in addition, qubit operations may be performed on a two-dimensional arrangement of atoms by using a one-dimensional array of SLMs or AODs.

The stability of qubit gate fidelity may be improved by maintaining overlap of light from the various light sources described herein (such as light sources associated with the optical trapping units or electromagnetic delivery units described herein). Such overlap may be maintained by an optical subsystem that measures the direction of light emitted by the various light sources, allowing closed-loop control of the direction of light emission. The optical subsystem may comprise a pickoff mirror located before the microscope objective. The pickoff mirror may be configured to direct a small amount of light to a lens, which may focus a collimated beam and convert angular deviation into position deviation, A position-sensitive optical detector, such as a lateral-effect position sensor or quadrant photodiode, may convert the position deviation into an electronic signal and information about the deviation may be fed into a compensation optic, such as an active mirror.

The stability of qubit gate manipulation may be improved by controlling the intensity of light from the various light sources described herein (such as light sources associated with the optical trapping units or electromagnetic delivery units described herein). Such intensity control may be maintained by an optical subsystem that measures the intensity of light emitted by the various light sources, allowing closed-loop control of the intensity. Each light source may be coupled to an intensity actuator, such as an intensity servo control. The actuator may comprise an acousto-optic modulator (AOM) or electro-optic modulator (EOM). The intensity may be measured using an optical detector, such as a photodiode or any other optical detector described herein. Information about the intensity may be integrated into a feedback loop to stabilize the intensity.

### Example of State Preparation Units

FIG. 5 shows an example of a state preparation unit 250. The state preparation unit may be configured to prepare a state of the plurality of atoms, as described herein. The state preparation unit may be coupled to the optical trapping unit and may direct atoms that have been prepared by the state preparation unit to the optical trapping unit. The state preparation unit may be configured to cool the plurality of atoms. The state preparation unit may be configured to cool the plurality of atoms prior to trapping the plurality of atoms at the plurality of optical trapping sites.

The state preparation unit may comprise one or more Zeeman slowers. For instance, the state preparation unit may comprise a Zeeman slower 251. Although depicted as comprising a single Zeeman slower in FIG. 5, the state preparation may comprise any number of Zeeman slowers, such as at least about 1, 2, 3, 4, 5, 6, 7, 8, 9, 10, or more Zeeman slowers or at most about 10, 9, 8, 7, 6, 5, 4, 3, 2, or 1 Zeeman slowers. The Zeeman slowers may be configured to cool one or more atoms of the plurality of atoms from a first velocity or distribution of velocities (such an emission velocity from an of an atom source, room temperature, liquid nitrogen temperature, or any other temperature) to a second velocity that is lower than the first velocity or distribution of velocities.

The first velocity or distribution of velocities may be associated with a temperature of at least about 50 Kelvin (1K), 60 K, 70 K, 80 K, 90 K, 100 K, 200 K, 300 K, 400 K, 500 K, 600 K, 700 K, 800 K, 900 K, 1,000 K, or more. The first velocity or distribution of velocities may be associated with a temperature of at most about 1,000 K, 900 K, 800 K, 700 K, 600 K, 500 K, 400 K, 300 K, 200 K, 100 K, 90 K, 80 K, 70 K, 60 K, 50 K, or less. The first velocity or distribution of velocities may be associated with a temperature that is within a range defined by any two of the preceding values. The second velocity may be at least about 1 meter per second (m/s), 2 m/s, 3 m/s, 4 m/s, 5 m/s, 6 m/s, 7 m/s, 8 m/s, 9 m/s, 10 m/s, or more. The second velocity may be at most about 10 m/s, 9 m/s, 8 m/s, 7 m/s, 6 m/s, 5 m/s, 4 m/s, 3 m/s, 2 m/s, 1 m/s, or less. The second velocity may be within a range defined by any two of the preceding values. The Zeeman slowers may comprise ID Zeeman slowers.

The state preparation unit may comprise a first magneto-optical trap (MOT) 252. The first MOT may be configured to cool the atoms to a first temperature. The first temperature may be at most about 10 millikelvin (mK), 9 mK, 8 mK, 7 mK, 6 mK, 5 mK, 4 mK, 3 mK, 2 mK, 1 mK, 0.9 mK, 0.8 mK, 0.7 mK, 0.6 mK, 0.5 mK, 0.4 mK, 0.3 mK, 0.2 mK, 0.1 mK, or less. The first temperature may be at least about 0.1 mK, 0.2 mK, 0.3 mK, 0.4 mK, 0.5 mK, 0.6 mK, 0.7 mK, 0.8 mK, 0.9 mK, 1 mK, 2 mK, 3 mK, 4 mK, 5 mK, 6 mK, 7 mK, 8 mK, 9 mK, 10 mK, or more. The first temperature may be within a range defined by any two of the preceding values. The first MOT may comprise a ID, 2D, or 3D MOT.

The first MOT may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 m, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 un, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The state preparation unit may comprise a second MOT 253. The second MOT may be configured to cool the atoms from the first temperature to a second temperature that is lower than the first temperature. The second temperature may be at most about 100 microkelvin (μK), 90 μK, 80 μK, 70 μK, 60 μK, 50 μK, 40 μK, 30 μK, 20 μK, 10 μK, 9 μK, 8 μK, 7 μK, 6 μK, 5 μK, 4 μK, 3 μK, 2 μK, 1 μK, 900 nanokelvin (nK), 800 nK, 700 nK, 600 nK, 500 nK, 400 nK, 300 nK, 200 nK, 100 nK, or less. The second temperature may be at least about 100 nK, 200 nK, 300 nK, 400 nK, 500 nK, 600 nK, 700 nK, 800 nK, 900 nK, 1 μK, 2 μK 3 μK, 4 μK, 5 μK, 6 μK, 7 μK, 8 μK, 9 μK, 10 μK, 20 μK, 30 μK, 40 μK, 50 μK, 60 μK, 70 μK, 80 μK, 90 μK, 100 μK, or more. The second temperature may be within a range defined by any two of the preceding values. The second MOT may comprise a 1D, 2D, or 3D MOT.

The second MOT may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

Although depicted as comprising two MOTs in FIG. 5, the state preparation unit may comprise any number of MOTs, such as at least about 1, 2, 3, 4, 5, 6, 7, 8, 9, 10, or more MOTs or at most about 10, 9, 8, 7, 6, 5, 4, 3, 2, or 1 MOTs.

The state preparation unit may comprise one or more sideband cooling units or Sisyphus cooling units (such as a sideband cooling unit described in www.arxiv.org/abs/1810.06626 or a Sisyphus cooling unit described in www.arxiv.org/abs/1811.06014, each of which is incorporated herein by reference in its entirety for all purposes). For instance, the state preparation unit may comprise sideband cooling unit or Sisyphus cooling unit 254. Although depicted as comprising a single sideband cooling unit or Sisyphus cooling unit in FIG. 5, the state preparation may comprise any number of sideband cooling units or Sisyphus cooling units, such as at least about 1, 2, 3, 4, 5, 6, 7, 8, 9, 10, or more sideband cooling units or Sisyphus cooling units, or at most about 10, 9, 8, 7, 6, 5, 4, 3, 2, or 1 sideband cooling units or Sisyphus cooling units. The sideband cooling units or Sisyphus cooling units may be configured to use sideband cooling to cool the atoms from the second temperature to a third temperature that is lower than the second temperature. The third temperature may be at most about 10 μK, 9 μK, 8 μK, 7 μK, 6 μK, 5 μK, 4 μK, 3 μK, 2 μK, 1 μK, 900 nK, 800 nK, 700 nK, 600 nK, 500 nK, 400 nK, 300 nK, 200 nK, 100 nK, 90 nK, 80 nK, 70 nK, 60 nK, 50 nK, 40 nK, 30 nK, 20 nK, 10 nK, or less. The third temperature may be at most about 10 nK, 20 nK, 30 nK, 40 nK, 50 nK, 60 nK, 70 nK, 80 nK, 90 nK, 100 nK, 200 nK, 300 nK, 400 nK, 500 nK, 600 nK, 700 nK, 800 nK, 900 nK, 1 μK, 2 μK, 3 μK, 4 μK, 5 μK, 6 μK, 7 μK, 8 μK, 9 μK, 10 μK, or more. The third temperature may be within a range defined by any two of the preceding values.

The sideband cooling units or Sisyphus cooling units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The state preparation unit may comprise one or more optical pumping units. For instance, the state preparation unit may comprise optical pumping unit 255. Although depicted as comprising a single optical pumping unit in FIG. 5, the state preparation may comprise any number of optical pumping units, such as at least about 1, 2, 3, 4, 5, 6, 7, 8, 9, 10, or more optical pumping units, or at most about 10, 9, 8, 7, 6, 5, 4, 3, 2, or 1 optical pumping units. The optical pumping units may be configured to emit light to optically pump the atoms from an equilibrium distribution of atomic states to a non-equilibrium atomic state. For instance, the optical pumping units may be configured to emit light to optically pump the atoms from an equilibrium distribution of atomic states to a single pure atomic state. The optical pumping units may be configured to emit light to optically pump the atoms to a ground atomic state or to any other atomic state. The optical pumping units may be configured to optically pump the atoms between any two atomic states. The optical pumping units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 un, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The state preparation unit may comprise one or more coherent driving units. For instance, the state preparation unit may comprise coherent driving unit 256. Although depicted as comprising a coherent driving unit in FIG. 5, the state preparation may comprise any number of coherent driving units, such as at least about 1, 2, 3, 4, 5, 6, 7, 8, 9, 10, or more coherent driving units or at most about 10, 9, 8, 7, 6, 5, 4, 3, 2, or 1 coherent driving units. The coherent driving units may be configured to coherently drive the atoms from the non-equilibrium state to the first or second atomic states described herein. Thus, the atoms may be optically pumped to an atomic state that is convenient to access (for instance, based on availability of light sources that emit particular wavelengths or based on other factors) and then coherently driven to atomic states described herein that are useful for performing quantum computations. The coherent driving units may be configured to induce a single photon transition between the non-equilibrium state and the first or second atomic state. The coherent driving units may be configured to induce a two-photon transition between the non-equilibrium state and the first or second atomic state. The two-photon transition may be induced using light from two light sources described herein (such as two lasers described herein).

The coherent driving units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The coherent driving units may be configured to induce an RF transition between the non-equilibrium state and the first or second atomic state. The coherent driving units may comprise one or more electromagnetic radiation sources configured to emit electromagnetic radiation configured to induce the RF transition. For instance, the coherent driving units may comprise one or more RF sources (such as any RF source described herein) configured to emit RF radiation. The RF radiation may comprise one or more wavelengths of at least about 10 centimeters (cm), 20 cm, 30 cm, 40 cm, 50 cm, 60 cm, 70 cm, 80 cm, 90 cm, 1 meter (m), 2 m, 3 m, 4 m, 5 m, 6 m, 7 m, 8 m, 9 m, 10 m, or more. The RF radiation may comprise one or more wavelengths of at most about 10 m, 9 m, 8 m, 7 m, 6 m, 5 m, 4 m, 3 m, 2 m, 1 m, 90 cm, 80 cm, 70 cm, 60 cm, 50 cm, 40 cm, 30 cm, 20 cm, 10 cm, or less. The RE radiation may comprise one or more wavelengths that are within a range defined by any two of the preceding values. Alternatively or in addition, the coherent driving units may comprise one or more light sources (such as any light sources described herein) configured to induce a two-photon transition corresponding to the RF transition

### Example of Controllers

The optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units may include one or more circuits or controllers (such as one or more electronic circuits or controllers) that is connected (for instance, by one or more electronic connections) to the optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units. The circuits or controllers may be configured to control the optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units.

### Example of Non-Classical Computers

In an aspect, the present disclosure provides a non-classical computer comprising: a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state; one or more electromagnetic delivery units configured to apply electromagnetic energy to one or more qubits of the plurality of qubits, thereby imparting a non-classical operation to the one or more qubits, which non-classical operation includes a superposition between at least the first qubit state and the second qubit state; one or more entanglement units configured to quantum mechanically entangle at least a subset of the plurality of qubits in the superposition with at least another qubit of the plurality of qubits; and one or more readout optical units configured to perform one or more measurements of the one or more qubits, thereby obtaining a non-classical computation.

In an aspect, the present disclosure provides a non-classical computer comprising a plurality of qubits comprising greater than 60 atoms each trapped within an optical trapping site of a plurality of spatially distinct optical trapping sites.

### Example of Methods for Performing a Non-Classical Computation

In an aspect, the present disclosure provides a method for performing a non-classical computation, comprising: (a) generating a plurality of spatially distinct optical trapping sites, the plurality of optical trapping sites configured to trap a plurality of atoms, the plurality of atoms comprising greater than 60 atoms; (b) applying electromagnetic energy to one or more atoms of the plurality of atoms, thereby inducing the one or more atoms to adopt one or more superposition states of a first atomic state and at least a second atomic state that is different from the first atomic state; (c) quantum mechanically entangling at least a subset of the one or more atoms in the one or more superposition states with at least another atom of the plurality of atoms; and (d) performing one or more optical measurements of the one or more superposition state to obtain the non-classical computation.

FIG. 6 shows a flowchart for an example of a first method 600 for performing a non-classical computation.

In a first operation 610, the method 600 may comprise generating a plurality of spatially distinct optical trapping sites. The plurality of optical trapping sites may be configured to trap a plurality of atoms. The plurality of atoms may comprise greater than 60 atoms. The optical trapping sites may comprise any optical trapping sites described herein. The atoms may comprise any atoms described herein.

In a second operation 620, the method 600 may comprise applying electromagnetic energy to one or more atoms of the plurality of atoms, thereby inducing the one or more atoms to adopt one or more superposition states of a first atomic state and at least a second atomic state that is different from the first atomic state. The electromagnetic energy may comprise any electromagnetic energy described herein. The first atomic state may comprise any first atomic state described herein. The second atomic state may comprise any second atomic state described herein.

In a third operation 630, the method 600 may comprise quantum mechanically entangling at least a subset of the one or more atoms in the one or more superposition states with at least another atom of the plurality of atoms. The atoms may be quantum mechanically entangled in any manner described herein (for instance, as described herein with respect to FIG. 2).

In a fourth operation 640, the method 600 may comprise performing one or more optical measurements of the one or more superposition state to obtain the non-classical computation. The optical measurements may comprise any optical measurements described herein.

In an aspect, the present disclosure provides a method for performing a non-classical computation, comprising: (a) providing a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state; (b) applying electromagnetic energy to one or more qubits of the plurality of qubits, thereby imparting a non-classical operation to the one or more qubits, which non-classical operation includes a superposition between at least the first qubit state and the second qubit state; (c) quantum mechanically entangling at least a subset of the plurality of qubits in the superposition with at least another qubit of the plurality of qubits; and (d) performing one or more optical measurements of the one or more qubits, thereby obtaining said the-classical computation.

FIG. 7 shows a flowchart for an example of a second method 700 for performing a non-classical computation.

In a first operation 710, the method 700 may comprise providing a plurality of qubits comprising greater than 60 atoms, each atom trapped within an optical trapping site of a plurality of spatially distinct optical trapping sites, wherein the plurality of qubits comprises at least a first qubit state and a second qubit state, wherein the first qubit state comprises a first atomic state and the second qubit state comprises a second atomic state. The optical trapping sites may comprise any optical trapping sites described herein. The qubits may comprise any qubits described herein. The atoms may comprise any atoms described herein. The first qubit state may comprise any first qubit state described herein. The second qubit state may comprise any second qubit state described herein. The first atomic state may comprise any first atomic state described herein. The second atomic state may comprise any second atomic state described herein.

In a second operation 720, the method 700 may comprise applying electromagnetic energy to one or more qubits of the plurality of qubits, thereby imparting a non-classical operation to the one or more qubits, which non-classical operation includes a superposition between at least the first qubit state and the second qubit state. The electromagnetic energy may comprise any electromagnetic energy described herein.

In a third operation 730, the method 700 may comprise quantum mechanically entangling at least a subset of the plurality of qubits in the superposition with at least another qubit of the plurality of qubits. The qubits may be quantum mechanically entangled in any manner described herein (for instance, as described herein with respect to FIG. 2).

In a fourth operation 740, the method 700 may comprise performing one or more optical measurements of the one or more qubits, thereby obtaining the non-classical computation. The optical measurements may comprise any optical measurements described herein.

In an aspect, the present disclosure provides a method for performing a non-classical computation, comprising: (a) providing a plurality of qubits comprising greater than 60 atoms each trapped within an optical trapping site of a plurality of spatially distinct optical trapping sites, and (b) using at least a subset of the plurality of qubits to perform the non-classical computation.

FIG. 8 shows a flowchart for an example of a third method 800 for performing a non-classical computation.

In a first operation 810, the method 800 may comprise providing a plurality of qubits comprising greater than 60 atoms each trapped within an optical trapping site of a plurality of spatially distinct optical trapping sites. The qubits may comprise any qubits described herein. The atoms may comprise any atoms described herein. The optical trapping sites may comprise any optical trapping sites described herein.

In a second operation 820, the method 800 may comprise using at least a subset of the plurality of qubits to perform a non-classical computation.

### Example of Parallel Addressing of Multi-Qubit Units

Direct excitation of strontium-87 from the ground state to Rydberg levels would require a laser with a wavelength of approximately 218 nr. Alternatively, the Rydberg excitation operation can be performed using two-photon excitation combining 689 nm and 319 nm light, each detuned from the intermediate ³P₁ state. The approximately 7 kHz width of the ³P₁ state provides an effective balance between the two-photon effective Rabi rate and scattering via spontaneous decay from the ³P₁. FIG. 9 shows an energy level structure for single-qubit and multi-qubit operations in strontium-87.

The optical system for single-qubit operations is also designed to work well for multi-qubit gates. One of the single-qubit beams is used as one leg of the two-photon excitation scheme that drives transitions to the Rydberg electronic manifold. To satisfy the spatially dependent frequency and phase matching condition, AODs are also used for the UV light. Importantly, the optical systems are matched so that the frequency shift of the UV light from one site to another is identical to that of the 689 nm light. The consequence of this constraint is that the performance of state-of-the-art UV AODs dictate the accessible field of view (FOV) for multi-qubit operations. Further, because one of the single-qubit beams is being used for multi-qubit operations (and the two single-qubit beams are matched), the FOV for single-qubit operations will be the same. A figure of merit for UV AODs is the product of the active aperture and the RF bandwidth of the device. For a fixed beam size in the back focal plane of the objective, increasing either of these quantities results in a larger scan angle of the beams, and thus a larger FOV in the plane of the qubit array. An FOV of approximately 100 μm ×100 μm was achieved, which is sufficient to address an array of approximately 1,000 atoms with a trapping site spacing of 3 μm.

### Example of Computer Systems

The present disclosure provides computer systems that are programmed to implement methods of the disclosure. FIG. 1 shows a computer system 101 that is programmed or otherwise configured to perform one or more operations of the methods for constrained optimization on a non-classical computer using subspace correction disclosed herein. The computer system 101 can regulate various aspects of classical or non-classical computers of the present disclosure, such as, for example, providing a state preparation unitary operation, wherein the state preparation unitary operation comprises at least a portion of an implementation of a constrained optimization problem on the non-classical computer, wherein the state preparation unitary operation is configured to evolve a quantum register to a solution state; applying a constraint detection operation, the constraint detection operation comprising entangling an ancilla qubit with a set of logical qubits; and measuring the ancilla qubit to determine whether a constraint of the constrained optimization problem is satisfied. In some cases, one or more operations may be performed by one or more gates. The computer system 101 can be an electronic device of a user or a computer system that is remotely located with respect to the electronic device. The electronic device can be a mobile electronic device.

The computer system 101 includes a central processing unit (CPU, also “processor” and “computer processor” herein) 105, which can be a single core or multi core processor, or a plurality of processors for parallel processing. The computer system 101 also includes memory or memory location 110 (e.g., random-access memory, read-only memory, flash memory), electronic storage unit 115 (e.g., hard disk), communication interface 120 (e.g., network adapter) for communicating with one or more other systems, and peripheral devices 125, such as cache, other memory, data storage and/or electronic display adapters. The memory 110, storage unit 115, interface 120 and peripheral devices 125 are in communication with the CPU 105 through a communication bus (solid lines), such as a motherboard. The storage unit 115 can be a data storage unit (or data repository) for storing data. The computer system 101 can be operatively coupled to a computer network (“network”) 130 with the aid of the communication interface 120. The network 130 can be the Internet, an internet and/or extranet, or an intranet and/or extranet that is in communication with the Internet. The network 130 in some cases is a telecommunication and/or data network. The network 130 can include one or more computer servers, which can enable distributed computing, such as cloud computing. The network 130, in some cases with the aid of the computer system 101, can implement a peer-to-peer network, which may enable devices coupled to the computer system 101 to behave as a client or a server.

The CPU 105 can execute a sequence of machine-readable instructions, which can be embodied in a program or software. The instructions may be stored in a memory location, such as the memory 110. The instructions can be directed to the CPU 105, which can subsequently program or otherwise configure the CPU 105 to implement methods of the present disclosure. Examples of operations performed by the CPU 105 can include fetch, decode, execute, and writeback.

The CPU 105 can be part of a circuit, such as an integrated circuit. One or more other components of the system 101 can be included in the circuit. In some cases, the circuit is an application specific integrated circuit (ASIC).

The storage unit 115 can store files, such as drivers, libraries and saved programs. The storage unit 115 can store user data, e.g., user preferences and user programs. The computer system 101 in some cases can include one or more additional data storage units that are external to the computer system 101, such as located on a remote server that is in communication with the computer system 101 through an intranet or the Internet.

The computer system 10s1 can communicate with one or more remote computer systems through the network 130. For instance, the computer system 101 can communicate with a remote computer system of a user. Examples of remote computer systems include personal computers (e.g., portable PC), slate or tablet PC's (e.g., Apple® iPad, Sarnsung® Galaxy Tab), telephones, Smart phones (e.g., Apple® iPhone, Android-enabled device, Blackberry®), or personal digital assistants. The user can access the computer system 101 via the network 130.

Methods as described herein can be implemented by way of machine (e.g., computer processor) executable code stored on an electronic storage location of the computer system 101, such as, for example, on the memory 110 or electronic storage unit 115. The machine executable or machine-readable code can be provided in the form of software. During use, the code can be executed by the processor 105. In some cases, the code can be retrieved from the storage unit 115 and stored on the memory 110 for ready access by the processor 105. In some situations, the electronic storage unit 115 can be precluded, and machine-executable instructions are stored on memory 110.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 101 can include or be in communication with an electronic display 135 that comprises a user interface (UI) 140 for providing, for example, providing a solution state of the optimization problem. Examples of UI's include, without limitation, a graphical user interface (GUI) and web-based user interface.

Methods and systems of the present disclosure can be implemented by way of one or more algorithms as disclosed herein above. An algorithm can be implemented by way of software upon execution by the central processing unit 105.

### Certain Definitions and Additional Considerations

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

As used herein, “or” is intended to mean an “inclusive or” or what is also known as a “logical OR,” wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. As such, any reference to “or” herein is intended to encompass “and/or” unless otherwise stated.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it may be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

It will be understood that, although the terms “first,” “second,” “third,” etc. may be used herein to describe various elements, these elements should not be limited by these terms. These terms are only used to distinguish one element from another. For example, a first element may be termed a second element, and, similarly, a second element may be termed a first element, without departing from the scope of the present disclosure.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, the terms “non-classical computation,” “non-classical procedure,” “non-classical operation,” any “non-classical computer” generally refer to any method or system for performing computational procedures outside of the paradigm of classical computing. A non-classical computation, non-classical procedure, non-classical operation, or non-classical computer may comprise a quantum computation, quantum procedure, quantum operation, or quantum computer.

As used herein, the terms “quantum computation,” “quantum procedure,” “quantum operation,” and “quantum computer” generally refer to any method or system for performing computations using quantum mechanical operations (such as unitary transformations or completely positive trace-preserving (CPTP) maps on quantum channels) on a Hilbert space represented by a quantum device. As such, quantum and classical (or digital) computation may be similar in the following aspect: both computations may comprise sequences of instructions performed on input information to then provide an output. Various paradigms of quantum computation may break the quantum operations down into sequences of basic quantum operations that affect a subset of qubits of the quantum device simultaneously. The quantum operations may be selected based on, for instance, their locality or their ease of physical implementation. A quantum procedure or computation may then consist of a sequence of such instructions that in various applications may represent different quantum evolutions on the quantum device. For example, procedures to compute or simulate quantum chemistry may represent the quantum states and the annihilation and creation operators of electron spin-orbitals by using qubits (such as two-level quantum systems) and a universal quantum gate set (such as the Hadamard, controlled-not (CNOT), and rotations) through the so-called Jordan-Wigner transformation or Bravyi-Kitaev transformation.

Additional examples of quantum procedures or computations may include procedures for optimization such as quantum approximate optimization algorithm (QAOA) or quantum minimum finding. QAOA may comprise performing rotations of single qubits and entangling gates of multiple qubits. In quantum adiabatic computation, the instructions may carry stochastic or non-stochastic paths of evolution of an initial quantum system to a final one.

Quantum-inspired procedures may include simulated annealing, parallel tempering, master equation solver, Monte Carlo procedures and the like. Quantum-classical or hybrid algorithms or procedures may comprise such procedures as variational quantum eigensolver (VQE) and the variational and adiabatically navigated quantum eigensolver (VanQver).

A quantum computer may comprise one or more adiabatic quantum computers, quantum gate arrays, one-way quantum computers, topological quantum computers, quantum Turing machines, quantum annealers, Ising solvers, or gate models of quantum computing.

As used herein, the term “adiabatic” refers to any process performed on a quantum mechanical system in which the parameters of the Hamiltonian are changed slowly in comparison to the natural timescale of evolution of the system.

As used herein, the term “non-adiabatic” refers to any process performed quantum mechanical system in which the parameters of the Hamiltonian are changed quickly in comparison to the natural timescale of evolution of the system or on a similar timescale as the natural timescale of evolution of the system.

As used herein, like characters refer to like elements.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

It should be noted that various illustrative or suggested ranges set forth herein are specific to their example embodiments and are not intended to limit the scope or range of disclosed technologies, but, again, merely provide example ranges for frequency, amplitudes, etc. associated with their respective embodiments or use cases. Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

It should be understood that, unless a term is expressly defined in this patent, there is no intent to limit the meaning of that term, either expressly or by implication, beyond its plain or ordinary meaning, and such term should not be interpreted to be limited in scope based at least in part on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are disclosed herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as disclosed herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, hardware modules may encompass a tangible entity, be that an entity that is physically constructed, permanently configured (e.g., hardwired), or temporarily configured (e.g., programmed) to operate in a certain manner or to perform certain operations disclosed herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information). Elements that are described as being coupled and or connected may refer to two or more elements that may be (e.g., direct physical contact) or may not be (e.g., electrically connected, communicatively coupled, etc.) in direct contact with each other, but yet still cooperate or interact with each other.

The various operations of example methods disclosed herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines disclosed herein may be at least partially processor-implemented. For example, at least some of the operations of a method may be performed by one or more processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain operations may be distributed among the one or more processors, not only residing within a single machine, but deployed across a number of machines. In some example embodiments, the one or more processors or processor-implemented modules may be located in a single geographic location (e.g., within an office environment, or a server farm). In other example embodiments, the one or more processors or processor-implemented modules may be distributed across a number of geographic locations.

### Examples

### Example Maximum Independent Set

A simulation of an application the systems and methods disclosed herein to the maximum independent set problem was performed. It was shown that it is possible to get well-performing approximations to optimization problems with a significant (100-1,000×) decrease in shot overhead when compared to similar QAOA algorithms.

The simulation was performed using a state-preparation unitary comprising the non-abelian unitary preparation algorithm by Yu, Wu, and Wilczek, which prepares the least optimized state satisfying the constraints, and uses a global unitary rotation to adiabatically prepare the most optimal state. (See, Yu, Hongye, Frank Wilczek, and Biao Wu, “Quantum algorithm for approximating maximum independent sets,” Chinese Physics Letters 38.3 (2021): 030304, which is incorporated by reference herein in its entirety). Any unitary state preparation that starts within or near the constraint manifold and ends up near the optimal state with reasonable success may be used to form the basis of a reasonable algorithm for the methods and systems disclosed herein.

### Example Subspace Correction for Constrained Optimization

A new class of hybrid algorithms for subspace correction utilized projective measurement and feedback to maintain a constrained subspace during the course of quantum circuit execution. Subspace correction, like error correction, relies on two components: syndrome detection and recovery. Here, the syndrome was the violation of a constraint on the chosen subspace, and it was detected with a generalized quantum operation. Many recovery strategies were constructed for a given syndrome, with an emergent trade-space between wall-clock time and recovery quality. When subspace correction was paired with an appropriate optimal-state preparation unitary and a well-chosen recovery strategy, one could reduce the shot overhead for optimization for algorithms such as QAOA by orders of magnitude. To actualize the generality of this approach, operations to prepare syndromes and basic recoveries for a number of common constraint terms in QUBO-based problems were explicitly constructed.

This class of algorithm, unlike previous hybrid NISQ algorithms, utilized long coherence times as the hybrid computation and recovery took place within the coherent execution of the quantum algorithm. It also generally required more qubits, depending on the desired degree of ancilla simultaneity during execution. Moreover, the multi-qubit operations needed for detection and recovery decomposed into high-depth 1Q/2Q sequences unless the hardware supports native multi-qubit entangling gates, in which case most operations were constant or low-poly in depth. As such, the target platforms for subspace correction were next generation hardware such as neutral atom quantum computers. Subspace correction was applicable beyond optimization and can be incorporated into quantum simulation and quantum machine learning algorithms.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-118. (canceled)

119. A method for preparing a solution to a problem comprising a constraint on a non-classical computer, comprising:
(a) providing a state preparation operation, wherein said state preparation operation comprises at least a portion of an implementation of said problem comprising said constraint on said non-classical computer, wherein said state preparation operation is configured to evolve a quantum register to a solution state;
(b) applying a constraint detection operation, said constraint detection operation comprising entangling an ancilla qubit with a set of data qubits; and
(c) measuring said ancilla qubit to determine whether a constraint of said problem is satisfied.

120. The method of claim 119, wherein said problem is a constrained optimization problem.

121. The method of claim 119, wherein said state preparation operation is a unitary operation.

122. The method of claim 119, wherein said ancilla qubit is one of a set of ancilla qubits, and wherein (c) further comprises measuring said set of ancilla qubits.

123. The method of claim 119, wherein (c) further comprises measuring said set of data qubits.

124. The method of claim 119, wherein said set of data qubits are comprised of logical qubits, physical qubits, or a combination thereof.

125. The method of claim 119, wherein measuring said ancilla qubit at (c) comprises: (i) collapsing at least part of a wavefunction into a new wavefunction, and (ii) determining whether said new wavefunction satisfies said constraint.

126. The method of claim 119, further comprising, subsequent to (c) outputting said solution state.

127. The method of claim 119, wherein (c) further comprises determining, via a processor, whether said constraint of said problem is satisfied.

128. The method of claim 119, wherein subsequent to (c), said method further comprises applying one or more recovery operations to said set of data qubits, and wherein measuring said ancilla qubit in (c) comprises an indication that said constraint is not satisfied by said set of data qubits.

129. The method of claim 128, further comprising determining, via a processor, a sequence of said one or more recovery operations based on an extent to which said constraint is not satisfied.

130. The method of claim 128, wherein said one or more recovery operations comprise preparing a superposition of states over all possible registers containing a single qubit or m qubits in a |1 [symbol] computational state.

131. The method of claim 128, wherein said one or more recovery operations comprise applying a RESET operation; and a) shelving one or more qubits in said |0 [symbol] state to said |clock 0 [symbol] state, b) exciting said |clock 0 [symbol] state with a pulse to said |ryd [symbol] state for π\sqrt{N} time, c) applying said Rydberg de-excitation beam to |clock 1 [symbol] ; and d) deshelving all qubits from said clock states.

132. The method of claim 119, wherein said constraint comprises a one-hot-encoding constraint.

133. The method of claim 132, wherein (b) comprises applying a shelving pulse to said ancilla qubit to excite to a |clock 0 [symbol] state; applying a multiphoton excitation to said set of logical qubits from a 1-in-n state to a 1-in-(n+1) Rydberg state; applying a Rydberg to |clock 1 [symbol] ) pulse on said ancilla qubit; and deshelving said ancilla qubit.

134. The method of claim 119, wherein said constraint comprises a m-in-n constraint.

135. The method of claim 134, wherein (b) comprises applying a shelving pulse to said ancilla qubit to excite to a |clock 0 [symbol] state; applying a multiphoton excitation to said set of logical qubits from an m-in-n state to a m-in-(n+ancilla) Rydberg state; applying a Rydberg to |clock 1 [symbol] pulse on said ancilla qubit; and deshelving said ancilla qubit.

136. The method of claim 119, wherein said constraint is an independent set constraint.

137. The method of claim 136, wherein (b) comprises applying a Toffoli gate at an edge.

138. The method of claim 119, wherein said constraint is a less than or equal to m-in-n constraint.

139. The method of claim 138, wherein (b) comprises recursively for all m′ excitations greater than m:
applying a shelving pulse to said ancilla qubit to excite to a |clock 0 [symbol] state; applying a multiphoton excitation to said set of logical qubits from an m-in-n state to a m-in-(n+ancilla) Rydberg state; applying a Rydberg to |clock 1 [symbol] pulse on said ancilla qubit; and deshelving said ancilla qubit.

140. The method of claim 119, wherein said method is integrated with an error correcting code.

141. The method of claim 119, wherein said quantum register comprises neutral atom qubits.

142. The method of claim 119, wherein said neutral atom qubits comprise strontium or ytterbium.

143. The method of claim 119, wherein said quantum register comprises nuclear-spin qubits.

144. The method of claim 119, wherein said constraint is an implied constraint.

145. The method of claim 119, wherein said problem is configured to be solved on a non-classical computer.

146. The method of claim 119, wherein said problem is a satisfiability problem.

147. The method of claim 119, further comprising repeating operations (a) to (c) until a stopping criterion is met.

148. The method of claim 147, wherein said stopping criterion comprises reaching a threshold number of iterations or a threshold change in said solution state.

149. A non-classical computer operable to perform a constrained optimization on a non-using subspace correction, said non-classical computer comprising:
a quantum register comprising a set of qubits and an ancilla qubit;
a quantum circuit comprising:
(a) a state preparation unitary operation, wherein said state preparation unitary operation comprises at least a portion of an implementation of a constrained optimization problem, wherein said state preparation unitary operation is configured to evolve a quantum register to a solution state;
(b) a constraint detection operation, said constraint detection operation comprising entangling said ancilla qubit with said set of logical qubits; and
(c) a measurement of said ancilla qubit, wherein said measurement is indicative of whether a constraint of said constrained optimization problem is satisfied.

150. A classical computer operably connected to a non-classical computer, said classical computer comprising instructions, which when executed, are configured to:
(a) provide a state preparation unitary operation, wherein said state preparation unitary operation comprises at least a portion of an implementation of a constrained optimization problem on said non-classical computer, wherein said state preparation unitary operation is configured to evolve a quantum register to a solution state;
(b) apply a constraint detection operation, said constraint detection operation comprising entangling an ancilla qubit with a set of logical qubits; and
(c) measure said ancilla qubit to determine whether a constraint of said constrained optimization problem is satisfied.
